(19) United States
(12) Patent Application Publication
(10) Pub. No.: US 2025/0200975 A1
(43) Pub. Date: Jun. 19, 2025

(54) MULTI-OBJECT TRACKING OF PARTIALLY OCCLUDED OBJECTS IN A MONITORED ENVIRONMENT

(71) Applicant: NVIDIA Corporation, Santa Clara, CA (US)

(72) Inventors: Joonhwa Shin, Santa Clara, CA (US); Fangyu Li, San Jose, CA (US); Hugo Maxence Verjus, Zurich (CH); Zheng Liu, Los Altos, CA (US)

(21) Appl. No.: 18/936,690

(22) Filed: Nov. 4, 2024

Related U.S. Application Data
(60) Provisional application No. 63/609,848, filed on Dec. 13, 2023.

(51) Int. Cl. G06V 20/52; G06T 7/70; G06V 10/26; G06V 10/82

(52) U.S. Cl. CPC G06V 20/52; G06T 7/70; G06V 10/26; G06V 10/82; G06V 2201/07; G06V 2201/10

(57) ABSTRACT

Apparatuses, systems, and techniques for multi-object tracking of partially occluded objects in a monitored environment are provided. A reference point of a first object in an environment is identified based on characteristics pertaining to the first object. A portion of the first object is occluded by a second object in the environment relative to a perspective of a camera component associated with a set of image frames depicting the first object and the second object. A set of coordinates of a multi-dimensional model for the first object is updated based on the identified reference point. The updated set of coordinates indicate a region of at least one of the set of image frames that include the occluded portion of the first object relative to the identified reference point. A location of the first object is tracked in the environment based on the updated set of coordinates of the multi-dimensional model.

### RELATED APPLICATIONS

The present application is a continuation application of U.S. Application No. 63/609,848 filed Dec. 13, 2023 entitled “Single-View 3D Tracking for Robust Multi-Object Tracking,” which is incorporated by reference herein.

### TECHNICAL FIELD

At least one embodiment pertains to methods and systems for tracking partially occluded objects in a monitored environment. For example, a reference point of a partially occluded object in an environment can be determined based on bounding box data obtained for the partially occluded object. A set of coordinates of a multi-dimensional (e.g., three-dimensional (3D)) model for the object can be updated based on the reference point. A location of the object in the environment can be tracked based on the updated coordinates of the model.

### BACKGROUND

Object tracking is a computer vision-based technique that simultaneously monitors and tracks the movements of one or more objects (also referred to as subjects) across one or more camera views, e.g., by taking input from video feeds captured by one or more cameras, and applying algorithms and/or machine learning techniques to analyze video streams to track and identify objects of interest. Object tracking may be used in applications such as security and surveillance, vehicle traffic monitoring, monitor activities in transit, factories and warehouses, in retail analytics to monitor customer behaviors in a retail store, and/or crowd management/public safety at events, gatherings, or public spaces.

### BRIEF DESCRIPTION OF DRAWINGS

Various embodiments in accordance with the present disclosure will be described with reference to the drawings, in which:

FIG. 1 is a block diagram of an example system architecture, according to at least one embodiment;

FIG. 2 is a block diagram of an example object tracking engine, according to at least one embodiment;

FIGS. 3A-C depict an example of tracking targets in an environment, according to at least one embodiment;

FIG. 4 depicts an example method of tracking partially occluded objects monitored by an intelligent video analytics system, according to at least one embodiment;

FIGS. 5A-5C depict an example of a partial occlusion of an object monitored by an intelligent video analytics system, according to at least one embodiment;

FIG. 6 depicts an example of updating coordinates for a multi-dimensional model of a partially occluded object, according to at least one embodiment;

FIG. 7 depicts another example of a partial occlusion of an object tracked by an intelligent video analytics system, according to at least one embodiment;

FIG. 8A illustrates a hardware structure for inference and/or training logic, according to at least one embodiment;

FIG. 8B illustrates a hardware structure for inference and/or training logic, according to at least one embodiment;

FIG. 9 illustrates an example data center system, according to at least one embodiment;

FIG. 10 illustrates a computer system, according to at least one embodiment;

FIG. 11 illustrates a computer system, according to at least one embodiment;

FIG. 12 illustrates at least portions of a graphics processor, according to one or more embodiments;

FIG. 13 illustrates at least portions of a graphics processor, according to one or more embodiments;

FIG. 14 is an example data flow diagram for an advanced computing pipeline, in accordance with at least one embodiment;

FIG. 15 is a system diagram for an example system for training, adapting, instantiating and deploying machine learning models in an advanced computing pipeline, in accordance with at least one embodiment;

FIGS. 16A and 16B illustrate a data flow diagram for a process to train a machine learning model, as well as client-server architecture to enhance annotation tools with pre-trained annotation models, in accordance with at least one embodiment;

FIG. 17A illustrates an example of an autonomous vehicle, according to at least one embodiment;

FIG. 17B illustrates an example of camera locations and fields of view for the autonomous vehicle of FIG. 17A, according to at least one embodiment;

FIG. 17C illustrates an example system architecture for the autonomous vehicle of FIG. 17A, according to at least one embodiment; and

FIG. 17D illustrates a system for communication between cloud-based server(s) and the autonomous vehicle of FIG. 17A, according to at least one embodiment.

### DETAILED DESCRIPTION

Embodiments of the present disclosure relate to methods and systems for multi-object tracking of partially occluded objects in a monitored environment. Accurately detecting and tracking objects depicted in images is a challenging task. Modern object detection and tracking systems can track an object in an environment by detecting the object in an image frame generated by a camera surveilling the environment and monitoring the position of the detected object across multiple image frames. In some instances, an occlusion event can occur while the position of the object is being tracked in the environment. During an occlusion event, two or more objects in an environment come too close to each other, and seemingly merge or combine with each other, which, in some instances, prevents the object detection and tracking system from differentiating between the two or more objects. For example, a partial occlusion (i.e., an object is partially merged or combined with another object) or full occlusion (i.e., an object is fully merged or combined with another object) can occur when an object (e.g., a person, an automobile, an animal, etc.) in an environment moves in front of or behind a static object (e.g., a lamp post, a tree, etc.) or another moving object, relative to a position of the camera that is surveilling the environment.

While both full and partial occlusions can disrupt object tracking, partial occlusions, in particular, can affect a system's ability to accurately detect the object after the occlusion event. For example, prior to a partial occlusion event, a system can detect an object in an environment and based on the detection, can associate the object with an initial bounding box that defines the location and size of the detected object in image frames depicting the object. During the partial occlusion event, the system can detect the portion of the object that is not occluded and can associate the detected portion with an additional bounding box, which may be smaller than and/or located at a different region of the image frames than the initial bounding box. Although the same object is depicted in the image frames prior to and during the partial occlusion event, the system may not detect that the partially occluded object (e.g., associated with the additional bounding box) is the same object associated with the initial bounding box. Accordingly, the system may identify the partially occluded object as a new or different object in the environment and may initiate tracking of the object (e.g., separately from the object for the initial bounding box). Object detection and tracking can consume a significant amount of computing resources (e.g., processor cycles, memory space, etc.), and multiple tracking processes for the same object (e.g., as triggered by the partial occlusion) can significantly increase the amount of computing resources consumed by the system.

In addition, tracking processes of the system may track a real-world geographic location of the object based on the location of the bounding box associated with the object (e.g., relative to bounding boxes for other objects in the environment). As the location of the bounding box for the partially occluded object may not accurately reflect the actual location of the object in the environment, the partial occlusion event can prevent the system from accurately tracking the real-world geographic location of the object. Further, some systems may implement artificial intelligence (AI) techniques for object detection and tracking. For example, one or more AI models can be trained to predict visual features of a detected object based on an image frame annotated by a bounding box associated with the detected object and/or predict a likelihood that visual features for a detected object correspond to a previously detected object in an environment. As image frames are given to the AI model (e.g., during an inference phase), the AI model can be retrained based on the given image frames and predicted visual features and/or predicted correspondence. As indicated above, the partial occlusion event for the object can impact the size and/or location of the bounding box associated with the object. Since an image frame depicting the partial occlusion event and the associated bounding box does not accurately reflect the size and/or location of the object, retraining the AI model based on this information can corrupt the AI model's ability to accurately predict visual features of a detected object (e.g., depicted by subsequent image frames) and/or a correspondence between visual features of a detected object and visual features of a previously detected object.

Embodiments of the present disclosure address the above and other deficiencies by providing techniques to recover a bounding box that completely encompasses an object (also referred to as a “full sized bounding box”) based on a bounding box for the object detected during a partial occlusion event (e.g., which encompasses a portion of the object). A camera component (e.g., a surveillance camera) can generate or otherwise obtain image frames depicting an environment. In some instances, an object may be partially occluded by another object in the environment relative to a perspective of the camera component. In such instances, a portion of the object may be depicted by the image frames (referred to below as a “depicted portion”) and another portion of the object may not be depicted by the image frames (referred to below as an “occluded portion”).

A system (e.g., an object detection and/or tracking system) can obtain the image frames from the camera component and can associate each object detected in the image frames with a bounding box, which defines the size and/or location of the detected object in the environment (referred to herein as a “detected bounding box”). For a respective detected object, the system can identify a reference point of the object based on one or more characteristics of the object. The characteristics of the object can be pre-defined (e.g., by a developer or operator of the system) based on a size and/or shape of objects having the same type. In an illustrative example, a detected object can have a type of a “person,” where a rectangle can encapsulate the size and/or shape of a “person.” In such example, the rectangle has a particular height (h) and width (w) (e.g., based on the height and width of the “person”), and the reference point of the object can be located at a center point of the rectangle (e.g., at a height of h/2 and a width of w/2), as defined by the developer or operator of the system.

The system can map coordinates of the detected bounding box for the object to coordinates of a multi-dimensional (e.g., three-dimensional (3D)) model of the object based on the identified reference point for the object. The multi-dimensional model of the object may represent the average size and/or shape of the object in multi-dimensions. In an illustrative example, the 3D model of a “person” can be encapsulated by a cylinder shape. In some instances, the size and/or shape of the object, as represented by the model, can be defined or otherwise provided by the developer or the operator of the system. For purposes of explanation and illustration, the multi-dimensional model is referred to as a 3D model herein. The system can map the coordinates of the detected bounding box (e.g., two-dimensional (2D) coordinates) to coordinates of the 3D model (e.g., 3D coordinates) via a projection matrix (e.g., a 3×4 projection matrix), which indicates the location of the detected bounding box coordinates relative to real-world coordinates. The system can map the bounding box coordinate for the reference point (e.g., at h/2 and w/2) to a reference coordinate of the 3D model that corresponds to a center point of the 3D object. In accordance with the previous example, the 3D model can be a model of a “person,” where the center point of the “person” corresponds to the waist of the person. Accordingly, the system can map the reference point coordinate of the bounding box to a coordinate of the 3D model representing the waist of a “person.” The mapping between the reference point coordinate of the detected bounding box to the center point of the 3D model indicates a real-world location (or approximate location) of the center point of the detected object in the environment. Based on the mapped reference coordinate of the 3D model, the system can determine one or more additional coordinates that correspond to different portions of the object, in view of the object type. For example, the system can determine a head coordinate (h) of the 3D model, representing a location of the person's head, and/or a foot coordinate (f), representing the location of the person's feet, based on the waist coordinate (h/2) mapped to the reference point of the detected bounding box.

The system can map one or more of the additional coordinates to an edge of the detected bounding box, based on the angle of the perspective of the camera component. For example, if the camera component is located above the objects in the environment, the angle of the perspective of the camera component may face down towards the objects and therefore, the head of each person detected in the environment may be detectable (e.g., even during a partial occlusion event). Therefore, the system can map the head coordinate to bounding box coordinates for a top edge of the bounding box, where the mapping indicates the height of the person in the environment. In some instances, the system can update the mapping between the reference point and the reference coordinate of the 3D model based on the mapping between the head coordinate and the top edge bounding box coordinate and in view of the pre-defined height of a person (e.g., as provided by the developer or operator of the system). The system may also update the foot coordinate (f) of the 3D model based on the updated mapping between the reference point and the reference coordinate. For example, the value of the foot coordinate can be updated such that a vertical distance between the head coordinate (h) and the foot coordinate (f) is approximately the height of an average person (e.g., as defined by the developer or the operator of the system).

The system can obtain an updated set of coordinates for the 3D model based on the head coordinate (which is mapped to the top edge bounding box coordinate), the updated reference coordinate, and/or the updated foot coordinate. The updated set of coordinates for the 3D model can define the shape and/or a size of a cylinder that encapsulates the 3D model. In some instances, the system can associate a bounding box with the cylinder that encapsulates the 3D model, where the associated bounding box represents the full size and/or the shape of the object in the environment, regardless of the partial occlusion depicted by the image frame(s). The system can provide the updated set of coordinates and/or the associated bounding box for tracking a location of the object in the environment during an occlusion event, in some instances. For example, the system can provide the updated set of coordinates to an object tracking engine that tracks the location of objects within the environment across a sequence of image frames. Based on the updated set of coordinates, the object tracking engine can associate the partially occluded object with the object, as detected prior to the partial occlusion. In another example, the system can provide the updated set of coordinates to an object location engine that tracks a location of the object relative to real-world geographic coordinates associated with the environment. The object location engine can estimate a real world location of the object based on the updated foot coordinate of the updated set of coordinates, in some instances. In yet another example, the system can provide the updated set of coordinates to a tracking correction engine that associates newly detected objects in the environment with previously detected objects in the environment. The tracking correction engine can determine, based on characteristics of the object as indicated by the updated set of coordinates, that the object detected during the partial occlusion is the same object that was detected prior to the partial occlusion (e.g., and therefore that the partially occluded object is not a new object for tracking).

Aspects and embodiments of the present disclosure provide techniques to enable a system to recover a full size bounding box for an object during a partial occlusion event based on image data depicting a single view of the environment. Based on the reference point identified for the depicted portion of a partially occluded object, the system can determine a location and/or size of the occluded portion of the object, and therefore can recover the full size bounding box for the object. The system can map coordinates of the detected bounding box to a multi-dimensional model of the object, which can inform the system of the location of the object in a monitored environment during the partial occlusion event. Accordingly, embodiments of the present disclosure enable the system to track the real world location of the object in the environment during an occlusion event in real time, which prevents the system from incorrectly tracking more targets than are actually present in the environment being surveilled. By reducing the number of incorrectly tracked objects monitored by the system, the number of tracking processes managed and/or executed by the system decreases, which reduces the number of computing resources (e.g., processor cycles, memory space, etc.) consumed by the system. Further, as embodiments of the present disclosure enable the system to recover the full size bounding box of a partially occluded object, such data provided to an AI model (e.g., trained to predict visual features of a detected object and/or a likelihood that visual features for a detected object correspond to features of a previously detected object in the environment) accurately reflects the size and/or shape of the object present in the environment. This can reduce the risk of corrupting the AI model's ability to accurately predict visual features of a detected object and/or a correspondence between visual features of a detected object and visual features of a previously detected object, e.g., if such data is used for retraining the AI model. Finally, embodiments of the present disclosure can be implemented in environments that include a single image device (e.g., a camera) capturing a single view of the environment, thereby reducing the total number of devices present in an environment and reducing the overall number of resources (e.g., hardware resources, computing resources, etc.) accessed to perform object tracking in an environment.

The systems and methods described herein may be used for a variety of purposes. By way of example and without limitation, these purposes may include systems or applications for online multiplayer gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing operations using one or more language models including-without limitation-one or more large language models (LLMs), one or more vision language models (VLMs), and/or one or more multi-modal language models, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

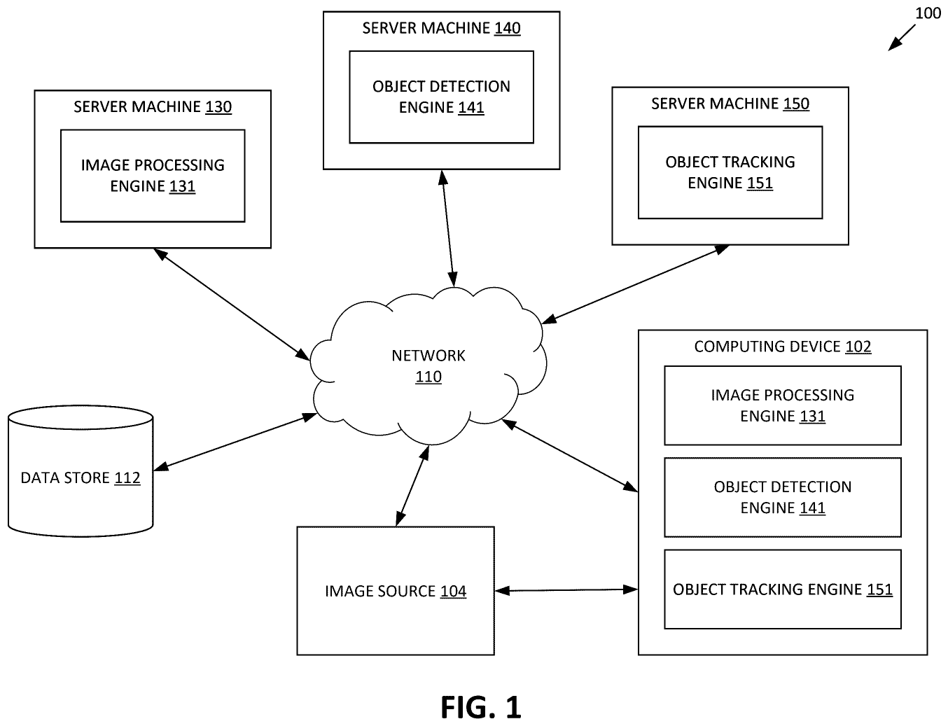

FIG. 1 is a block diagram of an example system architecture 100, according to at least one embodiment. The system architecture 100 (also referred to as “system” herein) may include a computing device 102, an image source 104, one or more data stores 112, and/or server machines (e.g., server machines 130-150), each connected to a network 110. In implementations, network 110 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Computing device 102 may be a desktop computer, a laptop computer, a smartphone, a tablet computer, a server, or any suitable computing device capable of performing the techniques described herein. In some embodiments, computing device 102 may be a computing device of a cloud computing platform. For example, computing device 102 may be, or may be a component of, a server machine of a cloud computing platform. In such embodiments, computing device 102 may be coupled to one or more edge devices (not shown) via network 110. An edge device refers to a computing device that enables communication between computing devices at the boundary of two networks. For example, an edge device may be connected to computing device 102, data store 112, server machine 130, server machine 140, and/or server machine 150 via network 110, and may be connected to one or more endpoint devices (not shown) via another network. In such example, the edge device can enable communication between computing device 102, data store 112, server machine 130, server machine 140, and/or server machine 150 and the one or more endpoint devices. In other or similar embodiments, computing device 102 may be, or may be a component of, an edge device. For example, computing device 102 may facilitate communication between data store 112, server machine 130, server machine 140, and/or server machine 150, which are connected to computing device 102 via network 110, and one or more endpoint devices that are connected to computing device 102 via another network.

In still other or similar embodiments, computing device 102 may be, or may be a component of, an endpoint device. For example, computing device 102 may be, or may be a component of, devices, such as, but not limited to: televisions, smart phones, cellular telephones, personal digital assistants (PDAs), portable media players, netbooks, laptop computers, electronic book readers, tablet computers, desktop computers, set-top boxes, gaming consoles, autonomous vehicles, surveillance devices, and the like. In such embodiments, computing device 102 may be connected to data store 112, server machine 130, server machine 140 and/or server machine 150 via network 110. In other or similar embodiments, computing device 102 may be connected to an edge device (not shown) of system 100 via a network and the edge device of system 100 may be connected to data store 112, server machine 130, server machine 140 and/or server machine 150 via network 110.

Image source 104 may be or may include one or sensors that are configured to generate data, such as visual data, audio data, etc., associated with an environment. The sensors can include an image sensor (e.g., a camera), a light detection and ranging (LIDAR) sensor, a radio detection and ranging (RADAR) sensor, sound navigation and ranging (SONAR) sensor, an ultrasonic sensor, a microphone, and other sensor types. In some embodiments, the data collected and/or generated by the sensors may represent a perception of the environment by the sensors. It should be noted that although some embodiments of the present disclosure are directed to image data (e.g., an image) generated by one or more sensors of image source 104, embodiments of the present disclosure may be applied to any type of data generated by one or more sensors of image source 104 (e.g., LIDAR data, RADAR data, SONAR data, ultrasonic data, audio data, etc.).

In some embodiments, image source 104 may be a component of, or may be otherwise connected to, computing device 102. For example, as described above, computing device 102 may be, or may be a component of, an endpoint device. In such embodiments, image source 104 may be a camera component of computing device 102 that is configured to generate an image and/or video data associated with the environment. In other or similar embodiments, image source 104 may be a device, or a component of or otherwise connected to a device that is separate and distinct from computing device 102. For example, as described above, computing device 102 may be, or may be a component of, a cloud computing platform or an edge device. In such embodiments, image source 104 may be a device (e.g., a surveillance camera, a device of an autonomous vehicle, etc.) that is connected to computing device 102, data store 112, and/or server machines 130-150 via network 110 or another network.

In some implementations, data store 112 is a persistent storage that is capable of storing content items (e.g., images) and data associated with the stored content items (e.g., object data, image metadata, etc.) as well as data structures to tag, organize, and index the content items and/or object data. Data store 112 may be hosted by one or more storage devices, such as main memory, magnetic or optical storage based disks, tapes or hard drives, NAS, SAN, and so forth. In some implementations, data store 112 may be a network-attached file server, while in other embodiments data store 112 may be some other type of persistent storage such as an object-oriented database, a relational database, and so forth, that may be hosted by computing device 102 or one or more different machines coupled to the computing device 102 via network 110 or another network.

Data store 112 may be or may include a domain-specific or organization-specific repository or data base. In some embodiments, computing device 102, image source 104, server machine 130, server machine 140, and/or server machine 150 may only be able to access data store via network 110, which may be a private network. In other or similar embodiments, data stored at data store 112 may be encrypted and may be accessible to computing device 102, image source 104, server machine 130, server machine 140, and/or server machine 150 via an encryption mechanism (e.g., a private encryption key, etc.). In additional or alternative embodiments, data store 112 may be a publicly accessible data store that is accessible to any device via a public network.

Server machine 130 may include an image processing engine 131 that is configured to process data generated by image source 104. For example, image source 104 and/or computing device 102 may encode image data (e.g., using a codec) generated by image source 104 prior to transmitting the image data to another device of system 100 via network 110 (or another network). Image processing engine 131 may decode the encoded image data (e.g., using the codec). In some embodiments, image processing engine 131 may re-encode decoded image data (e.g., using a different codec), prior to providing the image to another component or device of system 100. In some embodiments, image process engine 131 may be configured to select, combine, and transmit signals (e.g., via a multiplexer component, etc.) associated with image data generated by image source 104 to another component or device of system 100. In additional or alternative embodiments, image processing engine 131 may be configured to modify a quality of the image data generated by image source 104 before the image data is used for object detection and/or object tracking (e.g., by object detection engine 141 and/or object tracking engine 151). For example, image processing engine 131 may be configured to apply one or more transformations to an image generated by image source 104 to remove or reduce an amount of noise present in the image, to crop the image, and so on. It should be noted that although some embodiments of the present disclosure provide that image processing engine 131 may modify a quality of image data, other components of system 100 (e.g., object detection engine 141, object tracking engine 151, etc.) may also be configured to modify the quality of the image data.

Server machine 140 may include an object detection engine 141 configured to detect one or more objects included in images depicting an environment, such as images generated by image source 104. In some embodiments, object detection engine 141 may provide an image depicting an environment as input to a trained object detection model. The object detection model may be trained using historical data (e.g., historical images, historical object data, etc.) from one or more datasets to detect an object (referred to here as a detected object) included in a given input image depicting an environment, and estimate a region of the given input image that includes the detected object (referred to herein as a region of interest). In some embodiments, one or more outputs of the object detection model can indicate object data associated with the detected object. The object data may indicate a region of interest of a given input image that includes the detected object. For example, the object data can include a bounding box or another bounding shape (e.g., a spheroid, an ellipsoid, a cylindrical shape, etc.) that corresponds to the region of interest of the given input image. In some embodiments, the object data can include other data associated with the detected object, such as an object class corresponding to the detected object, mask data associated with the detected object (e.g., a two-dimensional (2D) bit array that indicates pixels (or groups of pixels) that corresponds to the detected object), and so forth.

Server machine 150 may include an object tracking engine 151 configured to track a state of one or more objects detected in one or more images (e.g., generated by image source 104). For purposes of explanation, an object that is detected by object detection engine 141 is referred to herein as a detected object. An object that is tracked by object tracking engine 151 is referred to herein as a target object or a target. A state of a target, as provided herein, may correspond to a location of an object within an environment depicted by the one or more images, a position of the object within the environment, a scale or size of the object within the environment, a velocity of the object within the environment, and so forth.

In some embodiments, object tracking engine 151 may track a target based on an image including the target and object data (e.g., one or more bounding boxes) associated with the target. Object tracking engine 151 may instantiate an object tracker component (referred to as an object tracker herein) for each detected object in an image depicting the environment. An object tracker may be a logical component that is configured to maintain state data associated with a target within a set of images (e.g., a sequence of video frames) depicting the environment. For example, when an object is initially detected in an image (e.g., a video frame), object tracking engine 151 may instantiate an object tracker to monitor and determine a state associated with the detected object (referred to herein as a current state of the target). Object detection engine 141 may detect the target in other images depicting the environment (e.g., subsequent video frames) and the object tracker associated with the target may determine, for each of the other images, the current state of the target. The object tracker may update state data associated with the object to correspond to the determined current state and store the updated state data (e.g., at data store 112). In some embodiments, the object tracker may further estimate a future state of the target in the environment and may store an indication of the future state (e.g., at data store 112) with the updated state data. Further details regarding determining the current state of a target and estimating the future state of the target are provided herein.

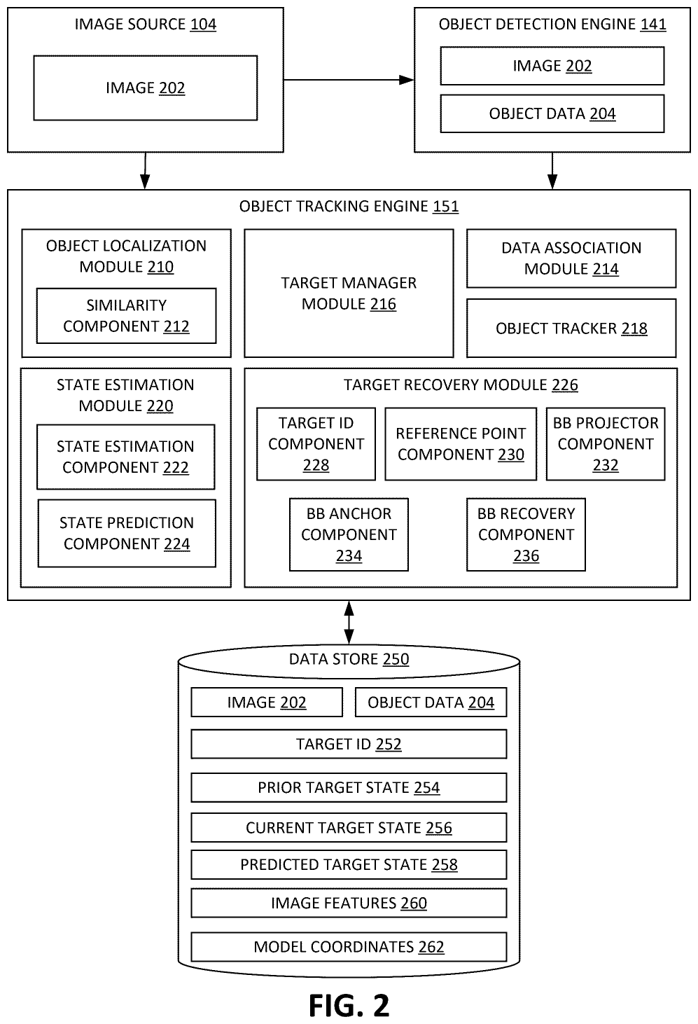

In some embodiments, a target in an environment can move close to another object (e.g., another target, an object that is not tracked by system 100, etc.) in the environment (e.g., relative to the viewpoint of the image source 104) such that the target seemingly merges or combines with the other object. Such instance is referred to herein as an occlusion event. A partial occlusion (i.e., an object is partially occluded by another object) or a full occlusion (i.e., an object is fully occluded by another object) can occur when the target moves in front of or behind a static object or target or another moving object or target, relative to a position and/or location of image source 104. During a partial occlusion event, object data obtained by object detection engine 141 for the target may be different from object data previously obtained for the target (e.g., in prior image frames). For example, object data obtained during the partial occlusion event may include a bounding box having a smaller size and/or a different shape from a bounding box of object data obtained during the partial occlusion event. As the object data obtained during the partial occlusion event does correspond to the object data previously obtained for the target, object tracking engine 151 may not be able to accurately track the location of the target and/or the characteristics of the target during the partial occlusion event. As described in further detail herein, object tracking engine 151 can identify a reference point for the partially occluded target (e.g., based on image data collected during the occlusion event) and can recover the characteristics (e.g., size, shape, etc.) of a full size bounding box for the target based on the identified reference point. As described herein, a full size bounding box refers to a bounding box that encompasses (or approximately encompasses) the size and shape of the target. Object tracking engine 151 can map coordinates of the bounding box for the object to coordinates of a multi-dimensional (e.g., 3D) model of the object and can determine the location of the full size bounding box (and therefore the target) in the environment based on the mapping. Further details regarding recovering the full size bounding box for an object are described below with respect to FIGS. 2-6.

In some implementations, computing device 102, image source 104, data store 112, and/or server machines 130-150, may be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable object detection based on an image (e.g., image 106). It should be noted that in some other implementations, the functions of computing device 102, image source 104, server machines 130, 140, and/or 150 may be provided by a fewer number of machines. For example, in some implementations, server machines 130, 140, and/or 150 may be integrated into a single machine, while in other implementations server machines 130, 140, and 150 may be integrated into multiple machines. In addition, in some implementations one or more of server machines 130, 140, and 150 may be integrated into computing device 102. For example, as illustrated in FIG. 1, image processing engine 131, object detection engine 141, and/or object tracking engine 151 may reside at on computing device 102, in some embodiments. In general, functions described in implementations as being performed by computing device 102 and/or server machines 130, 140, 150 may also be performed on one or more edge devices (not shown) and/or client devices (not shown), if appropriate. In addition, the functionality attributed to a particular component may be performed by different or multiple components operating together. Computing device 102 and/or server machines 130, 140, 150 may also be accessed as a service provided to other systems or devices through appropriate application programming interfaces.

It should be noted that although FIG. 1 illustrates image processing engine 131, object detection engine 141, and object tracking engine 151 as part of computing device 102, in additional or alternative embodiments, image processing engine 131, object detection engine 141, and/or object tracking engine 151 can reside on one or more server machines that are remote from computing device 102. It should be noted that in some other implementations, the functions of computing device 102 and/or server machines 130-150 can be provided by more or a fewer number of machines. For example, in some implementations, components and/or modules of computing device 102 and/or server machines 130-150 may be integrated into a single machine, while in other implementations components and/or modules of any of computing device 102 and/or server machines 130-150 may be integrated into multiple machines. In some embodiments or examples, image processing engine 131, object detection engine 141, and/or object tracking engine 151, or functionalities of image processing engine 131, object detection engine 141, and/or object tracking engine 151 can be included as part of a streaming analytics toolkit for target tracking, such as DeepStream SDK by NVIDIA Corporation®.

In general, functions described in implementations as being performed platform 120, server machine 160 and/or predictive system 180 can also be performed on the client device(s) 102 in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an image source 104, an object detection engine 141 and an object tracking engine 151, according to at least one embodiment. As described with respect to FIG. 1, image source 104 may be or may include one or more sensors (e.g., image sensors, etc.) that are configured to generate data associated with an environment. For example, image source 104 may be, or may include, a camera component that is configured to generate a video stream (i.e., a sequence of video frames or image frames) depicting the environment over a period of time.

Image source 104 may generate an image 202, in accordance with previously described embodiments, and may provide the image 202 to object detection engine 141. In some embodiments, image source 104 may provide image 202 to image processing engine 131, as described with respect to FIG. 1. Image processing engine 131 may process image 202, in accordance with previously described embodiments, and provide image 202 to object detection engine 141. In response to obtaining image 202, object detection engine 141 may provide image 202 as input to a trained object detection model and obtain one or more outputs of the model that indicate object data 204 associated with one or more objects detected in image 202, as previously described. The trained object detection model may be, for example, an artificial neural network such as a convolutional neural network trained to identify one or more types of objects, such as cars, people, animals, and so on. In some embodiments, object data 204 may include a bounding box (or a bounding shape) that indicates a region of image 202 that includes a detected object. Image 202 and/or object data 204 may be stored at data store 250, in some embodiments. Data store 250 may correspond to data store 112, described with respect to FIG. 1, or may be different from data store 112.

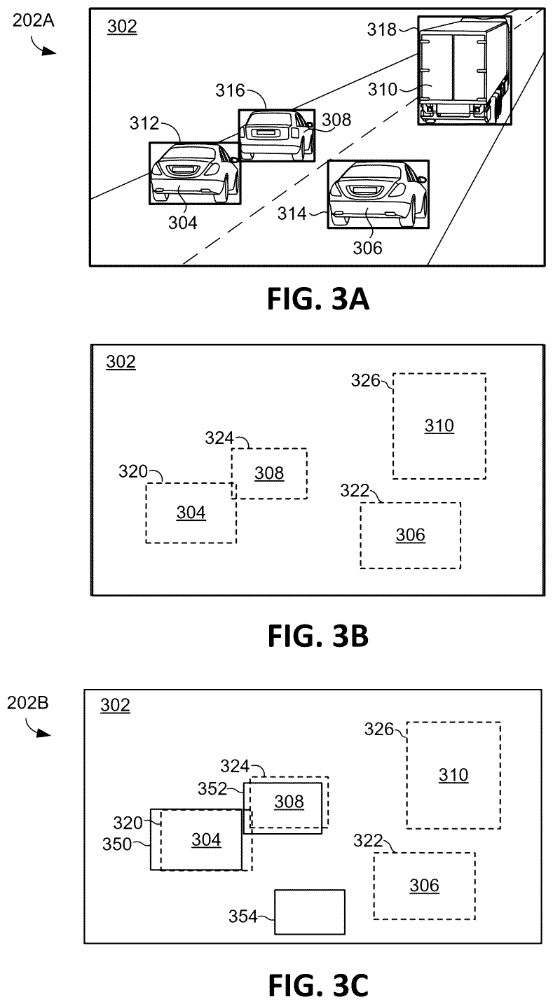

FIGS. 3A-3C depict example images 202A-202B generated by image source 104, according to at least one embodiment. As illustrated in FIG. 3A, image 202A depicts an example environment 302 including objects 304, 306, 308 and 310. In some embodiments, image 202A may be a first video frame of a sequence of video frames depicting environment 302. Object detection engine 131 may obtain image 202A and provide image 202A as input to a trained object detection model, as described above. One or more outputs of the object detection model may indicate regions of image 202A that include detected objects. The regions of image 202A indicated by the one or more outputs may correspond to a bounding box or other bounding shape associated with the detected objects. For example, a first region indicated by the one or more outputs may correspond to a first bounding box 312 associated with object 304, a second region may correspond to a second bounding box 314 associated with object 306, a third region may correspond to a third bounding box 316 associated with object 308 and a fourth region may correspond to a fourth bounding box 318 associated with object 310. Object data 204 generated for image 202A may include an indication of bounding boxes 312-318, in some embodiments.

Referring back to FIG. 2, object tracking engine 151 may obtain image 202 and/or object data 204 from object tracking engine 141, from image source 104, and/or via a data store, such as data store 112 described with respect to FIG. 1. As illustrated in FIG. 2, object tracking engine 151 may include an object localization module 210, a data association module 214, a target manager module 216, one or more object trackers 218, a state estimation module 220, and/or a target recovery module 226. Object localization module 210 may be configured to estimate a location of existing targets (referred to herein as localizing targets) tracked by object tracking engine 151 in a sequence of images 202 generated by image source 104.

In some embodiments, in response to obtaining object data 204, object localization module 210 may determine whether any object trackers 218 have been instantiated to track targets in the environment depicted in image 202. As described with respect to FIG. 3A, image 202A may be a first video frame of a sequence of video frames depicting environment 302. As image 202A may be the first video frame, object localization module 210 may determine that no object trackers 218 have been instantiated to track targets at the time object tracking module 151 obtains image 202A. In such embodiments, object localization module 210 may extract one or more visual features associated with each detected object (i.e., objects 304, 306, 308, 310) depicted in image 202A. The visual features may include an indication of one or more colors present in a set of pixels of a region of image 202A indicated by a bounding box (referred to herein as a bounding box region), a Histogram-of-Oriented-Gradient (HOG) of the bounding box region, or other visual features. Object localization module 210 may extract the visual features associated with the detected objects from the regions of image 202A indicated by bounding boxes 312, 314, 316, and 318.

The detected objects from different video frames may be compared to one another based on their visual features by similarity component 212. In some embodiments, similarity component 212 of object localization module 210 may generate a set of similarity metric values each indicating a similarity between a detected object 304, 306, 308, 310 from a current image or video frame and an existing target (e.g., associated with visual features extracted from one or more previous image or video frame). As described above, object localization module 210 may determine that no object trackers 218 have been instantiated for targets at the time image 202A is obtained, and therefore object tracking engine 151 may not be tracking any targets. Accordingly, similarity component 212 may assign each of the detected objects 304, 306, 308, 310 a particular similarity metric value (e.g., a low similarity metric value) which indicates that each of the detected objects 304, 306, 308, 310 do not correspond to an existing target.

Referring back to FIG. 2, in some embodiments, object detection engine 141 may not attempt to detect objects and generate object data 204 for each image 202 generated by image source 104 (e.g., in accordance with a protocol for the video analytics system). For example, object detection engine 141 may be configured to detect objects in every other image 202 generated by image source 104, every few images 202 generated by image source 104, etc. In such embodiments, object localization module 210 may be configured to detect and localize one or more objects depicted in image 202 using a correlation filter. A correlation filter refers to a class of classifiers that are configured to produce peaks in correlation outputs or responses. In some embodiments, a peak in a correlation output or response can correspond to an object depicted in image 202. In some embodiments, a correlation filter can include at least one of a Kernelized Correlation Filter (KCF), a discriminative correlation filter (DCF), a Correlation Filter neural network (CFNN), a Multi-Channel Correlation Filter (MCCF), a Kernel Correlation Filter, an adaptive correlation filter, and/or other filter types. A correlation filter may be implemented using one or more machine learning models, such as a machine learning model that uses linear regression, logistic regression, decision trees, support vector machines (SVM), Naïve Bayes, K-nearest neighbor (KNN), K-means clustering, random forest, dimensionality reduction algorithms, gradient boosting algorithms, neural networks (e.g., auto-encoders, convolutional, recurrent, perceptrons, long/short term memory/LSTM, Hopfield, Boltzmann, deep belief, deconvolutional, generative adversarial, liquid state machine, etc.), and/or other types of machine learning models.

A correlation filter may be trained to produce or identify a peak correlation response at a region of an image that corresponds to a reference coordinate (e.g., a center) of an object depicted in the image. Object localization module 210 may obtain an image 202 (i.e., from image source 104 or via data store 250) and apply the correlation filter to image 202 to obtain one or more outputs. The one or more outputs of the correlation filter can indicate one or more peak locations of a correlation response for image 202 (referred to herein simply as a correlation response). The locations of one or more correlation responses may correspond to regions of image 202 that depict an object in the environment and, in some embodiments, the peak location of the correlation response may correspond to the reference coordinate (e.g., the center) of the depicted object. Object localization module 210 may identify the regions of image 202 that are associated with a respective correlation response as regions of image 202 that depict a respective object (referred to herein as a correlation response region). In some embodiments, similarity component 212 may extract features from a correlation response region and assign a similarity metric value to the respective object depicted in the correlation response region and existing targets tracked by object tracking engine 151, as described above and in further detail below.

In some embodiments, object localization module 210 may apply the correlation filter to an image 202 even if object detection engine 141 generates object data 204 associated with image 202. In such embodiments, object localization module 210 may use object data 204 and the output of the correlation filter to improve (i.e., re-train) the correlation filter for subsequent images (e.g., video frames) generated by image source 104. For example, object localization module 210 may identify the correlation response regions of image 202 based on one or more outputs of the correlation filter. Object localization module 210 may compare the correlation response at the respective correlation response regions of image 202 to each bounding box indicated by object data 204 and determine an accuracy of the respective correlation responses based on the comparison. In some embodiments, object localization module 210 may provide an indication of the correlation responses, the bounding boxes indicated by object data, and/or the determined accuracy of each respective correlation responses to re-train the correlation filter.

It should be noted that although some embodiments of the present disclosure are directed to localizing visual features of detected or depicted objects to the existing targets, other techniques may be used to localize the existing targets. For example, in response to obtaining object data 204 for image 202, object localization module 210 may extract one or more visual features from regions of image 202 indicated by bounding boxes of object data 204. Object localization module 210 may provide the extracted visual features as input to a machine learning model (e.g., a recurrent neural network, etc.) and obtain one or more outputs of the machine learning model. Object localization module 210 may extract, from the one or more obtained outputs, an identifier associated with one or more attributes of the extracted visual features. Object localization module 210 may compare the extracted identifier to identifiers associated with existing targets and provide an indication of the comparison to data association module 214, in some embodiments.

Object localization module 210 may provide an indication of the object data 204 associated with image 202 (e.g., the bounding box regions of image 202, correlation response regions of image 202, etc.) and the set of similarity metric values to data association module 214. Data association module 220 may be configured to determine whether a bounding box region and/or a correlation response region corresponds to an estimated location of an existing target (i.e., indicated by a future target state 258 for the target, as described below). In some embodiments, data association module 214 can compare a location of a respective bounding box region to a location of an estimated target location and determine, based on the comparison, whether the bounding box region is located within a threshold proximity of the estimated target location. In response to determining that the bounding box region is located within the threshold proximity of the estimated target location, data association module 214 may determine that bounding box region matches, or approximately matches, the region of image 202 that corresponds to the estimated target location. Such bounding box regions are referred to herein as matched bounding box regions. Responsive to determining that the bounding box region is located outside of the threshold proximity of the estimated target location, data association module 214 may determine that the bounding box region does not match the region of image 202. Such bounding box regions and estimated target locations are referred to herein as unmatched bounding box regions and unmatched estimated target locations, respectively.

In additional or alternative embodiments, data association module 214 may determine whether a bounding box region of image 202 corresponds to an estimated target location based on a similarity metric value associated with the detected object included in the bounding box region and a respective target (e.g., determined from one or more previous images). For example, in response to determining that a similarity metric value associated with a detected object and a respective target satisfy a similarity criterion (e.g., the similarity metric value meets or exceeds a threshold value), data association module 214 may determine that the bounding box region that includes the detected object matches or approximately matches the estimated target location (i.e., the bounding box region is a matched bounding box region). Responsive to determining that the similarity metric value does not satisfy the similarity criterion (e.g., the similarity metric falls below the threshold value), data association module 214 may determine that the bounding box region that includes the detected object does not match the estimated target location (i.e., the bounding box region and/or the estimated target location is an unmatched bounding box region and/or an unmatched estimated target location, respectively).

In some embodiments, data association module 214 may provide an indication of each unmatched bounding box region and unmatched estimated target location to target manager module 216, in some embodiments. Target manager module 316 may be configured to instantiate and/or terminate each object tracker 218 of object tracking engine 151. As indicated above, an object tracker refers to a logical component that is configured to track a state of a target included in a set of images (e.g., a sequence of video frames) depicting an environment. In response to receiving the indication of the unmatched bounding box regions and/or unmatched estimated target locations, target manager module 216 may determine whether to instantiate one or more new object trackers 218 (i.e., to create a new target) or terminate an instantiated object tracker 218 for an existing target (e.g., in accordance with a target termination policy). In an illustrative example, an unmatched bounding box region may indicate to the target manager module 216 that a new object has been detected in the surveilled environment. Accordingly, target manager module 216 may instantiate a new object tracker 218 to track the state of the detected object in image 202 and subsequent images (e.g., video frames) generated by image source 104. In some embodiments, target manager module 216 may instantiate a new object tracker 218 by assigning the target a target identifier (ID) and storing the target ID at data store 250 as target ID 252. In another illustrative example, an unmatched estimated target location may indicate to target manager module 216 that a target is no longer present in the environment surveilled by image source 104. In response to determining that the target satisfies one or more conditions of a target termination policy, target manager module 216 may terminate an object tracker 218 that was instantiated to track the state of the target. In some embodiments, target manager module 216 may terminate the object tracker 218 by removing the target ID 252 for the terminated target from data store 250 and/or recycling the target ID 252 of the terminated target to be used for a new target.

As indicated previously with respect to FIG. 3A, image 202A may be the first video frame in a sequence of video frames generated by image source 104 and no object trackers 218 may be instantiated for any targets in environment 302 at the time image 202A is generated. Data association module 214 may identify each bounding box 312, 314, 316, 318 as unmatched bounding box regions and accordingly, target manager module 216 may instantiate a respective object tracker 218 for each of objects 304, 306, 308, and 310, in accordance with previously described embodiments.

Referring back to FIG. 2, an object tracker 218 may be configured to track a state of a respective target in an environment. A target state may refer to a location, a position, a scale or size, a velocity, etc. associated with a target during a time period that an image 202 is generated. An object tracker 218 associated with a respective target may determine one or more target states (e.g., a prior target state 254, a current target state 256, a predicted target state 258, etc.) based on state estimations and/or predictions made by state estimation module 220. As illustrated in FIG. 2, state estimation module 220 may include a state estimation component 222 and a state prediction component 224. State estimation component 222 may be configured to determine a current target state 256 based on state data associated with a target at the time an image 202 depicting the target is generated. For example, a current target state 256 may be defined by one or more coordinates for a bounding box associated with the target in image 202, a size of the bounding box associated with the target, and/or a change in the one or more coordinates for the bounding box relative to prior coordinates of a bounding box associated with the target in one or more prior images depicting a surveilled or monitored environment. In another example, the current target state 256 may be further defined by a change in the size of the bounding box associated with the target relative to a bounding box associated with the target in the one or more prior images. In some embodiments, the current target state 256 may also include one or more target features (e.g., extracted from the bounding box region of image 202, extracted from a correlation response region of image 202, etc.).

In some embodiments, state estimation component 222 may determine a current target state based on data obtained for the target from image 202. For example, an object tracker 218, data association module 214 and/or object localization module 210 may provide an indication of one or more bounding boxes associated with the target to state estimation component 222, in some embodiments. State estimation component 222 may determine the coordinates of the one or more bounding boxes and/or the size of the one or more bounding boxes based on the provided data. In some embodiments, state estimation component 222 may determine whether the target is a new target in image 202 or the target is an existing target that was tracked before image 202 was generated. In response to determining that the target was an existing target, state estimation component 222 may obtain prior target state data 254 for the target (e.g., from data store 250). Prior target state data 254 refers to target state data that as estimated (e.g., by state estimation component 222) for a target based on images generated prior to image 202. State estimation component 222 may determine the change in the one or more coordinates for the bounding box associated with the target by determining a distance between the one or more coordinates of the bounding box associated with image 202 and coordinates of a bounding box associated with the target depicted in one or more prior images. State estimation component 222 may determine a speed and direction (i.e., a velocity) at which the target is moving based on the determined distance. In some embodiments, state estimation component 222 may further determine a change in the size or scale of the target based on the determined distance.

As indicated above, the change in the one or more coordinates for the bounding box associated with the target depends on the location of a bounding box for an image generated prior to image 202. Accordingly, if a target is a new target in image 202, state estimation component 222 may not determine the change in the location and/or size or scale of the target (i.e., as no prior images generated by image source 104 depict the target). If the target is depicted in subsequent images of the surveilled environment, state estimation component 222 may determine the velocity and/or size or scale change of the target when the subsequent images are generated, in accordance with previously described embodiments.

It should be noted that in some embodiments described below, object localization module 210 may identify one or more correlation response regions of image 202 (e.g., using a correlation response filter, etc.). In such embodiments, state estimation component 222 may determine the current state of the target based on the identified correlation response regions in addition to or in lieu of the bounding box regions of image 202.

State estimation component 222 may store the coordinates of the one or more bounding boxes, the coordinates of one or more correlation response regions, the size of the one or more bounding boxes and/or the correlation response region, the velocity of the target, and/or the change in size or scale of the target as current target state 256 in data store 250. In some embodiments, state prediction component 224 may be configured to predict a future state of the target in the environment based on the current target state 256 for the target. In some embodiments, state prediction component 224 may obtain the current target state 256 and provide the current state 256 as an input to one or more state prediction functions. A state prediction function may be configured to execute a recursive filter, such as a Kalman Filter (KF), to estimate a future state of a target in the environment. State prediction component 224 may obtain an output from the one or more state prediction functions and determine, based on the output, a future state of the target during a time that is subsequent to when image 202 is generated, in some embodiments. In other or similar embodiments, state prediction component 224 may determine multiple future states of the target during a time period that is subsequent to when image 202 is generated. For example, state prediction component 224 may determine, based on the output of the one or more state prediction functions, a future state of the target at each instance of time of a time period that is subsequent to when image 202 is generated. State prediction component 224 may store the one or more future states of the target at data store 250 as future target state 258.

In additional or alternative embodiments, state prediction component 224 may use one or more machine learning models to predict the future state of the target. The one or more machine learning models may include a long term short term memory (LSTM) model, or another type of recurrent neural network (RNN) model. In some embodiments, the one or more machine learning models may be trained using historical object data and/or historical target state data to predict a future state of a target based on given target state and/or object data. State prediction component 224 may provide object data 204, the prior target state 254 and/or the current target state 256 for a target as input to the one or more machine learning models and may obtain an output of the one or more models. State prediction component 224 may extract, from the one or more outputs, multiple sets of state data for the target. Each set of target state data may correspond to a future state of the target at an instance of time that is subsequent to when image 202 is generated. In some embodiments, state prediction component 224 may also extract an indication of a level of confidence that a respective set of state data corresponds to the target. State prediction component 224 may identify one or more sets of state data associated with a level of confidence that satisfies a level of confidence criterion. For example, state prediction component 224 may identify a set of state data that is associated with the higher level of confidence than other sets of state data extracted from the one or more outputs. In another example, state prediction component 224 may identify each set of state data associated with a level of confidence that meets or exceeds a threshold level of confidence. Responsive to identifying the one or more sets of state data, state prediction component 224 may store the one or more sets of state data as predicted target state 258 at data store 250, as described above.

As described above, target manager module 216 may instantiate a new object tracker 218 to track a state of a newly detected object in image 202 (e.g., in view of an unmatched bounding box determined for image 202). However, in some embodiments, the newly instantiated object tracker 218 may not be configured to begin tracking the target until the target has been detected (e.g., by object detection engine 141 and/or object localization module 210) for a threshold number of images 202 generated by image source 104. In an illustrative example, target manager module 216 may instantiate an object tracker 218 to track an object that is first detected in a first video frame. However, the object tracker 218 for the target may not obtain and/or provide state data associated with the target based on first video frame (i.e., the object tracker 218 may not be tracking the state of the target based on the first video frame). If the target is detected (e.g., by object detection engine 141 and/or object localization module 210) in a threshold number of subsequent video frames, the object tracker 218 may be configured to obtain state data for the target and provide the state data to state estimation module 220, in accordance with embodiments described above. The technique of delaying tracking of a target until the target is detected in a threshold number of images 202 generated by image source 104 is referred to herein as late object tracker activation or simply late activation.

FIG. 3B depicts one or more estimated locations of targets 304, 306, 308, 310 in environment 302 at a time period after image 202A is generated. The estimated locations of targets 304, 306, 308, 310 may correspond to a predicted target state 258 associated with each target, as determined by state prediction component 224, in accordance with previously described embodiments. As illustrated in FIG. 3B, state prediction component 224 can predict that target 304 may be present at location 320 of environment 302, target 306 may be present at location 322 of environment 302, target 308 may be present at location 324 of environment 302, and target 310 may be present at location 326 of environment 302 in a future image or video frame. In some embodiments, object localization module 210 may localize targets 304, 306, 308, 310 based on the estimated locations 320, 322, 324, 326 (e.g., if object detection engine 141 does not generated object data 204 associated with an image generated after image 202A, as described above).

FIG. 3C illustrates another image 202B depicting example environment 302. In some embodiments, image 202B may be a video frame that is subsequent to the first video frame (i.e., image 202A) of the sequence of video frames depicting environment 302. Object detection engine 141 may generate object data 204 for one or more objects detected in image 202B. As illustrated in FIG. 3C, object data 204 may include bounding boxes 350, 352, and 354. Object localization module 210 may obtain image 202A and the corresponding object data 204, as described above, and initiate one or more processes to localize existing targets (e.g., targets 304, 306, 308, 310) in image 202B. In some embodiments, object localization module 210 may obtain predicted state data 258 associated with each respective target (e.g., from data store 250) and may estimate a location of each respective target in image 202B based on the obtained predicted state data 258. In accordance with embodiments described with respect to FIG. 3B, object localization module 210 may estimate that target 304 is present at location 320, target 306 is present at location 322, target 308 is present at location 324, and target 310 is present at location 326 of environment 302 depicted in image 202B.

Similarity component 212 may extract visual features from the bounding box regions of image 202B and the correlation response regions of image 202B that correspond to the estimated locations 320, 322, 324, 326 of each respective target (referred to herein as an estimated target region). Similarity component 212 may compare the extracted visual features of the detected objects in image 202B with visual features associated with tracked objects. Similarly component 212 may determine a similarity metric value associated with the extracted visual features based on the comparison, and may provide an indication of the bounding box regions, the estimate target regions, and the determined similarity metric values to data association module 214, as previously described. In accordance with previously described embodiments and examples, data association module 214 may determine that bounding box 350 matches with estimated location 320 and bounding box 352 matches with the estimated location based on the similarity values satisfying one or more similarity criteria (e.g., a difference being less than a difference threshold). Accordingly, object trackers 218 associated with targets 304 and 308 may provide state data associated with targets 304 and 308 to state estimation module 220 to update the current states of targets 304 and 308 in view of image 202B. For example, state estimation component 222 may determine a new state associated with targets 304 and 308 in view of image 202B and may update the current target state 256 for each target based on the determined new state. State estimation component 222 may store the state determined for targets 304 and 308 with respect to image 202A as prior state data 254 and may store the updated current target state 256 at data store 250, as described above. In some embodiments, state prediction component 224 may predict a future location of targets 304 and 308 in environment 302 update the future target states 258 in view of the predicted future locations.

In some embodiments, data association module 214 may determine that bounding box 354 does not match with an estimated location associated with an existing target in environment 302. Accordingly, target manager module 216 may determine that bounding box 354 corresponds to a new detected object in the environment and may instantiate an object tracker 218 to track the detected object. In additional or alternative embodiments, data association module 214 may determine estimated locations 322 and 326 do not match with a bounding box of object data 204 (i.e., estimated locations 322 and 326 are unmatched estimated locations). Accordingly, target manager module 216 may determine to terminate object trackers associated with 310 and/or 306, in accordance with a target management policy and/or embodiments described herein.

As indicated above, target manager module 216 may be configured to terminate an object tracker 218 for a target if the target is determined to be “lost,” in accordance with a target termination policy of the video analytics system. In some embodiments, the target termination policy may provide that target manager module 216 may not terminate an object tracker 218 until the target associated with the object tracker is “lost” for a threshold number of images generated by image source 104. In such embodiments, the object tracker 218 may continue to track the target based on the predicted target state 258 determined for the target (e.g., based on the most recent current object state 256 determined for the target). In an illustrative example, if a target is tracked based on one or more video frames, in accordance with previously described embodiments, and is determined to be “lost” in a subsequent video frame, the object tracker 218 associated with the target may continue to track the target, even though the target is “lost” in the subsequent video frame. If object detection engine 141 and/or object localization module 210 does not detect the “lost” target in a threshold number of subsequent video frames, the target manager module 216 may terminate the object tracker 218 associated with the target, in accordance with the target termination policy. The technique of tracking a target in an environment even though the target is not detected (e.g., by object detection engine 141 and/or object localization module 210) is referred to herein as shadow tracking. As will be seen below, target manager module 216 may determine whether a new object detected in an environment is the same as, or otherwise corresponds to, a “lost” target before terminating the object tracker 218 for the object. Upon determining that the new object is the same as or corresponds to the lost target, target manager module 216 (or another module or component of object tracking engine 151) can associate the “new” object with the “lost” target and can continue tracking the “lost” target, as described herein.

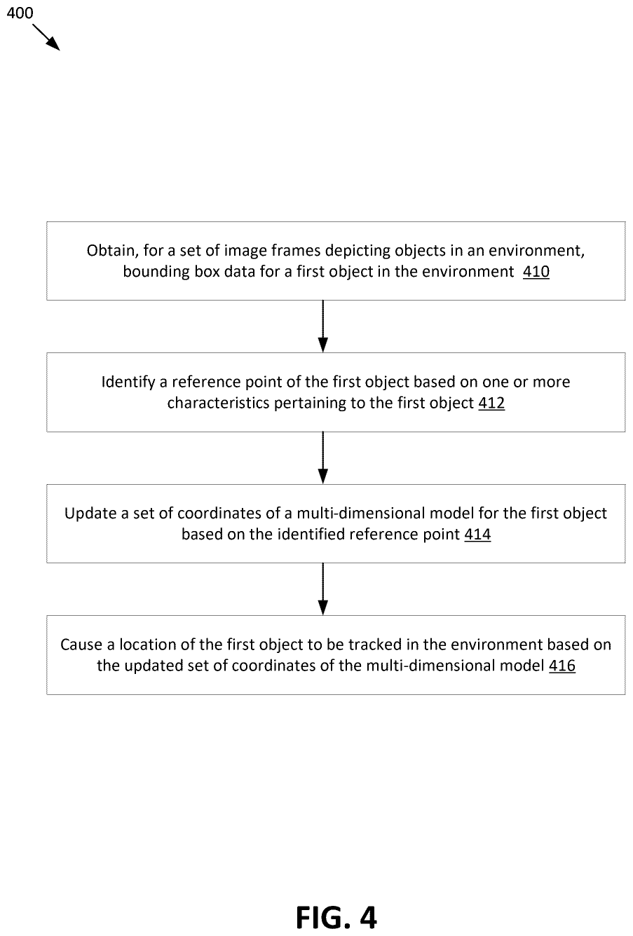

As described above, a target tracked by object tracking engine 151 may become partially occluded with another object or target in a monitored environment (e.g., relative to a location or positioning of image source 104 in the environment). Due to the partial occlusion, target manager module 216 may determine that the target is “lost” (e.g., at least for a time period of the partial occlusion event), as described in further detail below. Additionally or alternatively, target manager module 216 may detect a new object or target present in the monitored environment during the partial occlusion event. The new object or target may be or represent the partially occluded “lost” target. However, as will be explained in further detail below, target manager module 216 may not recognize that the new object is the same as the “lost” target during the occlusion event. Target recovery module 226 can determine that a partially occluded “lost” target is the same as or corresponds to a new object detected during the partial occlusion event, as described below with respect to FIGS. 4-7. Additionally or alternatively, target recovery module 226 can recover a full size bounding box for the “lost” target during the occlusion event and can track (or provide information to object tracker 218 to track) a location of the “lost target” in the monitored environment during the partial occlusion event, as described below with respect to FIGS. 4-7.

As illustrated in FIG. 2, target recovery module 226 can include a target identifier (ID) component 228, a bounding box (BB) projector component 230, a BB anchor component 232, a model component 234, and/or a BB recovery component 236. Further details regarding each component of target recovery module 226 are provided herein with respect to FIGS. 4-7 below.

FIG. 4 illustrates a flow diagram for an example method 400 for tracking partially occluded objects tracked by an intelligent video analytics system, according to at least one embodiment. In some embodiments, method 400 can be performed by system 100. For example, one or more operations of method 400 can be performed by image processing engine 131, object detection engine 141, and/or object tracking engine 151, in some embodiments. In some embodiments, one or more operations of method 400 may be performed by object tracking engine 151 and, in some instances, by target recovery module 226 of object tracking engine 151. Method 400 may be performed by one or more processing units (e.g., CPUs and/or GPUs), which may include (or communicate with) one or more memory devices. In at least one embodiment, method 400 may be performed by multiple processing threads (e.g., CPU threads and/or GPU threads), each thread executing one or more individual functions, routines, subroutines, or operations of the method. In at least one embodiment, processing threads implementing method 400 may be synchronized (e.g., using semaphores, critical sections, and/or other thread synchronization mechanisms). Alternatively, processing threads implementing method 400 may be executed asynchronously with respect to each other. Various operations of method 400 may be performed in a different order compared with the order shown in FIG. 4. Some operations of the methods may be performed concurrently with other operations. In at least one embodiment, one or more operations shown in FIG. 4 may not always be performed.

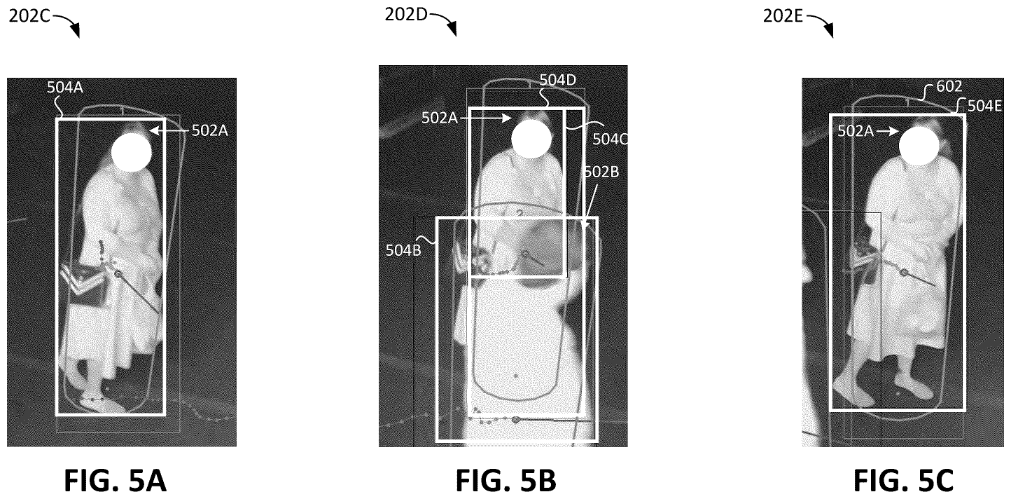

At block 410, processing logic obtains, for a set of image frames depicting objects in an environment, bounding box data for a first object in the environment. As described above, image source 104 can obtain a set of images 202 depicting one or more objects in an environment. FIGS. 5A-5C depict example images 202C-202E depicting one or more objects 502 in an environment. One or more of objects 502 depicted by images 202C-202E can be targets tracked by an object tracker 218 of object tracking engine 151, in some embodiments. In other or similar embodiments, one or more objects 502 can be objects that are not tracked, or are not yet tracked, by an object tracker 218. For purposes of example and explanation only, FIGS. 4-7 refer to objects detected in images 202 as “objects.” It should be noted, however, that objects 502 can additionally or alternatively be targets that are tracked by one or more object trackers 218, in accordance with previously described embodiments.

In some embodiments, each of images 202C-202E can be or can correspond to image frames of a video stream. For example, image 202C can be a first frame of the video stream, image 202D can be a second frame of the video stream, and image 2022E can be a third frame of the video stream. It should be noted that although embodiments of the present disclosure describe image frame 202C as a first image frame, image frame 202D as a second image frame, and image frame 202E as a third image frame, image frames 202C-202E can be captured or provided in any order. For example, in some embodiments, image 202D can be a first image frame of the video stream and image 202C can be the second image frame of the video stream.

As illustrated in FIG. 5A, the environment can include object 502A. As described above, object detection engine 141 can obtain object data 204 for one or more objects detected in the environment, where the object data 204 includes a bounding box indicating a region of the image 202 that depicts the object. Object data 204 obtained for object 502A can include bounding box 504A, in some embodiments.

In some embodiments, a bounding box included in or otherwise indicated by object data 204 can include a full size bounding box. A full size bounding box can encompass an entire shape and/or size of a detected object. In other or similar embodiments, a bounding box can include a partial bounding box, which encompasses a portion of the entire shape and/or size of the detected object. In some embodiments, object detection engine 141 and/or object tracking engine 151 can determine that a bounding box detected for an object is a full size bounding box based on a size and/or shape of other bounding boxes determined for the detected object (e.g., based on detection of the object in prior or subsequent image frames of a video stream). For example, object detection engine 141 and/or object tracking engine 151 can detect an object in a first image frame of a video stream and can associate the detected object with a first bounding box having a first size and a first shape. Object detection engine 141 and/or object tracking engine 151 can detect the object in one or more second image frames of the video stream and can associate the detected object with one or more second bounding boxes each having a second size and a second shape. If the object is partially occluded in the first image frame or in any of the one or more second image frames, a size or shape of the first bounding box will differ from the size or shape of the one or more second bounding boxes. Object detection engine 141 and/or object tracking engine 151 can detect this difference (e.g., by comparing the size and/or shape of the first bounding box to the one or more second bounding boxes) and can identify the bounding box that encompasses the entire shape of the object by identifying the bounding box having a size that is larger than the size of other bounding boxes for the object, in some embodiments.

As described above, object detection engine 141 can obtain object data 204 based on one or more outputs of a trained object detection model. An output of the trained object detection model can include a bounding box that indicates a region of an image 202 and, in some instances, a level of confidence that the region indicated by the bounding box includes a detected object. In some embodiments, object detection engine 141 and/or object tracking engine 151 can determine that a bounding box detected for an object is a full size bounding box by determining that a level of confidence output by the object detection model satisfies one or more criteria (e.g., exceeds a threshold level of confidence). It should be noted that object detection engine 141 and/or object tracking engine 151 can determine whether a bounding box for a detected object is a full size bounding box or a partial bounding box according to different techniques.

Referring back to FIG. 5A, object detection engine 141 can obtain a bounding box 504A for object 502A, as described above. In some embodiments, object detection engine 141 can determine that bounding box 504A is a full size bounding box that encompasses the entirety of object 502A, in accordance with previously described embodiments. FIG. 5B depicts an example image 202D depicting object 502A during a partial occlusion event. As illustrated by FIG. 5B, a second object 502B is positioned in front of object 502A (e.g., relative to a position and/or orientation of image source 104). Object detection engine 141 can obtain object data 204 for object 502A and object 502B in accordance with previously described embodiments, which can include a bounding box 504B for object 502B and/or a bounding box 504C for partially occluded object 502A and. Due to the partial occlusion of object 502A by object 502B, the size and shape of the bounding box 504C for object 502A depicted by image 202D may be different from the bounding box 504A for object 502A depicted by image 202C.

As indicated above, in some instances, object tracking engine 151 may determine that a target is “lost” in a monitored environment (e.g., upon determining that a bounding box previously associated with a target is not included in a subsequent image depicting the environment). For example, upon determining that image 202D does not include a bounding box having a size and/or shape of bounding box 504A of image 202C, object tracking engine 151 may determine that object 502A may be “lost” in the environment. However, as described above, object tracking engine 151 may determine that a new object may be present in the environment, in view of the detection of bounding box 504B and/or 504C of image 202D. Target identifier component 228 of target recovery module 226 may determine whether either of bounding boxes 504B or 504C of image 202D correspond to previously detected object 502A of image 202C.

In some embodiments, target identifier component 228 can determine whether bounding box 504B and/or bounding box 504C correspond to previously detected object 502A based on a similarity of features of the region of image 202C indicated by bounding box 504A to features of the regions of image 202D indicated by bounding boxes 504B and 504C. For purposes of example and explanation only, the region of image 202C indicated by bounding box 504A is referred to as a “first” region, the region of image 202D indicated by bounding box 504B is referred to as a “second” region, and the region of image 202D indicated by bounding box 504C is referred to as a “third” region. In one or more embodiments, target identifier component 228 can extract or otherwise determine one or more image features 260 of the first region of image 202C and can extract or otherwise determine one or more image features 260 of the second and third regions of image 202D. Image features 206 can include, but are not limited to, low-level image features (e.g., color histograms, texture data, edge detection data, local image descriptors, etc.), mid-level image features (e.g., shape descriptors, contour data, segment data, etc.), high-level image features (e.g., semantic segmentation data, scene understanding data), etc., spatial relationship features (e.g., relative position, size, orientation data of the objects depicted by images 202C and 202D), and so forth. Target identifier component 228 can extract or otherwise determine image features of the regions of images 202C and 202D according to any image feature extraction technique, including but not limited to low-level feature extraction techniques (e.g., Histogram of Oriented Gradients (HOG) techniques, color moment techniques, local binary patterns techniques, canny edge detector techniques, etc.), mid-level feature extraction techniques (e.g., Fourier descriptor techniques, Hu moment techniques, etc.), high-level feature extraction techniques, feature matching techniques (e.g., random sample consensus (RANSAC) techniques, Euclidean distance techniques, etc.), and so forth. For purposes of example and explanation only, image features 260 extracted from the first region are referred to as first image features 260A, image features 260 extracted from the second region are referred to as second image features 260B and image features 260 extracted from the third region are referred to as third image features 260C.

Upon extracting the image features 260 from the first region of image 202C and the second and third regions of image 202D, target identifier component 228 can compare the first image features 260A to each of the second image features 260B and the third image features 260C to determine a degree of similarity between the compared features. A degree of similarity between image features 260 can represent or otherwise correspond to a distance between the first image features 260A and each of the second image features 260B and the third image features 260C. In an illustrative example, target identifier component 228 can determine a first degree of similarity between first image features 260A and second image features 260B and a second degree of similarity between first image features 260A and third image features 260C. The first degree of similarity can be lower than the second degree of similarity (e.g., as object 502B is a different object that is partially occluding object 502A). In some embodiments, upon determining that a determined degree of similarity satisfies one or more criteria (e.g., exceeds a threshold degree of similarity), target identifier component 228 can determine that the object depicted in the region of image 202D indicated by a respective bounding box 504 is the same object depicted in the region of image 202C indicated by image 202C. In accordance with the previous illustrative example, target identifier component 228 can determine that the degree of similarity between the first image features 260A and the third image features 260C satisfy the criteria (and/or the degree of similarity between the first image features 260A and the second image features 260C fail to satisfy the criteria), and therefore the object depicted in the region indicated by bounding box 504C is the same as object 502A, and therefore bouncing box 504C corresponds to previously detected object 502A.

It should be noted that target identifier component 228 can determine image features 260 of image 202C correspond to image features 260 of image 202D and/or whether bounding boxes 504B or 504C correspond to object 502A according to other techniques, as described herein. For example, in some embodiments, target identifier component 228 can provide image 202C (or at least a portion of image 202C) and/or image 202D (or at least a portion of image 202D) as an input to an artificial intelligence model trained to predict a degree of similarity between objects depicted in given input images (referred to herein as an object similarity model). Target identifier component 228 can obtain one or more outputs of the object similarity model, which can indicate a degree of similarity between at least one object depicted by image 202C and at least one object depicted by image 202D. Target identifier component 228 can determine whether the object depicted in the second region and/or third region of image 202D corresponds to object 502A based on the output(s) of the object similarity model, in some embodiments.

In other or similar embodiments, target identifier component 228 can determine whether objects depicted by image 202D are the same as or correspond to object 502A based on predicted target state data 258 determined for object 502A. As described above, an object tracker 218 for object 502A can determine a predicted target state 258 for object 502A. Object trackers 218 initialized for objects of bounding boxes 504B and 504C can determine a current target state 256 for such objects, as described above. In some embodiments, target identifier component 228 can determine whether a predicted target state 258 to a current target state 256 corresponds to (e.g., matches or approximately matches) each object of bounding boxes 504B and 504C. Upon determining that the predicted target state 258 corresponds to current target state 256 for an object of bounding boxes 504B or 504C target identifier component 228 can determine that the object indicated by the corresponding bounding box 504 is the same as object 502A.

In accordance with embodiments and examples described above, target identifier component 228 can determine that the object depicted by bounding box 504C of image 202D is the same as object 502A. As the size and/or shape of bounding box 504C is different from the size and/or shape of bounding box 504A, target recovery module 226 can determine that bounding box 504C is a partial bounding box for object 502A. Accordingly, target recovery module 226 can recover the full size bounding box 504 for object 502A depicted by image 202D, as described below.

As will be seen below, recovering a full size bounding box 504 for an object 502 can involve mapping (also referred to as projecting) coordinates of a detected bounding box to a multi-dimensional model associated with the object 502. It should be noted that embodiments of the present disclosure can be applied for any object 502 detected in an environment and are not limited to objects 502 for which a partial bounding box is determined.

Referring back to FIG. 4, at block 412, processing logic identifies a reference point of the first object based on one or more characteristics pertaining to the first object. In some embodiments, a developer or operator of system 100 can define a reference point for objects having the same or similar object type as the first object. The reference point can be or can include a region or component of each object having the common object type. In an illustrative example, the object type of the first object can be a “person” object type, where a rectangle can encapsulate the size and/or shape of a “person.” In such example, the rectangle has a particular height (h) and width (w) (e.g., based on the height and width of the “person”), and the reference point (e.g., as defined by the operator or developer of system 100) can be located at a center point of the rectangle (e.g., at a height of h/2 and a width of w/2). The center point of an object having a “person” object type can be or can otherwise correspond to a “waist” of the person.

In some embodiments, a developer or operator of system 100 can provide a definition for reference points for each object type that can be detected in a particular environment. For example, a developer or operator of system 100 can provide a definition for reference points of people, animals, cars, bicycles, etc., which could be detected in the environment. Target recovery module 226 can determine an object type associated with an object detected by an image 202 and can identify a corresponding reference point defined for the determined object type, in some embodiments. For example, target recovery module 226 can determine that object 502A has a “person” object type and therefore can identify a reference point defined for a “person” object type by the developer or operator of system 100. In other or similar embodiments, target recovery module 226 (and/or another module of object tracking engine 151 or of system 100) can determine a reference point for objects having a particular object type according to alternative techniques (e.g., AI techniques).

Reference point component 230 of target recovery module 226 can identify a region of image 202D that includes or depicts the reference point associated with object 502A in bounding box 504C. As described above, a reference point for a “person” object type can be defined to be located at a center point of a rectangle encompassing the object, in some embodiments. Therefore, in some embodiments, reference point component 230 can identify the region of image 202D that is at the center point of bounding box 504C as the reference point associated with object 502A. It should be noted that depending on location of the object (e.g., object 502B) that partially occludes object 502A, the “true” center point of object 502A (e.g., the waist of the person associated with object 502A) may not be depicted by image 202D. In some embodiments, reference point component 230 can designate or otherwise identify the center point of bounding box 504C as an initial reference point for object 502A. As described below, reference point component 230 (or another component of target recovery module 226) can determine the “true” center point of object 502A based on the projection of the coordinates of image 202 to the multi-dimensional model for object 502A and can update the reference point for object 502A based on the determination.

In other or similar embodiments, reference point component 230 can identify the region of image 202D that includes or depicts the reference point associated with object 502A according to other techniques. For example, reference point component 230 can perform one or more object recognition operations to determine one or more components of object 502A and can determine a “waist” of object 502A based on the object recognition operations. An object recognition operation can include any operation that involves determining an object type or object feature of an object depicted in an image. In some embodiments, object recognition can be performed using one or more AI models. For example, BB projector component 230 can provide image 202D as an input to an object recognition model and can obtain one or more outputs of the model that indication a region of the image 202D corresponding to a “waist” of object 502A. BB projector component 230 can determine the region of image 202D that corresponds to the “waist” of object 502A based on the one or more outputs of the model. Such determined regions can be identified or designated as the reference point of object 502A, as depicted by image 202D.

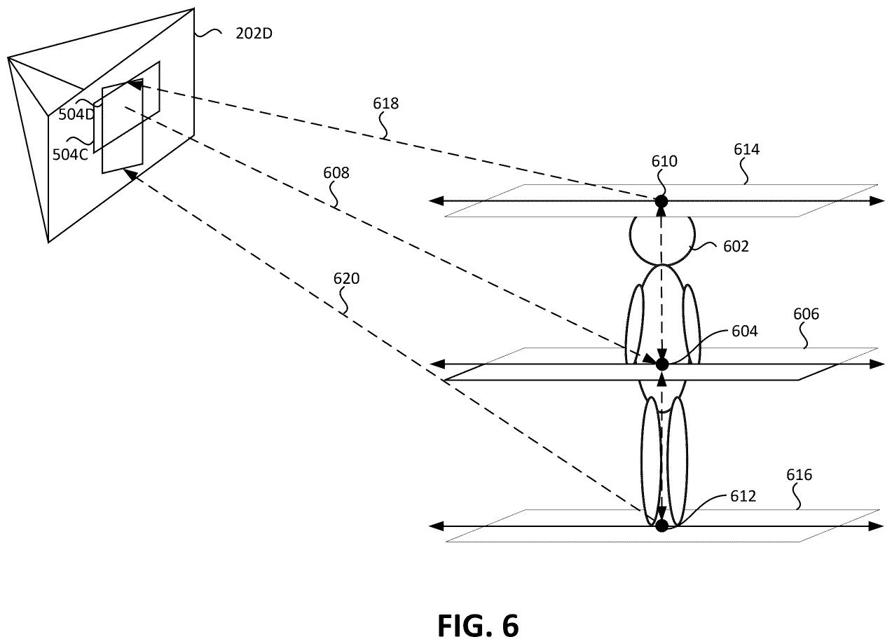

Referring back to FIG. 4, at block 414, processing logic updates a set of coordinates of a multi-dimensional model for the first object based on the identified reference point. FIG. 6 depicts an example of projecting coordinates of a region of image 202D indicated by a bounding box of a partially occluded object (e.g., object 502A) to a multi-dimensional (e.g., 3D) model of the object, according to at least one embodiment. Processing logic can update the set of coordinates for the model of the object based on the projection, as described herein. FIG. 6 illustrates image 202D and bounding box 504C, as described with respect to FIG. 5B. FIG. 6 also illustrates a digital representation of a multi-dimensional model 602 of object 502A. For purposes of example and explanation only, multi-dimensional model 602 is referred to herein as a 3D model 602 or simply model 602. However, model 602 can have any dimensionality, in accordance with embodiments described herein.

As will be described in further detail below, an image 202, as captured by image source 104, can be associated with a two-dimensional (2D) coordinate geometry, which, in some instances, can deal with x and y coordinates represented in a coordinate plane or a Cartesian plane. Model 602, as indicated above, can be associated with a multi-dimensional coordinate geometry, which, can deal with additional and/or alternative coordinates than the 2D coordinate geometry. Image 202 provides a 2D view of the monitored environment, which includes one or more multi-dimensional (e.g., 3D) objects, including object 502A. Embodiments described herein refer to “projecting” coordinates of the 2D view provided by image 202 to the 3D coordinates of model 602 representing object 502A in the monitored environment. For purposes of explanation and illustration only, image 202 is referred to as having coordinates of (x, y) where the x coordinate represents a location of an object on the x-axis of a real-world environment of the Cartesian plane and the y coordinate indicates a location of an object or an image feature on the y-axis of the real-world environment in the Cartesian plane. Such coordinates are referred to herein as “image coordinates” Further, model 602 is referred to has having coordinates (x′, y′, and h), where the x′ coordinate represents the predicted or estimated location of model 602 on the x-axis of the real-world environment, the y′ coordinate represents the predicted or estimated location of model 602 on the y-axis of the real-world environment, and the h coordinate represents the height of the object, as represented by the model 602. Such coordinates are referred to herein as “model” coordinates.

In accordance with previously described examples and embodiments, a reference point of a “person” type object can be located at a center point of the object (e.g., a “waist” of the object). As illustrated by FIG. 6, model 602 can include a model reference point 604, which is located at (or approximately at) a center point or a “waist” of the model 602. Reference point 604 can be a point (or a set of points) of a reference plane 606. Reference plane 606 can be or can include a Euclidean plane that refers to a flat, two-dimensional surface that extends indefinitely in two directions, relative to reference point 604. For instance, reference plane 606 can extend indefinitely in the x-directions and the z-directions relative to reference point 604. Reference plane 606 is depicted by FIG. 6 to illustrate the multi-dimensionality of model 602, as described herein.

BB projector component 232 of target recovery module 226 can update a set of model coordinates 262 for model 602 to include a first mapping 608 between an image coordinate of image 202 associated with the identified reference point (e.g., as described with respect to block 412) with a model coordinate associated with reference point 604 of model 602. The first mapping 608 indicates the association between the location in the 2D coordinate geometry of image 202 and the reference point 604 (e.g., the center point) of model 602. In an illustrative example, initial image coordinates associated with the identified reference point of block 412 can be (x, y). BB projector component 232 can update the model coordinates 262 for model 602 to be (x′, y′, h/2) (e.g., where “x“ ” represents the location of the object along the x-axis in the 2D coordinate geometry of image 202, “y” represents the location of the object along the y-axis in the 2D coordinate geometry of image 202, and h/2 represents the center point of the model 602 at approximately half of the total height of the model). The model coordinates 262 of (x′, y′, h/2) represent the first mapping 608 between the image coordinates of image 202 and the model coordinates 262 of model 602.

In some embodiments, BB projector component 232 can determine additional model coordinates 262 for model 602 based on the coordinates of first mapping 608. For example, BB can determine initial coordinates for a “head” point 610 of model 602 and/or initial coordinates for a “foot” point 612 of model 602 based on the model coordinate of the first mapping 608 for reference point 604. A model coordinate for a “head” point 610 of model 602 represents an estimated or predicted model coordinate for a location of a “head” of object 502A in the monitored environment. A model coordinate for a “foot” point 612 of model 602 represents an estimated or predicted model coordinate for a location of a “foot” (or “feet”) of object 502A in the monitored environment. As described above, the model coordinates 262 for the reference point 604 can be (x′, y′, h/2), where h/2 represents half of the total height (h) of the model 602. Therefore, the total height of the model is h. Based on the model coordinates 262 for reference point 604, BB projector component 232 can determine that the initial coordinates for the head point 610 of model 602 are (x′, y′, h) and the initial coordinates of the foot point 612 of model 602 are (x′, y′, 0). In some embodiments, the value of the height (h) of model 602 is defined by a developer or operator of system 100. In other or similar embodiments, the height (h) of model 602 can be determined based on historical or experimental data of system 100. The height (h) of the model 602 can be defined as or can correspond to the height (or average height) of objects having the same object type as an object detected in image 202D. For example, the height (h) of model 602 can be defined as or can correspond to the average height of human beings. As will be seen below, BB projector component 232 can update the coordinate determined for the head point 610 and/or the foot point 612 of model 602 in view of an anchor point determined for image 202D, as described below.

In accordance with previously described embodiments, a head point 610 of model 602 can be a point (or a set of points) of a “head” plane 614. Head plane 614 can be or can include a Euclidean plane that refers to a flat, two-dimensional surface that extends indefinitely in two directions, relative to head point 614. For instance, head plane 614 can extend indefinitely in the x-directions and the z-directions relative to head point 610. Additionally or alternatively, a foot point 612 of model 602 can be a point (or set of points) of a “foot” plane 616. Foot plane 616 can be or can include a Euclidean plane that refers to a flat, two-dimensional surface that extends indefinitely in two directions, relative to foot point 612. For instance, foot plane 616 can extend indefinitely in the x-directions and the z-directions relative to foot point 612. Head plane 614 and foot plane 616 are depicted by FIG. 6 to further illustrate the multi-dimensionality of model 602, as described herein.

In some embodiments, BB anchor component 234 can identify an anchor point of the region of image 202D identified by bounding box 504C. An anchor point refers to a point of an image 202 that depicts a common characteristic of each object having a particular object type in an environment (e.g., in view of an angle or perspective of image source 104). For example, image source 104 may be, or may be connected to, a surveillance camera that is mounted on a wall or a ceiling for an environment. The surveillance camera may be angled “downward” generate images 202 depicting the environment located below the surveillance camera. The surveillance camera may be located above each object that enters into the environment, and therefore the top most portion of each object may be visible to the surveillance camera (e.g., including during a partial occlusion event). A top most portion of a “person” type object can include a “head” of the person, and therefore the “head” of the person may be visible to the surveillance camera, even during a partial occlusion event. In accordance with previously described embodiments, a bounding box determined for a detected object can encompass the features of the object that are detected by the image source 104 (e.g., regardless of whether the bounding box is a full size bounding box or a partial bounding box). Accordingly, a partial bounding box detected for a partially occluded object 502 in the monitored environment can include the “head” of the person indicated by the partial bounding box. As the “head” of a person is the top most region of an object having a “person” object type, the top most region of the partial bounding box can indicate or correspond to the “head” of the object 502A. Therefore, the top most region of the partial bounding box can be identified as an anchor point for objects 502 of a monitored environment having a “person” object type. In some embodiments, a developer or operator of system 100 can provide or otherwise device an anchor point for each type of object. In other or similar embodiments, system 100 can determine an anchor point for each type of object detected in a monitored environment based on experimental or historical data.

In other or similar embodiments, other regions of a bounding box can be identified as an anchor point for objects 502 of a monitored environment. For example, if a surveillance camera is mounted at a position such that the angle of the perspective of the surveillance camera allows for the bottom most portion of objects in the monitored environment to remain visible to the surveillance camera (e.g., including during a partial occlusion event), a bottom most portion of a partial bounding box detected for a partially occluded object 502 may be designated as an anchor point for the objects 502.

In some embodiments, BB projector component 232 can determine whether to update the initial model coordinates 262 for the head point 610 and/or the foot point 612 based on the determined anchor point. In some embodiments, BB projector component 232 can determine a set of image coordinates associated with a portion of the bounding box for the partially occluded object 502A (e.g., bounding box 504C) associated with the determined anchor point. BB projector component 232 can compare the determined set of image coordinates with a set of model coordinates 262 for a point of model 602 that corresponds to the determined anchor point and can determine whether to update the set of model coordinates 262 for the point of model 602 based on the comparison. In an illustrative example, the anchor point for object 502A can be the top most region of bounding box 504C, which corresponds to the “head” of object 502B, as described above. BB projector component 232 can determine a set of image coordinates associated with the top most region of bounding box 504C. In some embodiments, each of the set of image coordinates can have the same (or a similar) y value. BB projector component 232 can compare the y value of the set of image coordinates to the y′ value for the initial model coordinate for the head point 610 of model 602. Upon determining that a difference between the y value of the set of image coordinates and the y′ value for the initial model coordinate falls below a threshold difference, BB projector component 232 can determine that the initial model coordinate for the head point 610 matches (or approximately matches) the image coordinate(s) associated with the anchor point determined for object 502A, in some embodiments. In such embodiments, BB projector component 232 can generate a second mapping 618 between the set of image coordinates for the anchor point and the initial model coordinate for the head point 610, which indicates that the location of the anchor point of object 502A in the 2D coordinate geometry of image 202 corresponds to the initial model coordinates 262 for the head point 610 of model 602.

Upon determining that a difference between the y value of the set of image coordinates and the y′ value for the initial model coordinate exceeds the threshold difference, BB projector component 232 can determine that the initial model coordinate for the head point 610 does not match (or approximately match) the image coordinate(s) associated with the anchor point determined for object 502A. In such embodiments, BB projector component 232 can update the initial model coordinates 262 for the head point 610, the reference point 604, and/or the foot point 612 based on the determined difference between the y value of the set of image coordinates and the y′ value for the initial model coordinate for the head point 610. For example, BB projector component 232 can update the model coordinate for the head point 610 to match the image coordinates for the anchor point of object 502A by updating the y′ value of the initial model coordinate for the head point 610 to match the y value of the set of image coordinates. Additionally or alternatively, BB projector component 232 can update the model coordinates 262 for the reference point 604 and/or the foot point 612 of model 602 by updating the y′ value of the model coordinates 262 to reflect the difference between the y value of the anchor point and the y′ value of the model coordinate for the head point 610. For example, if a difference between the y value of the anchor point and the y′ value of the model coordinate for the head point 610 is a value of five units, BB projector component can adjust (e.g., add, subtract, etc.) the y′ value of the model coordinates 262 for the reference point 604 and/or the foot point 612 by a value of five units.

It should be noted that although some embodiments and examples herein are described with respect to adjusting the model coordinates 262 of model 602 based on a difference between the image coordinates of the anchor point and the initial model coordinates 262 of the head point 610, model coordinates 262 of model 602 can be adjusted based on a difference between the image coordinates of the anchor point and the model coordinates 262 of any point of model 602 (e.g., head point 610, reference point 604, foot point 612, etc.).

BB projector component 232 can generate a third mapping 620 between the model coordinates 262 for the foot point 612 of model 602 and a region of image 202D that includes (or is predicted or estimated to include) a foot or feet of object 502A. As described with respect to FIG. 5B, object 502B may partially occlude object 502A (e.g., relative to the perspective of image source 104). In accordance with previously provided embodiments and examples, a foot or feet of object 502A may not be depicted by image 202D due to the partial occlusion. BB projector component 232 can determine a region of image 202D that includes (or is predicted or estimated to include) a foot or feet of object 502A based on the first mapping 608 and/or the second mapping 618 between model coordinates 262 and image coordinates for a reference point and/or head of object 502A and a distance between model coordinates 262 of the foot point 612 and the reference point 604 and/or the head point 610 of model 602. In an illustrative example, BB projector component 232 can identify a region of image 202D that depicts (or is likely to depict) a head and/or a waist of object 502A based on the first mapping 608 and/or the second mapping 618 between the image coordinates of image 202D and the model coordinates 262 of model 602, as described above. BB projector component 232 can determine a distance between at least one of the foot point 612 and the reference point 604 of model 602 and/or the foot point 612 and the head point 610 of model 602. BB projector component 232 can identify a region of image 202D that is located at the determined distance from the image coordinates mapped to the model coordinates 262 for the head point 610 and/or the reference point 604. The identified region of image 202D can correspond to the predicted or estimated region of image 202D that includes the foot or the feet of object 502A. BB projector component 232 can generate the third mapping 620 between the image coordinates for the identified region of image 202D and the model coordinates 262 for foot point 612 of model 602, as described above. As illustrated in FIG. 6, the region of image 202D that is mapped to the foot point 612 of model 602 is outside of the region of image 202D that is indicated by bounding box 504C. In some embodiments, first mapping 608, second mapping 618, and/or third mapping 620 can be included in or can correspond to a projection matrix (e.g., a 3×4 projection matrix).

BB recovery component 236 can recover the full size bounding box for object 502A based on the mappings (e.g., the first mapping 608, the second mapping 618, and/or the third mapping 620) generated by BB projector component 232, as described above. In some embodiments, BB recovery component 236 can determine that a top most portion of the recovered bounding box can correspond to the image coordinates mapped to the head point 610 of model 602 and a bottom most portion of the recovered bounding box can correspond to the image coordinates mapped to the foot point 612 of model 602. As illustrated in FIGS. 5B and 6, BB recover component 236 can recover a full size bounding box 504D for object 502A.

In some instances, BB recovery component 236 can adjust one or more image coordinates of the full size bounding box 504D. For example, upon determining that the left-most image coordinate of the bounding box 504D is less than 0, BB recovery component 236 can shift the value of the left-most image coordinate of the bounding box 504D to be 0 and can update the values of other image coordinates of bounding box 504D based on the shift. In another example, upon determining that the right-most image coordinate of the bounding box 504D is larger than the overall width of the image 202D, BB recovery component 236 can shift the value of the right-most image coordinate of bounding box 504D to match the overall width of image 202D and can update the other coordinates of bounding box 504D based on the shift. In yet another example, upon determining that a bottom most coordinate of the bounding box 504D is less than zero, BB recovery component 236 can shift the value of the bottom most coordinate of the bounding box 504D to be 0 and can update the other coordinates of bounding box 504D based on the shift. In yet another example, upon determining that a top most coordinate of the bounding box 504D exceeds the total height of image 202D, BB recovery component 236 can shift the value of the top most coordinate of the bounding box 504D to be the value of the total height of image 202D and can update the other coordinates of bounding box 504D based on the shift.

Referring back to FIG. 4, at block 416, processing logic causes a location of the first object to be tracked in the environment based on the updated set of coordinates of the multi-dimensional model. In some embodiments, BB recovery component 236 and/or another component of target recovery module 226 can provide the recovered full size bounding box 504D for object 502A to the object tracker 218 for object tracker 502A. The object tracker 218 can continue to track the location of object 502A based on the recovered full size bounding box 504D for object 502A during and after the partial occlusion event, as illustrated by FIG. 5C. FIG. 5C depicts a 2D version of model 602 for object 502A. As illustrated by FIG. 5C, the 2D version of model 602 can have a cylindrical shape, in some embodiments. FIG. 5C also depicts a bounding box 504E detected for object 502A based on object detection performed for image 202E, as described herein. In accordance with embodiments herein, by recovering the full size bounding box 504D of object 502A depicted in image 202D, object tracker 218 is able to continue tracking of object 502A across image frames 202C-202E (e.g., with minimal interruption).

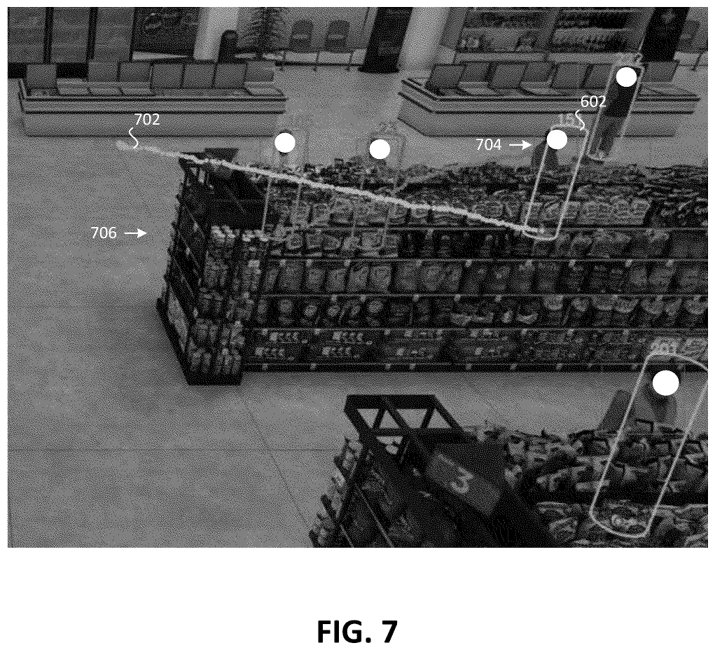

FIG. 7 depicts another example of a partial occlusion of one or more objects tracked by an intelligent video analytics system, according to at least one embodiment. As illustrated by FIG. 7, system 100 is able to continue tracking a location of one or more occluded portions of objects in a monitored environment even during a partial occlusion event. For instance, system 100 can detect a foot path 702 (e.g., indicating a path of travel) of an object 704 in a monitored environment, even though the object 704 is partially occluded by another object 706 (e.g., a stationary object) in the environment.

### Inference and Training Logic

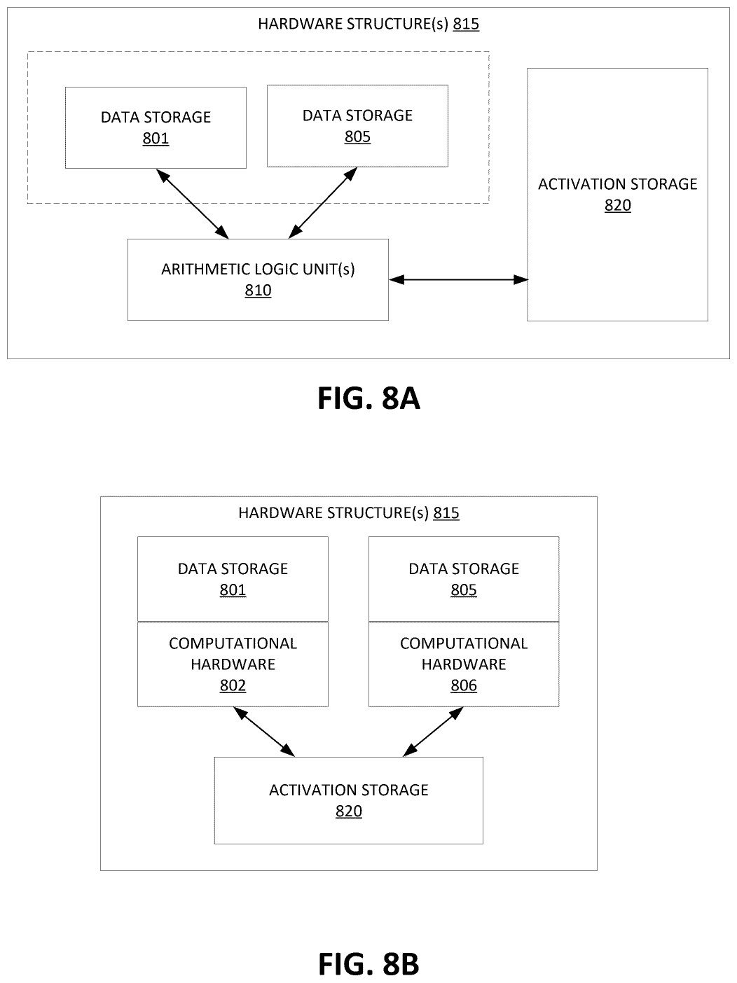

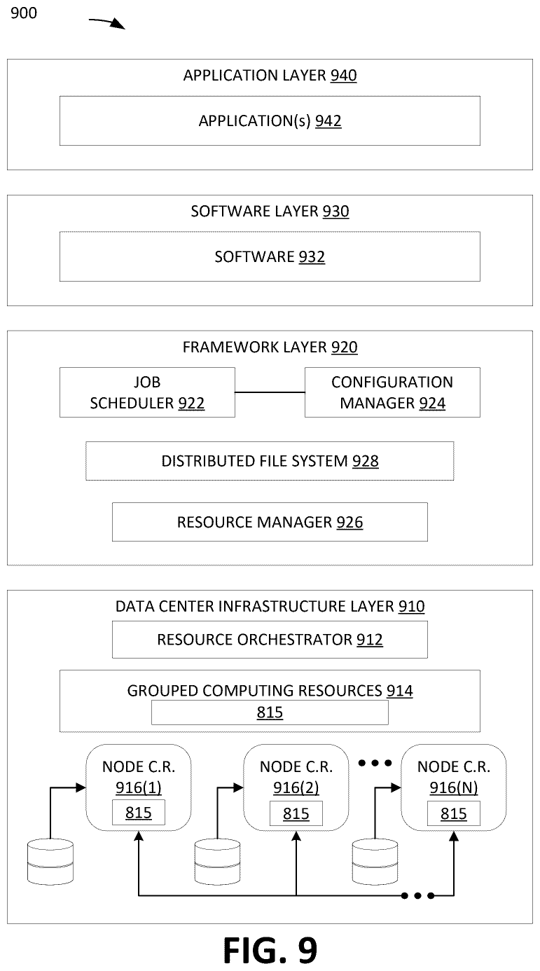

FIG. 8A illustrates hardware structures 715 for inference and/or training logic used to perform inferencing and/or training operations associated with one or more embodiments. Details regarding inference and/or training logic are provided below in conjunction with FIGS. 8A and/or 8B.

In at least one embodiment, inference and/or training logic of hardware structures 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic may include, or be coupled to code and/or data storage 801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic of hardware structures 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage 805 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to on one or more processors or other hardware logic devices or circuits. In at least one embodiment, code and/or data storage 805 may be cache memory, DRAM, SRAM, non-volatile memory (e.g., Flash memory), or other storage. In at least one embodiment, choice of whether code and/or data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be same storage structure. In at least one embodiment, code and/or data storage 801 and code and/or data storage 805 may be partially same storage structure and partially separate storage structures. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic of hardware structures 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or code and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic illustrated in FIG. 8A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 8B illustrates hardware structures 815 of inference and/or training logic, according to at least one or more embodiments. In at least one embodiment, inference and/or training logic may include, without limitation, hardware logic in which computational resources are dedicated or otherwise exclusively used in conjunction with weight values or other information corresponding to one or more layers of neurons within a neural network. In at least one embodiment, inference and/or training logic illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic illustrated in FIG. 8B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one “storage/computational pair 801/802” of code and/or data storage 801 and computational hardware 802 is provided as an input to “storage/computational pair 805/806” of code and/or data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic.

### Data Center

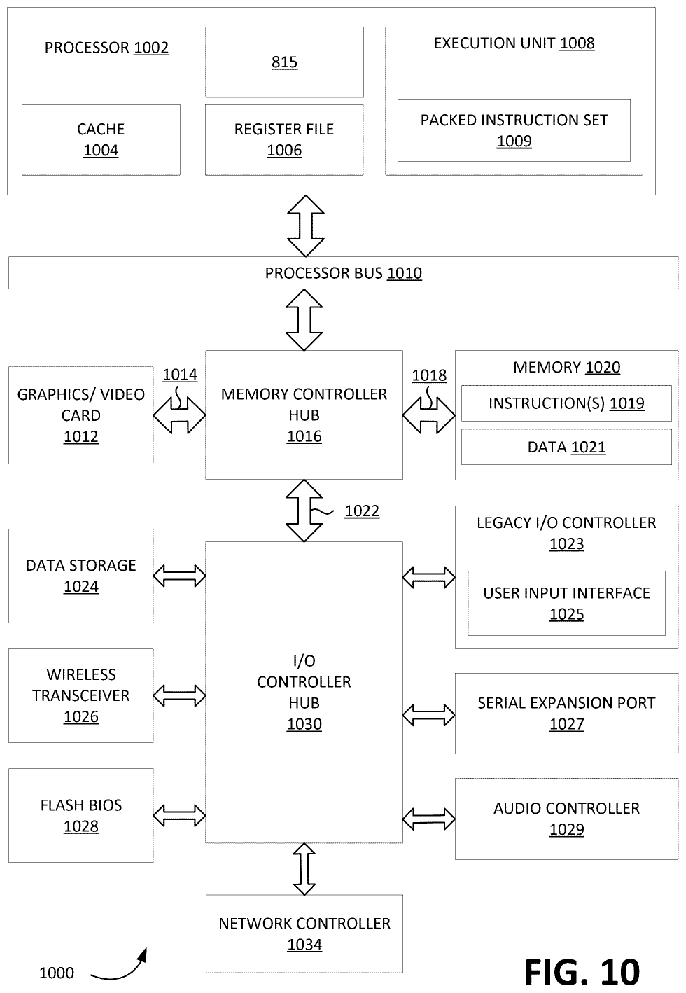

FIG. 9 illustrates an example data center 900, in which at least one embodiment may be used. In at least one embodiment, data center 900 includes a data center infrastructure layer 910, a framework layer 920, a software layer 930, and an application layer 940.

In at least one embodiment, as shown in FIG. 9, data center infrastructure layer 910 may include a resource orchestrator 912, grouped computing resources 914, and node computing resources (“node C.R.s”) 916(1)-1016(N), where “N” represents any whole, positive integer. In at least one embodiment, node C.R.s 916(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-1016(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-1016(N) and/or grouped computing resources 914. In at least one embodiment, resource orchestrator 912 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 922, a configuration manager 924, a resource manager 926 and a distributed file system 928. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 928 for large-scale data processing (e.g., “big data”). In at least one embodiment, job scheduler 922 may include a Spark driver to facilitate scheduling of workloads supported by various layers of data center 900. In at least one embodiment, configuration manager 924 may be capable of configuring different layers such as software layer 930 and framework layer 920 including Spark and distributed file system 928 for supporting large-scale data processing. In at least one embodiment, resource manager 926 may be capable of managing clustered or grouped computing resources mapped to or allocated for support of distributed file system 928 and job scheduler 922. In at least one embodiment, clustered or grouped computing resources may include grouped computing resource 914 at data center infrastructure layer 910. In at least one embodiment, resource manager 926 may coordinate with resource orchestrator 912 to manage these mapped or allocated computing resources.

In at least one embodiment, software 932 included in software layer 930 may include software used by at least portions of node C.R.s 916(1)-1016(N), grouped computing resources 914, and/or distributed file system 928 of framework layer 920. The one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-1016(N), grouped computing resources 914, and/or distributed file system 928 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 924, resource manager 926, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic of hardware structures 815 are used to perform inferencing and/or training operations associated with one or more embodiments. Details regarding inference and/or training logic are provided herein in conjunction with FIGS. 8A and/or 8B. In at least one embodiment, inference and/or training logic 815 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

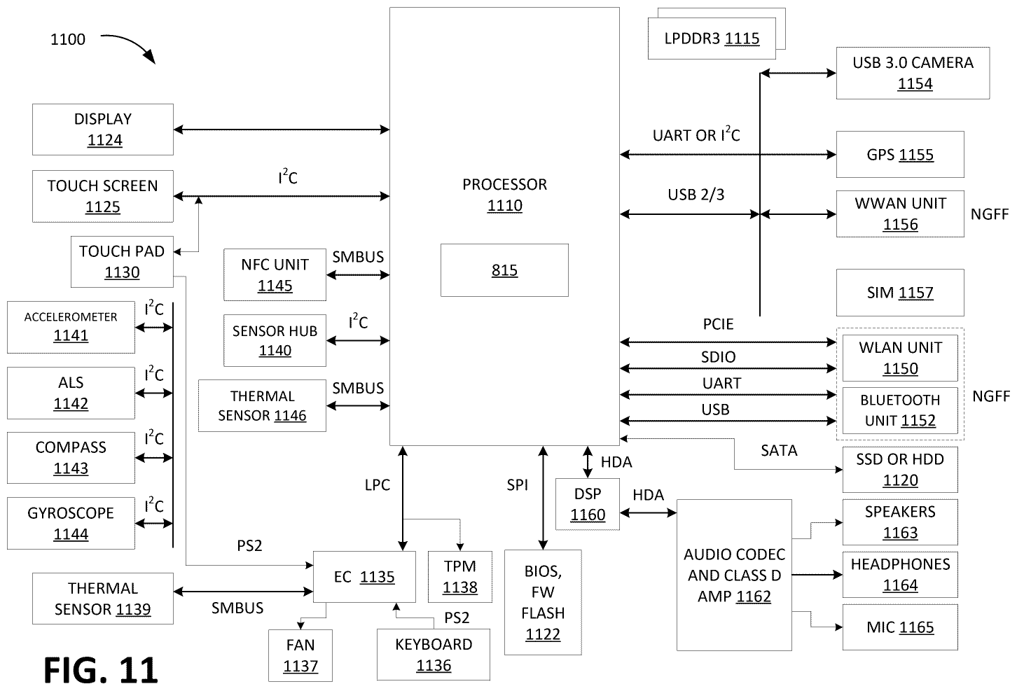

FIG. 10 is a block diagram illustrating an exemplary computer system, which may be a system with interconnected devices and components, a system-on-a-chip (SOC) or some combination thereof 1000 formed with a processor that may include execution units to execute an instruction, according to at least one embodiment. In at least one embodiment, computer system 1000 may include, without limitation, a component, such as a processor 1002 to employ execution units including logic to perform algorithms for process data, in accordance with present disclosure, such as in embodiment described herein. In at least one embodiment, computer system 1000 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1000 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 1000 may include, without limitation, processor 1002 that may include, without limitation, one or more execution units 1008 to perform machine learning model training and/or inferencing according to techniques described herein. In at least one embodiment, computer system 1000 is a single processor desktop or server system, but in another embodiment computer system 1000 may be a multiprocessor system. In at least one embodiment, processor 1002 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1002 may be coupled to a processor bus 1010 that may transmit data signals between processor 1002 and other components in computer system 1000.

In at least one embodiment, processor 1002 may include, without limitation, a Level 1 (“L1”) internal cache memory (“cache”) 1004. In at least one embodiment, processor 1002 may have a single internal cache or multiple levels of internal cache. In at least one embodiment, cache memory may reside external to processor 1002. Other embodiments may also include a combination of both internal and external caches depending on particular implementation and needs. In at least one embodiment, register file 1006 may store different types of data in various registers including, without limitation, integer registers, floating point registers, status registers, and instruction pointer register.

In at least one embodiment, execution unit 1008, including, without limitation, logic to perform integer and floating point operations, also resides in processor 1002. In at least one embodiment, processor 1002 may also include a microcode (“ucode”) read only memory (“ROM”) that stores microcode for certain macro instructions. In at least one embodiment, execution unit 1008 may include logic to handle a packed instruction set 1009. In at least one embodiment, by including packed instruction set 1009 in an instruction set of a general-purpose processor 1002, along with associated circuitry to execute instructions, operations used by many multimedia applications may be performed using packed data in a general-purpose processor 1002. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1008 may also be used in microcontrollers, embedded processors, graphics devices, DSPs, and other types of logic circuits. In at least one embodiment, computer system 1000 may include, without limitation, a memory 1020. In at least one embodiment, memory 1020 may be implemented as a Dynamic Random Access Memory (“DRAM”) device, a Static Random Access Memory (“SRAM”) device, flash memory device, or other memory device. In at least one embodiment, memory 1020 may store instruction(s) 1019 and/or data 1021 represented by data signals that may be executed by processor 1002.

In at least one embodiment, system logic chip may be coupled to processor bus 1010 and memory 1020. In at least one embodiment, system logic chip may include, without limitation, a memory controller hub (“MCH”) 1016, and processor 1002 may communicate with MCH 1016 via processor bus 1010. In at least one embodiment, MCH 1016 may provide a high bandwidth memory path 1018 to memory 1020 for instruction and data storage and for storage of graphics commands, data and textures. In at least one embodiment, MCH 1016 may direct data signals between processor 1002, memory 1020, and other components in computer system 1000 and to bridge data signals between processor bus 1010, memory 1020, and a system I/O 1022. In at least one embodiment, system logic chip may provide a graphics port for coupling to a graphics controller. In at least one embodiment, MCH 1016 may be coupled to memory 1020 through a high bandwidth memory path 1018 and graphics/video card 1012 may be coupled to MCH 1016 through an Accelerated Graphics Port (“AGP”) interconnect 1014.

In at least one embodiment, computer system 1000 may use system I/O 1022 that is a proprietary hub interface bus to couple MCH 1016 to I/O controller hub (“ICH”) 1030. In at least one embodiment, ICH 1030 may provide direct connections to some I/O devices via a local I/O bus. In at least one embodiment, local I/O bus may include, without limitation, a high-speed I/O bus for connecting peripherals to memory 1020, chipset, and processor 1002. Examples may include, without limitation, an audio controller 1029, a firmware hub (“flash BIOS”) 1028, a wireless transceiver 1026, a data storage 1024, a legacy I/O controller 1023 containing user input and keyboard interfaces 1025, a serial expansion port 1027, such as Universal Serial Bus (“USB”), and a network controller 1034, which may include in some embodiments, a data processing unit. Data storage 1024 may comprise a hard disk drive, a floppy disk drive, a CD-ROM device, a flash memory device, or other mass storage device.

In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1000 are interconnected using compute express link (CXL) interconnects.

Inference and/or training logic are used to perform inferencing and/or training operations associated with one or more embodiments. Details regarding inference and/or training logic are provided herein in conjunction with FIGS. 8A and/or 8B. In at least one embodiment, inference and/or training logic may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

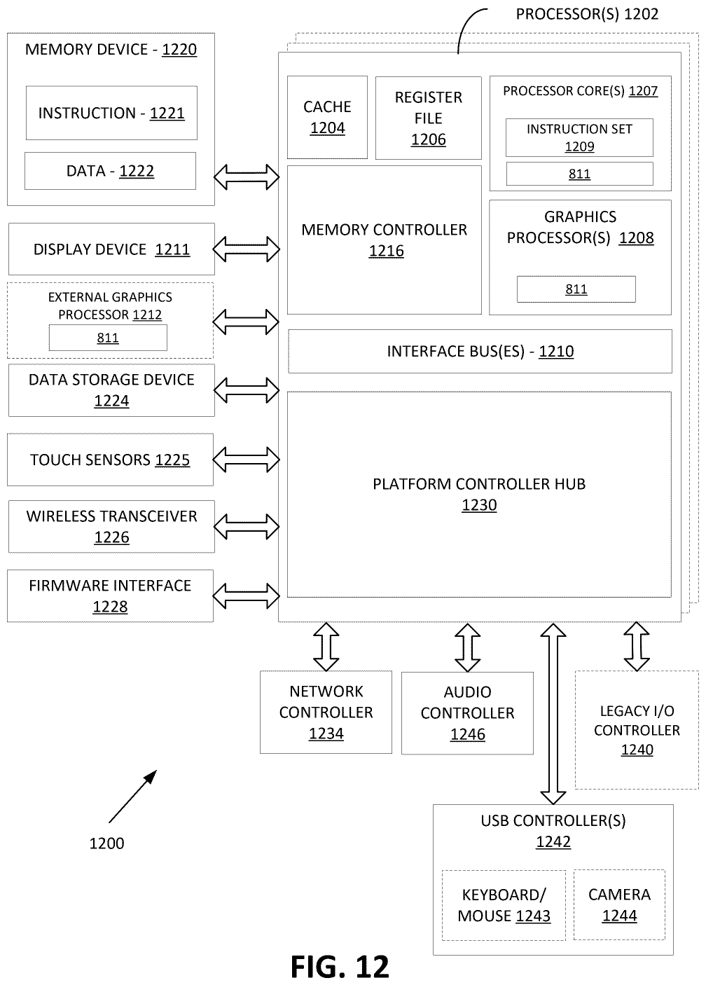

FIG. 11 is a block diagram illustrating an electronic device 1100 for utilizing a processor 1110, according to at least one embodiment. In at least one embodiment, electronic device 1100 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 1100 may include, without limitation, processor 1110 communicatively coupled to any suitable number or kind of components, peripherals, modules, or devices. In at least one embodiment, processor 1110 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices illustrated in FIG. 11 may be interconnected with proprietary interconnects, standardized interconnects (e.g., PCIe) or some combination thereof. In at least one embodiment, one or more components of FIG. 11 are interconnected using compute express link (CXL) interconnects.

In at least one embodiment, FIG. 11 may include a display 1124, a touch screen 1125, a touch pad 1130, a Near Field Communications unit (“NFC”) 1145, a sensor hub 1140, a thermal sensor 1146, an Express Chipset (“EC”) 1135, a Trusted Platform Module (“TPM”) 1138, BIOS/firmware/flash memory (“BIOS, FW Flash”) 1122, a DSP 1160, a drive 1120 such as a Solid State Disk (“SSD”) or a Hard Disk Drive (“HDD”), a wireless local area network unit (“WLAN”) 1150, a Bluetooth unit 1152, a Wireless Wide Area Network unit (“WWAN”) 1156, a Global Positioning System (GPS) 1155, a camera (“USB 3.0 camera”) 1154 such as a USB 3.0 camera, and/or a Low Power Double Data Rate (“LPDDR”) memory unit (“LPDDR3”) 1115 implemented in, for example, LPDDR3 standard. These components may each be implemented in any suitable manner.

In at least one embodiment, other components may be communicatively coupled to processor 1110 through components discussed above. In at least one embodiment, an accelerometer 1141, Ambient Light Sensor (“ALS”) 1142, compass 1143, and a gyroscope 1144 may be communicatively coupled to sensor hub 1140. In at least one embodiment, thermal sensor 1139, a fan 1137, a keyboard 1136, and a touch pad 1130 may be communicatively coupled to EC 1135. In at least one embodiment, speaker 1163, headphones 1164, and microphone (“mic”) 1165 may be communicatively coupled to an audio unit (“audio codec and class d amp”) 1162, which may in turn be communicatively coupled to DSP 1160. In at least one embodiment, audio unit 1164 may include, for example and without limitation, an audio coder/decoder (“codec”) and a class D amplifier. In at least one embodiment, SIM card (“SIM”) 1157 may be communicatively coupled to WWAN unit 1156. In at least one embodiment, components such as WLAN unit 1150 and Bluetooth unit 1152, as well as WWAN unit 1156 may be implemented in a Next Generation Form Factor (“NGFF”).

Inference and/or training logic are used to perform inferencing and/or training operations associated with one or more embodiments. Details regarding inference and/or training logic 815 are provided herein in conjunction with FIGS. 8A and/or 8B. In at least one embodiment, inference and/or training logic 815 may be used in system FIG. 11 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

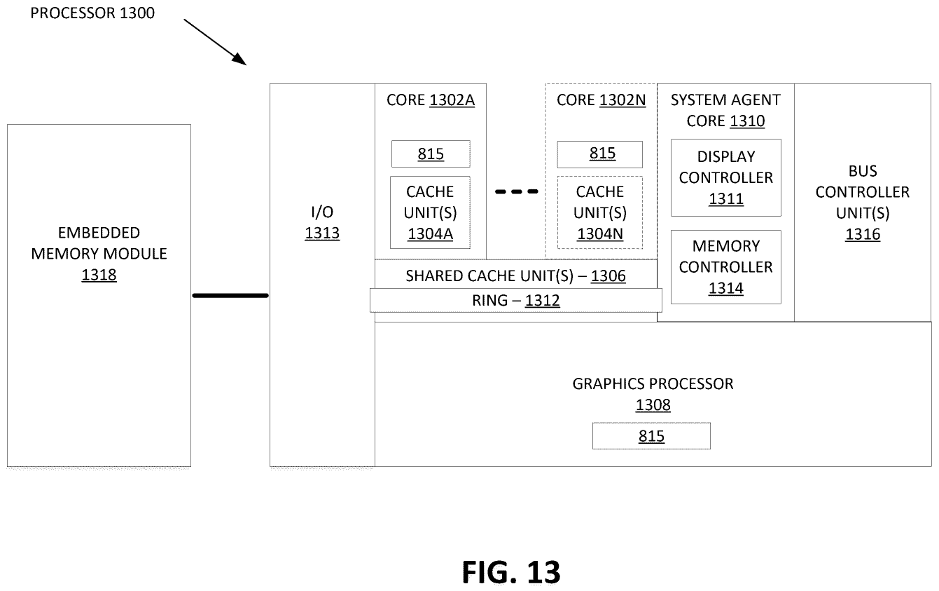

FIG. 12 is a block diagram of a processing system, according to at least one embodiment. In at least one embodiment, system 1200 includes one or more processors 1202 and one or more graphics processors 1208, and may be a single processor desktop system, a multiprocessor workstation system, or a server system having a large number of processors 1202 or processor cores 1207. In at least one embodiment, system 1200 is a processing platform incorporated within a system-on-a-chip (SoC) integrated circuit for use in mobile, handheld, edge, or embedded devices.

In at least one embodiment, system 1200 may include, or be incorporated within a server-based gaming platform, a game console, including a game and media console, a mobile gaming console, a handheld game console, or an online game console. In at least one embodiment, system 1200 is a mobile phone, smart phone, tablet computing device or mobile Internet device. In at least one embodiment, processing system 1200 may also include, couple with, or be integrated within a wearable device, such as a smart watch wearable device, smart eyewear device, augmented reality device, or virtual reality device. In at least one embodiment, processing system 1200 is a television or set top box device having one or more processors 1202 and a graphical interface generated by one or more graphics processors 1208.

In at least one embodiment, one or more processors 1202 each include one or more processor cores 1207 to process instructions which, when executed, perform operations for system and user software. In at least one embodiment, each of one or more processor cores 1207 is configured to process a specific instruction set 1209. In at least one embodiment, instruction set 1209 may facilitate Complex Instruction Set Computing (CISC), Reduced Instruction Set Computing (RISC), or computing via a Very Long Instruction Word (VLIW). In at least one embodiment, processor cores 1207 may each process a different instruction set 1209, which may include instructions to facilitate emulation of other instruction sets. In at least one embodiment, processor core 1207 may also include other processing devices, such a Digital Signal Processor (DSP).

In at least one embodiment, processor 1202 includes cache memory 1204. In at least one embodiment, processor 1202 may have a single internal cache or multiple levels of internal cache. In at least one embodiment, cache memory is shared among various components of processor 1202. In at least one embodiment, processor 1202 also uses an external cache (e.g., a Level-3 (L3) cache or Last Level Cache (LLC)) (not shown), which may be shared among processor cores 1207 using known cache coherency techniques. In at least one embodiment, register file 1206 is additionally included in processor 1202 which may include different types of registers for storing different types of data (e.g., integer registers, floating point registers, status registers, and an instruction pointer register). In at least one embodiment, register file 1206 may include general-purpose registers or other registers.

In at least one embodiment, one or more processor(s) 1202 are coupled with one or more interface bus(es) 1210 to transmit communication signals such as address, data, or control signals between processor 1202 and other components in system 1200. In at least one embodiment, interface bus 1210, in one embodiment, may be a processor bus, such as a version of a Direct Media Interface (DMI) bus. In at least one embodiment, interface 1210 is not limited to a DMI bus, and may include one or more Peripheral Component Interconnect buses (e.g., PCI, PCI Express), memory busses, or other types of interface busses. In at least one embodiment processor(s) 1202 include an integrated memory controller 1216 and a platform controller hub 1230. In at least one embodiment, memory controller 1216 facilitates communication between a memory device and other components of system 1200, while platform controller hub (PCH) 1230 provides connections to I/O devices via a local I/O bus.

In at least one embodiment, memory device 1220 may be a dynamic random access memory (DRAM) device, a static random access memory (SRAM) device, flash memory device, phase-change memory device, or some other memory device having suitable performance to serve as process memory. In at least one embodiment memory device 1220 may operate as system memory for system 1200, to store data 1222 and instructions 1221 for use when one or more processors 1202 executes an application or process. In at least one embodiment, memory controller 1216 also couples with an optional external graphics processor 1212, which may communicate with one or more graphics processors 1208 in processors 1202 to perform graphics and media operations. In at least one embodiment, a display device 1211 may connect to processor(s) 1202. In at least one embodiment display device 1211 may include one or more of an internal display device, as in a mobile electronic device or a laptop device or an external display device attached via a display interface (e.g., DisplayPort, etc.). In at least one embodiment, display device 1211 may include a head mounted display (HMD) such as a stereoscopic display device for use in virtual reality (VR) applications or augmented reality (AR) applications.

In at least one embodiment, platform controller hub 1230 enables peripherals to connect to memory device 1220 and processor 1202 via a high-speed I/O bus. In at least one embodiment, I/O peripherals include, but are not limited to, an audio controller 1246, a network controller 1234, a firmware interface 1228, a wireless transceiver 1226, touch sensors 1225, a data storage device 1224 (e.g., hard disk drive, flash memory, etc.). In at least one embodiment, data storage device 1224 may connect via a storage interface (e.g., SATA) or via a peripheral bus, such as a Peripheral Component Interconnect bus (e.g., PCI, PCI Express). In at least one embodiment, touch sensors 1225 may include touch screen sensors, pressure sensors, or fingerprint sensors. In at least one embodiment, wireless transceiver 1226 may be a Wi-Fi transceiver, a Bluetooth transceiver, or a mobile network transceiver such as a 3G, 4G, or Long Term Evolution (LTE) transceiver. In at least one embodiment, firmware interface 1228 enables communication with system firmware, and may be, for example, a unified extensible firmware interface (UEFI). In at least one embodiment, network controller 1234 may enable a network connection to a wired network. In at least one embodiment, a high-performance network controller (not shown) couples with interface bus 1210. In at least one embodiment, audio controller 1246 is a multi-channel high definition audio controller. In at least one embodiment, system 1200 includes an optional legacy I/O controller 1240 for coupling legacy (e.g., Personal System 2 (PS/2)) devices to system. In at least one embodiment, platform controller hub 1230 may also connect to one or more Universal Serial Bus (USB) controllers 1242 connect input devices, such as keyboard and mouse 1243 combinations, a camera 1244, or other USB input devices.

In at least one embodiment, an instance of memory controller 1216 and platform controller hub 1230 may be integrated into a discreet external graphics processor, such as external graphics processor 1212. In at least one embodiment, platform controller hub 1230 and/or memory controller 1216 may be external to one or more processor(s) 1202. For example, in at least one embodiment, system 1200 may include an external memory controller 1216 and platform controller hub 1230, which may be configured as a memory controller hub and peripheral controller hub within a system chipset that is in communication with processor(s) 1202.

Inference and/or training logic are used to perform inferencing and/or training operations associated with one or more embodiments. Details regarding inference and/or training logic 815 are provided herein in conjunction with FIGS. 8A and/or 8B. In at least one embodiment portions or all of inference and/or training logic may be incorporated into graphics processor 1300. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

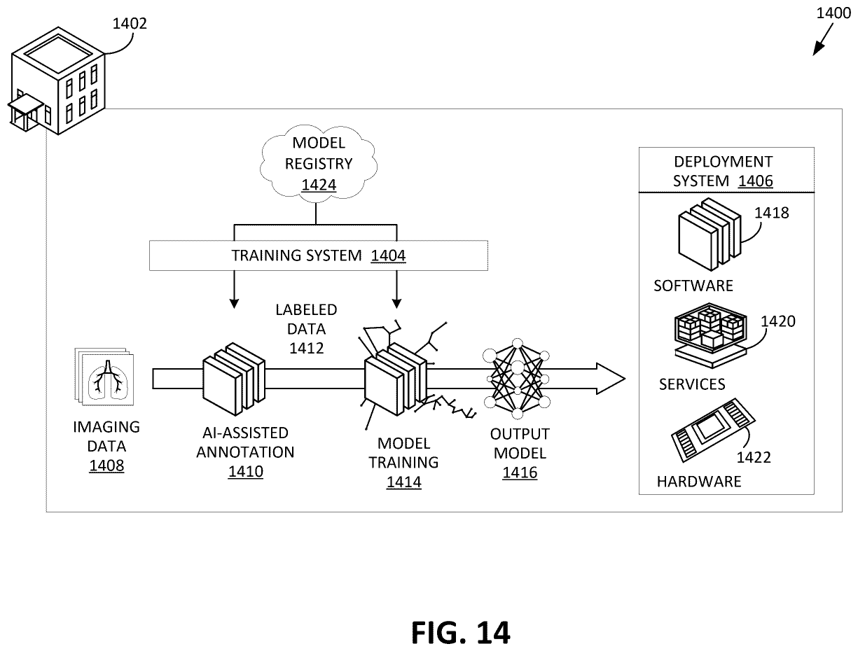

FIG. 13 is a block diagram of a processor 1300 having one or more processor cores 1302A-1402N, an integrated memory controller 1314, and an integrated graphics processor 1308, according to at least one embodiment. In at least one embodiment, processor 1300 may include additional cores up to and including additional core 1302N represented by dashed lined boxes. In at least one embodiment, each of processor cores 1302A-1402N includes one or more internal cache units 1304A-1404N. In at least one embodiment, each processor core also has access to one or more shared cached units 1306.

In at least one embodiment, internal cache units 1304A-1404N and shared cache units 1306 represent a cache memory hierarchy within processor 1300. In at least one embodiment, cache memory units 1304A-1404N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1306 and 1304A-1404N.

In at least one embodiment, processor 1300 may also include a set of one or more bus controller units 1316 and a system agent core 1310. In at least one embodiment, one or more bus controller units 1316 manage a set of peripheral buses, such as one or more PCI or PCI express busses. In at least one embodiment, system agent core 1310 provides management functionality for various processor components. In at least one embodiment, system agent core 1310 includes one or more integrated memory controllers 1314 to manage access to various external memory devices (not shown).

In at least one embodiment, one or more of processor cores 1302A-1402N include support for simultaneous multi-threading. In at least one embodiment, system agent core 1310 includes components for coordinating and operating cores 1302A-1402N during multi-threaded processing. In at least one embodiment, system agent core 1310 may additionally include a power control unit (PCU), which includes logic and components to regulate one or more power states of processor cores 1302A-1402N and graphics processor 1308.

In at least one embodiment, processor 1300 additionally includes graphics processor 1308 to execute graphics processing operations. In at least one embodiment, graphics processor 1308 couples with shared cache units 1306, and system agent core 1310, including one or more integrated memory controllers 1314. In at least one embodiment, system agent core 1310 also includes a display controller 1311 to drive graphics processor output to one or more coupled displays. In at least one embodiment, display controller 1311 may also be a separate module coupled with graphics processor 1308 via at least one interconnect, or may be integrated within graphics processor 1308.

In at least one embodiment, a ring based interconnect unit 1312 is used to couple internal components of processor 1300. In at least one embodiment, an alternative interconnect unit may be used, such as a point-to-point interconnect, a switched interconnect, or other techniques. In at least one embodiment, graphics processor 1308 couples with ring interconnect 1312 via an I/O link 1313.

In at least one embodiment, I/O link 1313 represents at least one of multiple varieties of I/O interconnects, including an on package I/O interconnect which facilitates communication between various processor components and a high-performance embedded memory module 1318, such as an eDRAM module. In at least one embodiment, each of processor cores 1302A-1402N and graphics processor 1308 use embedded memory modules 1318 as a shared Last Level Cache.

In at least one embodiment, processor cores 1302A-1402N are homogenous cores executing a common instruction set architecture. In at least one embodiment, processor cores 1302A-1402N are heterogeneous in terms of instruction set architecture (ISA), where one or more of processor cores 1302A-1402N execute a common instruction set, while one or more other cores of processor cores 1302A-1402N executes a subset of a common instruction set or a different instruction set. In at least one embodiment, processor cores 1302A-1402N are heterogeneous in terms of microarchitecture, where one or more cores having a relatively higher power consumption couple with one or more power cores having a lower power consumption. In at least one embodiment, processor 1300 may be implemented on one or more chips or as an SoC integrated circuit.

Inference and/or training logic are used to perform inferencing and/or training operations associated with one or more embodiments. Details regarding inference and/or training logic 815 are provided herein in conjunction with FIGS. 8A and/or 8B. In at least one embodiment portions or all of inference and/or training logic may be incorporated into processor 1300. For example, in at least one embodiment, training and/or inferencing techniques described herein may use one or more of ALUs embodied in graphics processor 1308, graphics core(s) 1302A-1402N, or other components in FIG. 13. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of graphics processor 1300 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

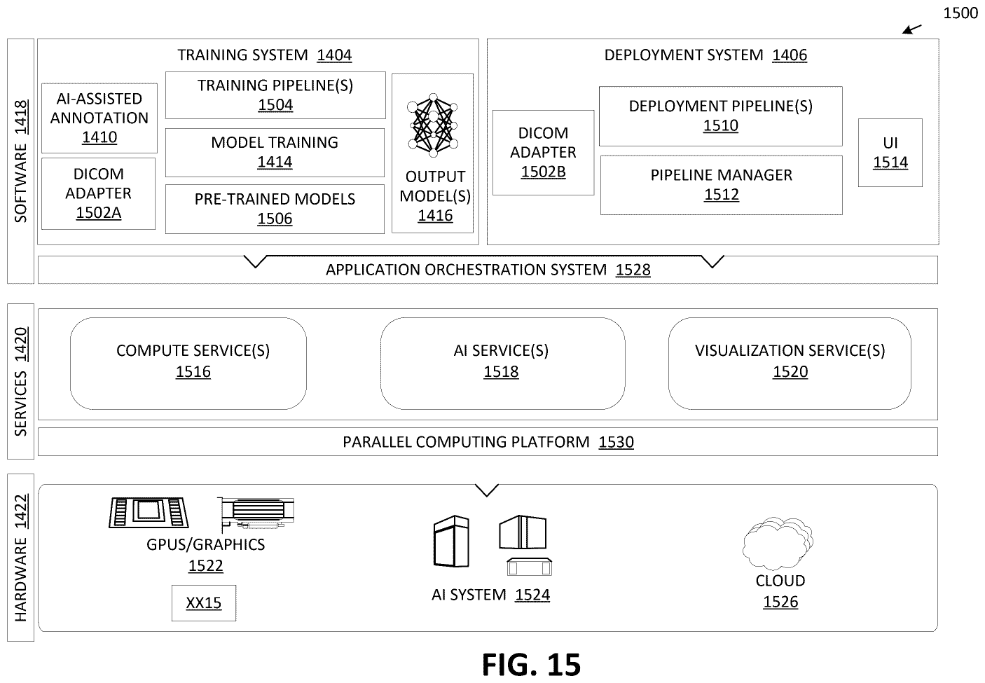

FIG. 14 is an example data flow diagram for a process 1400 of generating and deploying an image processing and inferencing pipeline, in accordance with at least one embodiment. In at least one embodiment, process 1400 may be deployed for use with imaging devices, processing devices, and/or other device types at one or more facilities 1402. Process 1400 may be executed within a training system 1404 and/or a deployment system 1406. In at least one embodiment, training system 1404 may be used to perform training, deployment, and implementation of machine learning models (e.g., neural networks, object detection algorithms, computer vision algorithms, etc.) for use in deployment system 1406. In at least one embodiment, deployment system 1406 may be configured to offload processing and compute resources among a distributed computing environment to reduce infrastructure requirements at facility 1402. In at least one embodiment, one or more applications in a pipeline may use or call upon services (e.g., inference, visualization, compute, AI, etc.) of deployment system 1406 during execution of applications.

In at least one embodiment, some of applications used in advanced processing and inferencing pipelines may use machine learning models or other AI to perform one or more processing steps. In at least one embodiment, machine learning models may be trained at facility 1402 using data 1408 (such as imaging data) generated at facility 1402 (and stored on one or more picture archiving and communication system (PACS) servers at facility 1402), may be trained using imaging or sequencing data 1408 from another facility (ies), or a combination thereof. In at least one embodiment, training system 1404 may be used to provide applications, services, and/or other resources for generating working, deployable machine learning models for deployment system 1406.

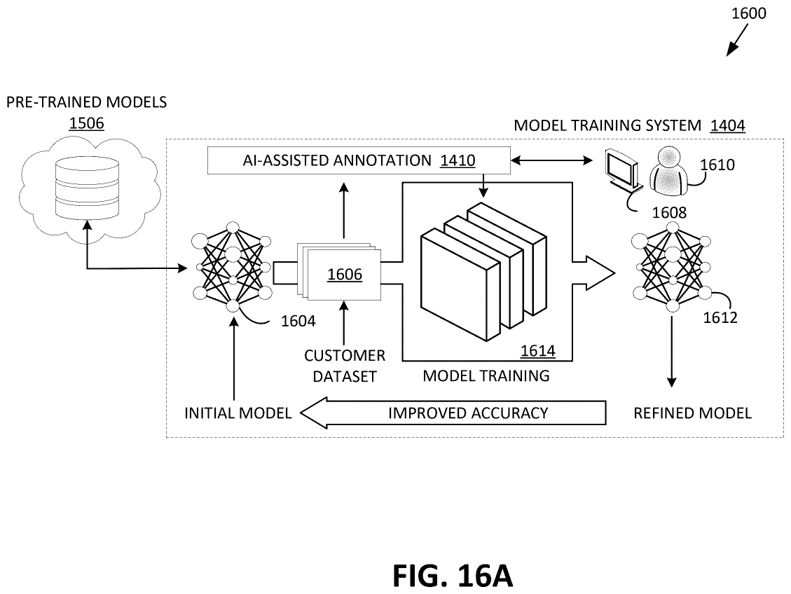

In at least one embodiment, model registry 1424 may be backed by object storage that may support versioning and object metadata. In at least one embodiment, object storage may be accessible through, for example, a cloud storage (e.g., cloud 1526 of FIG. 15) compatible application programming interface (API) from within a cloud platform. In at least one embodiment, machine learning models within model registry 1424 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1504 (FIG. 15) may include a scenario where facility 1402 is training their own machine learning model, or has an existing machine learning model that needs to be optimized or updated. In at least one embodiment, imaging data 1408 generated by imaging device(s), sequencing devices, and/or other device types may be received. In at least one embodiment, once imaging data 1408 is received, AI-assisted annotation 1410 may be used to aid in generating annotations corresponding to imaging data 1408 to be used as ground truth data for a machine learning model. In at least one embodiment, AI-assisted annotation 1410 may include one or more machine learning models (e.g., convolutional neural networks (CNNs)) that may be trained to generate annotations corresponding to certain types of imaging data 1408 (e.g., from certain devices). In at least one embodiment, AI-assisted annotations 1410 may then be used directly, or may be adjusted or fine-tuned using an annotation tool to generate ground truth data. In at least one embodiment, AI-assisted annotations 1410, labeled clinic data 1412, or a combination thereof may be used as ground truth data for training a machine learning model. In at least one embodiment, a trained machine learning model may be referred to as output model 1416, and may be used by deployment system 1406, as described herein.

In at least one embodiment, training pipeline 1504 (FIG. 15) may include a scenario where facility 1402 needs a machine learning model for use in performing one or more processing tasks for one or more applications in deployment system 1406, but facility 1402 may not currently have such a machine learning model (or may not have a model that is optimized, efficient, or effective for such purposes). In at least one embodiment, an existing machine learning model may be selected from a model registry 1424. In at least one embodiment, model registry 1424 may include machine learning models trained to perform a variety of different inference tasks on imaging data. In at least one embodiment, machine learning models in model registry 1424 may have been trained on imaging data from different facilities than facility 1402 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1424. In at least one embodiment, a machine learning model may then be retrained, or updated, at any number of other facilities, and a retrained or updated model may be made available in model registry 1424. In at least one embodiment, a machine learning model may then be selected from model registry 1424—and referred to as output model 1416—and may be used in deployment system 1406 to perform one or more processing tasks for one or more applications of a deployment system.

In at least one embodiment, training pipeline 1504 (FIG. 15), a scenario may include facility 1402 requiring a machine learning model for use in performing one or more processing tasks for one or more applications in deployment system 1406, but facility 1402 may not currently have such a machine learning model (or may not have a model that is optimized, efficient, or effective for such purposes). In at least one embodiment, a machine learning model selected from model registry 1424 may not be fine-tuned or optimized for imaging data 1408 generated at facility 1402 because of differences in populations, robustness of training data used to train a machine learning model, diversity in anomalies of training data, and/or other issues with training data. In at least one embodiment, AI-assisted annotation 1410 may be used to aid in generating annotations corresponding to imaging data 1408 to be used as ground truth data for retraining or updating a machine learning model. In at least one embodiment, labeled data 1412 may be used as ground truth data for training a machine learning model. In at least one embodiment, retraining or updating a machine learning model may be referred to as model training 1414. In at least one embodiment, model training 1414—e.g., AI-assisted annotations 1410, labeled clinic data 1412, or a combination thereof—may be used as ground truth data for retraining or updating a machine learning model. In at least one embodiment, a trained machine learning model may be referred to as output model 1416, and may be used by deployment system 1406, as described herein.

In at least one embodiment, deployment system 1406 may include software 1418, services 1420, hardware 1422, and/or other components, features, and functionality. In at least one embodiment, deployment system 1406 may include a software “stack,” such that software 1418 may be built on top of services 1420 and may use services 1420 to perform some or all of processing tasks, and services 1420 and software 1418 may be built on top of hardware 1422 and use hardware 1422 to execute processing, storage, and/or other compute tasks of deployment system 1406. In at least one embodiment, software 1418 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1408, in addition to containers that receive and configure imaging data for use by each container and/or for use by facility 1402 after processing through a pipeline (e.g., to convert outputs back to a usable data type). In at least one embodiment, a combination of containers within software 1418 (e.g., that make up a pipeline) may be referred to as a virtual instrument (as described in more detail herein), and a virtual instrument may leverage services 1420 and hardware 1422 to execute some or all processing tasks of applications instantiated in containers.

In at least one embodiment, a data processing pipeline may receive input data (e.g., imaging data 1408) in a specific format in response to an inference request (e.g., a request from a user of deployment system 1406). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1416 of training system 1404.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1424 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1420 as a system (e.g., system 1500 of FIG. 15). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1500 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1500 of FIG. 15). In at least one embodiment, completed and validated applications or containers may be stored in a container registry and associated machine learning models may be stored in model registry 1424. In at least one embodiment, a requesting entity—who provides an inference or image processing request—may browse a container registry and/or model registry 1424 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1406 (e.g., a cloud) to perform processing of data processing pipeline. In at least one embodiment, processing by deployment system 1406 may include referencing selected elements (e.g., applications, containers, models, etc.) from a container registry and/or model registry 1424. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1420 may be leveraged. In at least one embodiment, services 1420 may include compute services, artificial intelligence (AI) services, visualization services, and/or other service types. In at least one embodiment, services 1420 may provide functionality that is common to one or more applications in software 1418, so functionality may be abstracted to a service that may be called upon or leveraged by applications. In at least one embodiment, functionality provided by services 1420 may run dynamically and more efficiently, while also scaling well by allowing applications to process data in parallel (e.g., using a parallel computing platform 1530 (FIG. 15)). In at least one embodiment, rather than each application that shares a same functionality offered by a service 1420 being required to have a respective instance of service 1420, service 1420 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1420 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1418 implementing advanced processing and inferencing pipeline that includes segmentation application and anomaly detection application may be streamlined because each application may call upon a same inference service to perform one or more inferencing tasks.

In at least one embodiment, hardware 1422 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1422 may be used to provide efficient, purpose-built support for software 1418 and services 1420 in deployment system 1406. In at least one embodiment, use of GPU processing may be implemented for processing locally (e.g., at facility 1402), within an AI/deep learning system, in a cloud system, and/or in other processing components of deployment system 1406 to improve efficiency, accuracy, and efficacy of image processing and generation. In at least one embodiment, software 1418 and/or services 1420 may be optimized for GPU processing with respect to deep learning, machine learning, and/or high-performance computing, as non-limiting examples. In at least one embodiment, at least some of computing environment of deployment system 1406 and/or training system 1404 may be executed in a datacenter one or more supercomputers or high performance computing systems, with GPU optimized software (e.g., hardware and software combination of NVIDIA's DGX System). In at least one embodiment, hardware 1422 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 15 is a system diagram for an example system 1500 for generating and deploying an imaging deployment pipeline, in accordance with at least one embodiment. In at least one embodiment, system 1500 may be used to implement process 1400 of FIG. 14 and/or other processes including advanced processing and inferencing pipelines. In at least one embodiment, system 1500 may include training system 1404 and deployment system 1406. In at least one embodiment, training system 1404 and deployment system 1406 may be implemented using software 1418, services 1420, and/or hardware 1422, as described herein.

In at least one embodiment, system 1500 (e.g., training system 1404 and/or deployment system 1406) may implemented in a cloud computing environment (e.g., using cloud 1526). In at least one embodiment, system 1500 may be implemented locally with respect to a healthcare services facility, or as a combination of both cloud and local computing resources. In at least one embodiment, access to APIs in cloud 1526 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1500, may be restricted to a set of public IPs that have been vetted or authorized for interaction.

In at least one embodiment, various components of system 1500 may communicate between and among one another using any of a variety of different network types, including but not limited to local area networks (LANs) and/or wide area networks (WANs) via wired and/or wireless communication protocols. In at least one embodiment, communication between facilities and components of system 1500 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1404 may execute training pipelines 1504, similar to those described herein with respect to FIG. 14. In at least one embodiment, where one or more machine learning models are to be used in deployment pipelines 1510 by deployment system 1406, training pipelines 1504 may be used to train or retrain one or more (e.g., pre-trained) models, and/or implement one or more of pre-trained models 1506 (e.g., without a need for retraining or updating). In at least one embodiment, as a result of training pipelines 1504, output model(s) 1416 may be generated. In at least one embodiment, training pipelines 1504 may include any number of processing steps, such as but not limited to imaging data (or other input data) conversion or adaption In at least one embodiment, for different machine learning models used by deployment system 1406, different training pipelines 1504 may be used. In at least one embodiment, training pipeline 1504 similar to a first example described with respect to FIG. 14 may be used for a first machine learning model, training pipeline 1504 similar to a second example described with respect to FIG. 14 may be used for a second machine learning model, and training pipeline 1504 similar to a third example described with respect to FIG. 14 may be used for a third machine learning model. In at least one embodiment, any combination of tasks within training system 1404 may be used depending on what is required for each respective machine learning model. In at least one embodiment, one or more of machine learning models may already be trained and ready for deployment so machine learning models may not undergo any processing by training system 1404, and may be implemented by deployment system 1406.

In at least one embodiment, output model(s) 1416 and/or pre-trained model(s) 1506 may include any types of machine learning models depending on implementation or embodiment. In at least one embodiment, and without limitation, machine learning models used by system 1500 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

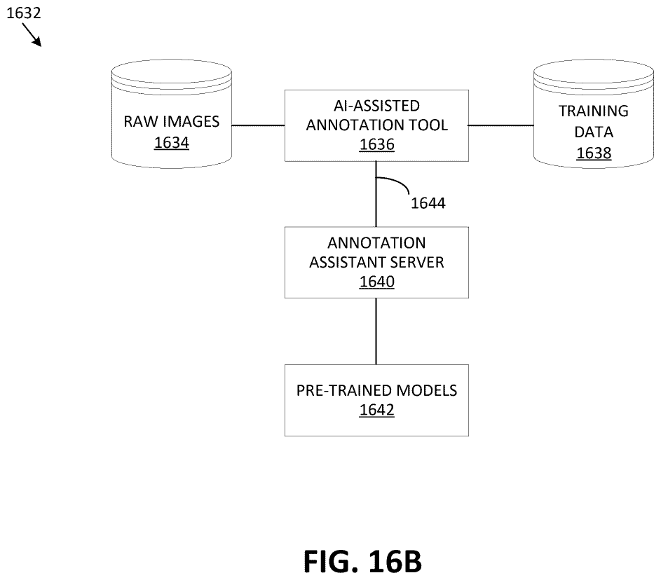

In at least one embodiment, training pipelines 1504 may include AI-assisted annotation, as described in more detail herein with respect to at least FIG. 16B. In at least one embodiment, labeled data 1412 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1408 (or other data type used by machine learning models), there may be corresponding ground truth data generated by training system 1404. In at least one embodiment, AI-assisted annotation may be performed as part of deployment pipelines 1510; either in addition to, or in lieu of AI-assisted annotation included in training pipelines 1504. In at least one embodiment, system 1500 may include a multi-layer platform that may include a software layer (e.g., software 1418) of diagnostic applications (or other application types) that may perform one or more medical imaging and diagnostic functions. In at least one embodiment, system 1500 may be communicatively coupled to (e.g., via encrypted links) PACS server networks of one or more facilities. In at least one embodiment, system 1500 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1402). In at least one embodiment, applications may then call or execute one or more services 1420 for performing compute, AI, or visualization tasks associated with respective applications, and software 1418 and/or services 1420 may leverage hardware 1422 to perform processing tasks in an effective and efficient manner.

In at least one embodiment, deployment system 1406 may execute deployment pipelines 1510. In at least one embodiment, deployment pipelines 1510 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1510 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1510 depending on information desired from data generated by a device. In at least one embodiment, where detections of anomalies are desired from an MRI machine, there may be a first deployment pipeline 1510, and where image enhancement is desired from output of an MRI machine, there may be a second deployment pipeline 1510.

In at least one embodiment, an image generation application may include a processing task that includes use of a machine learning model. In at least one embodiment, a user may desire to use their own machine learning model, or to select a machine learning model from model registry 1424. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1500—such as services 1420 and hardware 1422—deployment pipelines 1510 may be even more user friendly, provide for easier integration, and produce more accurate, efficient, and timely results.

In at least one embodiment, deployment system 1406 may include a user interface 1514 (e.g., a graphical user interface, a web interface, etc.) that may be used to select applications for inclusion in deployment pipeline(s) 1510, arrange applications, modify, or change applications or parameters or constructs thereof, use and interact with deployment pipeline(s) 1510 during set-up and/or deployment, and/or to otherwise interact with deployment system 1406. In at least one embodiment, although not illustrated with respect to training system 1404, user interface 1514 (or a different user interface) may be used for selecting models for use in deployment system 1406, for selecting models for training, or retraining, in training system 1404, and/or for otherwise interacting with training system 1404.

In at least one embodiment, pipeline manager 1512 may be used, in addition to an application orchestration system 1528, to manage interaction between applications or containers of deployment pipeline(s) 1510 and services 1420 and/or hardware 1422. In at least one embodiment, pipeline manager 1512 may be configured to facilitate interactions from application to application, from application to service 1420, and/or from application or service to hardware 1422. In at least one embodiment, although illustrated as included in software 1418, this is not intended to be limiting, and in some examples (e.g., as illustrated in FIG. 13) pipeline manager 1512 may be included in services 1420. In at least one embodiment, application orchestration system 1528 (e.g., Kubernetes, DOCKER, etc.) may include a container orchestration system that may group applications into containers as logical units for coordination, management, scaling, and deployment. In at least one embodiment, by associating applications from deployment pipeline(s) 1510 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1512 and application orchestration system 1528. In at least one embodiment, so long as an expected input and/or output of each container or application is known by a system (e.g., based on constructs of applications or containers), application orchestration system 1528 and/or pipeline manager 1512 may facilitate communication among and between, and sharing of resources among and between, each of applications or containers. In at least one embodiment, because one or more of applications or containers in deployment pipeline(s) 1510 may share same services and resources, application orchestration system 1528 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1528) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1420 leveraged by and shared by applications or containers in deployment system 1406 may include compute services 1516, AI services 1518, visualization services 1520, and/or other service types. In at least one embodiment, applications may call (e.g., execute) one or more of services 1420 to perform processing operations for an application. In at least one embodiment, compute services 1516 may be leveraged by applications to perform super-computing or other high-performance computing (HPC) tasks. In at least one embodiment, compute service(s) 1516 may be leveraged to perform parallel processing (e.g., using a parallel computing platform 1530) for processing data through one or more of applications and/or one or more tasks of a single application, substantially simultaneously. In at least one embodiment, parallel computing platform 1530 (e.g., NVIDIA's CUDA) may enable general purpose computing on GPUs (GPGPU) (e.g., GPUs 1522). In at least one embodiment, a software layer of parallel computing platform 1530 may provide access to virtual instruction sets and parallel computational elements of GPUs, for execution of compute kernels. In at least one embodiment, parallel computing platform 1530 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1530 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1518 may be leveraged to perform inferencing services for executing machine learning model(s) associated with applications (e.g., tasked with performing one or more processing tasks of an application). In at least one embodiment, AI services 1518 may leverage AI system 1524 to execute machine learning model(s) (e.g., neural networks, such as CNNs) for segmentation, reconstruction, object detection, feature detection, classification, and/or other inferencing tasks. In at least one embodiment, applications of deployment pipeline(s) 1510 may use one or more of output models 1416 from training system 1404 and/or other models of applications to perform inference on imaging data. In at least one embodiment, two or more examples of inferencing using application orchestration system 1528 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1528 may distribute resources (e.g., services 1420 and/or hardware 1422) based on priority paths for different inferencing tasks of AI services 1518.

In at least one embodiment, shared storage may be mounted to AI services 1518 within system 1500. In at least one embodiment, shared storage may operate as a cache (or other storage device type) and may be used to process inference requests from applications. In at least one embodiment, when an inference request is submitted, a request may be received by a set of API instances of deployment system 1406, and one or more instances may be selected (e.g., for best fit, for load balancing, etc.) to process a request. In at least one embodiment, to process a request, a request may be entered into a database, a machine learning model may be located from model registry 1424 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1512) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<11 min). In at least one embodiment, model execution times may be measured from requesting institution or entity and may include partner network traversal time, as well as execution on an inference service.

In at least one embodiment, transfer of requests between services 1420 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1526, and an inference service may perform inferencing on a GPU.

In at least one embodiment, visualization services 1520 may be leveraged to generate visualizations for viewing outputs of applications and/or deployment pipeline(s) 1510. In at least one embodiment, GPUs 1522 may be leveraged by visualization services 1520 to generate visualizations. In at least one embodiment, rendering effects, such as ray-tracing, may be implemented by visualization services 1520 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1520 may include an internal visualizer, cinematics, and/or other rendering or image processing capabilities or functionality (e.g., ray tracing, rasterization, internal optics, etc.).

In at least one embodiment, hardware 1422 may include GPUs 1522, AI system 1524, cloud 1526, and/or any other hardware used for executing training system 1404 and/or deployment system 1406. In at least one embodiment, GPUs 1522 (e.g., NVIDIA's TESLA and/or QUADRO GPUs) may include any number of GPUs that may be used for executing processing tasks of compute services 1516, AI services 1518, visualization services 1520, other services, and/or any of features or functionality of software 1418. For example, with respect to AI services 1518, GPUs 1522 may be used to perform pre-processing on imaging data (or other data types used by machine learning models), post-processing on outputs of machine learning models, and/or to perform inferencing (e.g., to execute machine learning models). In at least one embodiment, cloud 1526, AI system 1524, and/or other components of system 1500 may use GPUs 1522. In at least one embodiment, cloud 1526 may include a GPU-optimized platform for deep learning tasks. In at least one embodiment, AI system 1524 may use GPUs, and cloud 1526—or at least a portion tasked with deep learning or inferencing—may be executed using one or more AI systems 1524. As such, although hardware 1422 is illustrated as discrete components, this is not intended to be limiting, and any components of hardware 1422 may be combined with, or leveraged by, any other components of hardware 1422.

In at least one embodiment, AI system 1524 may include a purpose-built computing system (e.g., a super-computer or an HPC) configured for inferencing, deep learning, machine learning, and/or other artificial intelligence tasks. In at least one embodiment, AI system 1524 (e.g., NVIDIA's DGX) may include GPU-optimized software (e.g., a software stack) that may be executed using a plurality of GPUs 1522, in addition to DPUs, CPUs, RAM, storage, and/or other components, features, or functionality. In at least one embodiment, one or more AI systems 1524 may be implemented in cloud 1526 (e.g., in a data center) for performing some or all of AI-based processing tasks of system 1500.

In at least one embodiment, cloud 1526 may include a GPU-accelerated infrastructure (e.g., NVIDIA's NGC) that may provide a GPU-optimized platform for executing processing tasks of system 1500. In at least one embodiment, cloud 1526 may include an AI system(s) 1524 for performing one or more of AI-based tasks of system 1500 (e.g., as a hardware abstraction and scaling platform). In at least one embodiment, cloud 1526 may integrate with application orchestration system 1528 leveraging multiple GPUs to enable seamless scaling and load balancing between and among applications and services 1420. In at least one embodiment, cloud 1526 may tasked with executing at least some of services 1420 of system 1500, including compute services 1516, AI services 1518, and/or visualization services 1520, as described herein. In at least one embodiment, cloud 1526 may perform small and large batch inference (e.g., executing NVIDIA's TENSOR RT), provide an accelerated parallel computing API and platform 1530 (e.g., NVIDIA's CUDA), execute application orchestration system 1528 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1500.

FIG. 16A illustrates a data flow diagram for a process 1600 to train, retrain, or update a machine learning model, in accordance with at least one embodiment. In at least one embodiment, process 1600 may be executed using, as a non-limiting example, system 1500 of FIG. 15. In at least one embodiment, process 1600 may leverage services 1420 and/or hardware 1422 of system 1500, as described herein. In at least one embodiment, refined models 1612 generated by process 1600 may be executed by deployment system 1406 for one or more containerized applications in deployment pipelines 1510.

In at least one embodiment, model training 1414 may include retraining or updating an initial model 1604 (e.g., a pre-trained model) using new training data (e.g., new input data, such as customer dataset 1606, and/or new ground truth data associated with input data). In at least one embodiment, to retrain, or update, initial model 1604, output or loss layer(s) of initial model 1604 may be reset, or deleted, and/or replaced with an updated or new output or loss layer(s). In at least one embodiment, initial model 1604 may have previously fine-tuned parameters (e.g., weights and/or biases) that remain from prior training, so training or retraining 1414 may not take as long or require as much processing as training a model from scratch. In at least one embodiment, during model training 1414, by having reset or replaced output or loss layer(s) of initial model 1604, parameters may be updated and re-tuned for a new data set based on loss calculations associated with accuracy of output or loss layer(s) at generating predictions on new, customer dataset 1606 (e.g., image data 1408 of FIG. 14).

In at least one embodiment, pre-trained models 1506 may be stored in a data store, or registry (e.g., model registry 1424 of FIG. 14). In at least one embodiment, pre-trained models 1506 may have been trained, at least in part, at one or more facilities other than a facility executing process 1600. In at least one embodiment, to protect privacy and rights of patients, subjects, or clients of different facilities, pre-trained models 1506 may have been trained, on-premises, using customer or patient data generated on-premises. In at least one embodiment, pre-trained models 1506 may be trained using cloud 1526 and/or other hardware 1422, but confidential, privacy protected patient data may not be transferred to, used by, or accessible to any components of cloud 1526 (or other off premise hardware). In at least one embodiment, where a pre-trained model 1506 is trained at using patient data from more than one facility, pre-trained model 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1506 on-premise and/or off premise, such as in a datacenter or other cloud computing infrastructure.

In at least one embodiment, when selecting applications for use in deployment pipelines 1510, a user may also select machine learning models to be used for specific applications. In at least one embodiment, a user may not have a model for use, so a user may select a pre-trained model 1506 to use with an application. In at least one embodiment, pre-trained model 1506 may not be optimized for generating accurate results on customer dataset 1606 of a facility of a user (e.g., based on patient diversity, demographics, types of medical imaging devices used, etc.). In at least one embodiment, prior to deploying pre-trained model 1506 into deployment pipeline 1510 for use with an application(s), pre-trained model 1506 may be updated, retrained, and/or fine-tuned for use at a respective facility.

In at least one embodiment, a user may select pre-trained model 1506 that is to be updated, retrained, and/or fine-tuned, and pre-trained model 1506 may be referred to as initial model 1604 for training system 1404 within process 1600. In at least one embodiment, customer dataset 1606 (e.g., imaging data, genomics data, sequencing data, or other data types generated by devices at a facility) may be used to perform model training 1414 (which may include, without limitation, transfer learning) on initial model 1604 to generate refined model 1612. In at least one embodiment, ground truth data corresponding to customer dataset 1606 may be generated by training system 1404. In at least one embodiment, ground truth data may be generated, at least in part, by clinicians, scientists, doctors, practitioners, at a facility (e.g., as labeled clinic data 1412 of FIG. 14).

In at least one embodiment, AI-assisted annotation 1410 may be used in some examples to generate ground truth data. In at least one embodiment, AI-assisted annotation 1410 (e.g., implemented using an AI-assisted annotation SDK) may leverage machine learning models (e.g., neural networks) to generate suggested or predicted ground truth data for a customer dataset. In at least one embodiment, user 1610 may use annotation tools within a user interface (a graphical user interface (GUI)) on computing device 1608.

In at least one embodiment, user 1610 may interact with a GUI via computing device 1608 to edit or fine-tune (auto) annotations. In at least one embodiment, a polygon editing feature may be used to move vertices of a polygon to more accurate or fine-tuned locations.

In at least one embodiment, once customer dataset 1606 has associated ground truth data, ground truth data (e.g., from AI-assisted annotation, manual labeling, etc.) may be used by during model training 1414 to generate refined model 1612. In at least one embodiment, customer dataset 1606 may be applied to initial model 1604 any number of times, and ground truth data may be used to update parameters of initial model 1604 until an acceptable level of accuracy is attained for refined model 1612. In at least one embodiment, once refined model 1612 is generated, refined model 1612 may be deployed within one or more deployment pipelines 1510 at a facility for performing one or more processing tasks with respect to medical imaging data.

In at least one embodiment, refined model 1612 may be uploaded to pre-trained models 1506 in model registry 1424 to be selected by another facility. In at least one embodiment, his process may be completed at any number of facilities such that refined model 1612 may be further refined on new datasets any number of times to generate a more universal model.

FIG. 16B is an example illustration of a client-server architecture 1632 to enhance annotation tools with pre-trained annotation models, in accordance with at least one embodiment. In at least one embodiment, AI-assisted annotation tools 1636 may be instantiated based on a client-server architecture 1632. In at least one embodiment, annotation tools 1636 in imaging applications may aid radiologists, for example, identify organs and abnormalities. In at least one embodiment, imaging applications may include software tools that help user 1610 to identify, as a non-limiting example, a few extreme points on a particular organ of interest in raw images 1634 (e.g., in a 3D MRI or CT scan) and receive auto-annotated results for all 2D slices of a particular organ. In at least one embodiment, results may be stored in a data store as training data 1638 and used as (for example and without limitation) ground truth data for training. In at least one embodiment, when computing device 1608 sends extreme points for AI-assisted annotation 1410, a deep learning model, for example, may receive this data as input and return inference results of a segmented organ or abnormality. In at least one embodiment, pre-instantiated annotation tools, such as AI-Assisted Annotation Tool 1636B in FIG. 16B, may be enhanced by making API calls (e.g., API Call 1644) to a server, such as an Annotation Assistant Server 1640 that may include a set of pre-trained models 1642 stored in an annotation model registry, for example. In at least one embodiment, an annotation model registry may store pre-trained models 1642 (e.g., machine learning models, such as deep learning models) that are pre-trained to perform AI-assisted annotation on a particular organ or abnormality. These models may be further updated by using training pipelines 1504. In at least one embodiment, pre-installed annotation tools may be improved over time as new labeled clinic data 1412 is added.

### Autonomous Vehicle

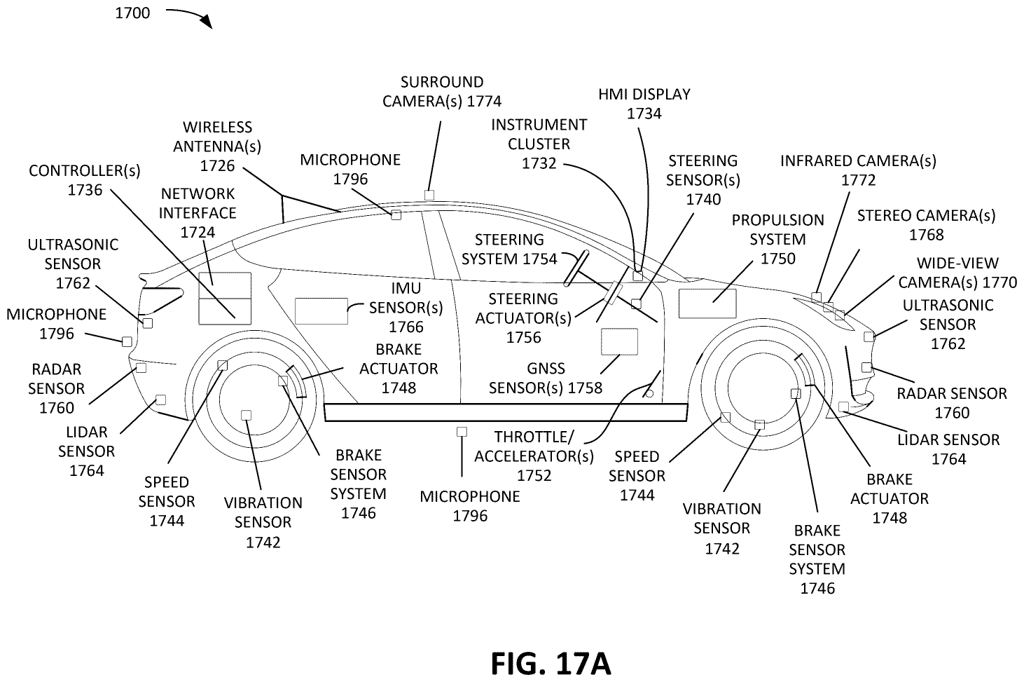

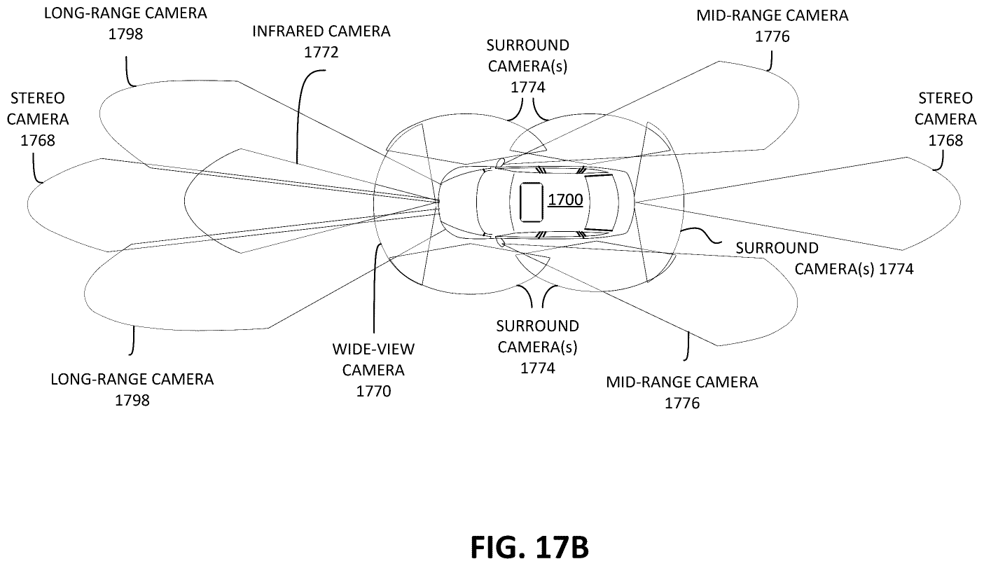

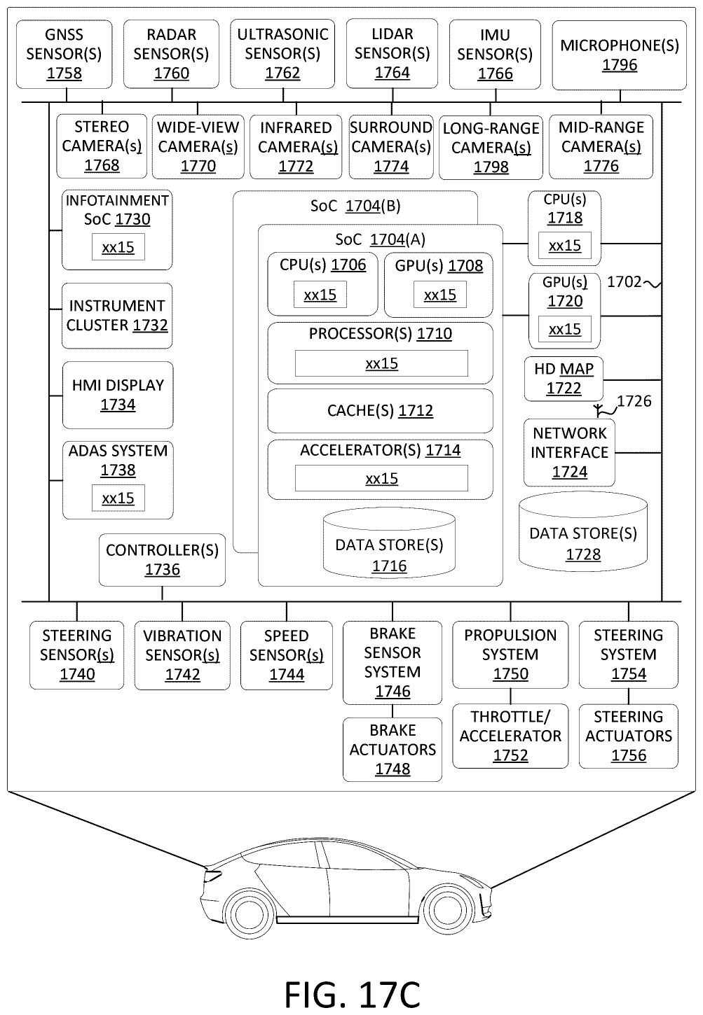

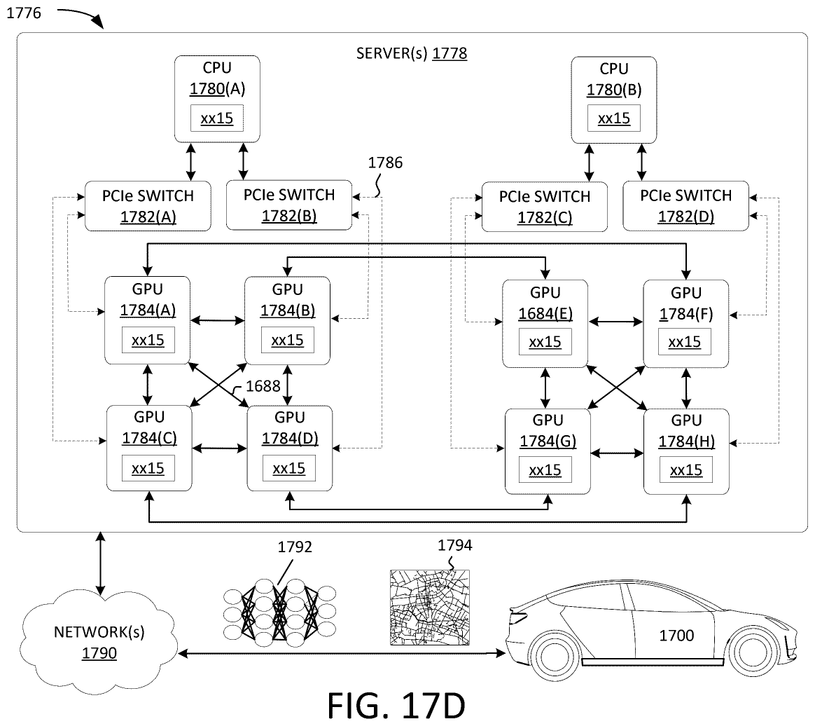

FIG. 17A illustrates an example of an autonomous vehicle 1700, according to at least one embodiment. In at least one embodiment, autonomous vehicle 1700 (alternatively referred to herein as “vehicle 1700”) may be, without limitation, a passenger vehicle, such as a car, a truck, a bus, and/or another type of vehicle that accommodates one or more passengers. In at least one embodiment, vehicle 1700 may be a semi-tractor-trailer truck used for hauling cargo. In at least one embodiment, vehicle 1700 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In one or more embodiments, vehicle 1700 may be capable of functionality in accordance with one or more of level 1-level 5 of autonomous driving levels. For example, in at least one embodiment, vehicle 1700 may be capable of conditional automation (Level 3), high automation (Level 4), and/or full automation (Level 5), depending on embodiment.

In at least one embodiment, vehicle 1700 may include, without limitation, components such as a chassis, a vehicle body, wheels (e.g., 2, 4, 6, 8, 18, etc.), tires, axles, and other components of a vehicle. In at least one embodiment, vehicle 1700 may include, without limitation, a propulsion system 1750, such as an internal combustion engine, hybrid electric power plant, an all-electric engine, and/or another propulsion system type. In at least one embodiment, propulsion system 1750 may be connected to a drive train of vehicle 1700, which may include, without limitation, a transmission, to enable propulsion of vehicle 1700. In at least one embodiment, propulsion system 1750 may be controlled in response to receiving signals from a throttle/accelerator(s) 1752.

In at least one embodiment, a steering system 1754, which may include, without limitation, a steering wheel, is used to steer a vehicle 1700 (e.g., along a desired path or route) when a propulsion system 1750 is operating (e.g., when vehicle is in motion). In at least one embodiment, a steering system 1754 may receive signals from steering actuator(s) 1756. A steering wheel may be optional for full automation (Level 5) functionality. In at least one embodiment, a brake sensor system 1746 may be used to operate vehicle brakes in response to receiving signals from brake actuator(s) 1748 and/or brake sensors.

In at least one embodiment, controller(s) 1736, which may include, without limitation, one or more system on chips (“SoCs”) (not shown in FIG. 17A) and/or graphics processing unit(s) (“GPU(s)”), provide signals (e.g., representative of commands) to one or more components and/or systems of vehicle 1700. For instance, in at least one embodiment, controller(s) 1736 may send signals to operate vehicle brakes via brake actuator(s) 1748, to operate steering system 1754 via steering actuator(s) 1756, and/or to operate propulsion system 1750 via throttle/accelerator(s) 1752. Controller(s) 1736 may include one or more onboard (e.g., integrated) computing devices (e.g., supercomputers) that process sensor signals, and output operation commands (e.g., signals representing commands) to enable autonomous driving and/or to assist a human driver in driving vehicle 1700. In at least one embodiment, controller(s) 1736 may include a first controller 1736 for autonomous driving functions, a second controller 1736 for functional safety functions, a third controller 1736 for artificial intelligence functionality (e.g., computer vision), a fourth controller 1736 for infotainment functionality, a fifth controller 1736 for redundancy in emergency conditions, and/or other controllers. In at least one embodiment, a single controller 1736 may handle two or more of above functionalities, two or more controllers 1736 may handle a single functionality, and/or any combination thereof.

In at least one embodiment, controller(s) 1736 provide signals for controlling one or more components and/or systems of vehicle 1700 in response to sensor data received from one or more sensors (e.g., sensor inputs). In at least one embodiment, sensor data may be received from, for example and without limitation, global navigation satellite systems (“GNSS”) sensor(s) 1758 (e.g., Global Positioning System sensor(s)), RADAR sensor(s) 1760, ultrasonic sensor(s) 1762, LIDAR sensor(s) 1764, inertial measurement unit (“IMU”) sensor(s) 1766 (e.g., accelerometer(s), gyroscope(s), magnetic compass(es), magnetometer(s), etc.), microphone(s) 1796, stereo camera(s) 1768, wide-view camera(s) 1770 (e.g., fisheye cameras), infrared camera(s) 1772, surround camera(s) 1774 (e.g., 360 degree cameras), long-range cameras (not shown in FIG. 17A), mid-range camera(s) (not shown in FIG. 17A), speed sensor(s) 1744 (e.g., for measuring speed of vehicle 1700), vibration sensor(s) 1742, steering sensor(s) 1740, brake sensor(s) (e.g., as part of brake sensor system 1746), and/or other sensor types.

In at least one embodiment, one or more of controller(s) 1736 may receive inputs (e.g., represented by input data) from an instrument cluster 1732 of vehicle 1700 and provide outputs (e.g., represented by output data, display data, etc.) via a human-machine interface (“HMI”) display 1734, an audible annunciator, a loudspeaker, and/or via other components of vehicle 1700. In at least one embodiment, outputs may include information such as vehicle velocity, speed, time, map data (e.g., a High Definition map (not shown in FIG. 17A), location data (e.g., vehicle 1700's location, such as on a map), direction, location of other vehicles (e.g., an occupancy grid), information about objects and status of objects as perceived by controller(s) 1736, etc. For example, in at least one embodiment, HMI display 1734 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1700 further includes a network interface 1724 which may use wireless antenna(s) 1726 and/or modem(s) to communicate over one or more networks. For example, in at least one embodiment, network interface 1724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. In at least one embodiment, wireless antenna(s) 1726 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

Inference and/or training logic are used to perform inferencing and/or training operations associated with one or more embodiments. In at least one embodiment, inference and/or training logic may be used in system FIG. 17A for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

FIG. 17B illustrates an example of camera locations and fields of view for autonomous vehicle 1700 of FIG. 17A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1700.

In at least one embodiment, camera types for cameras may include, but are not limited to, digital cameras that may be adapted for use with components and/or systems of vehicle 1700. In at least one embodiment, one or more of camera(s) may operate at automotive safety integrity level (“ASIL”) B and/or at another ASIL. In at least one embodiment, camera types may be capable of any image capture rate, such as 60 frames per second (fps), 120 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all of cameras) may record and provide image data (e.g., video) simultaneously.

In at least one embodiment, one or more of cameras may be mounted in a mounting assembly, such as a custom designed (three-dimensional (“3D”) printed) assembly, in order to cut out stray light and reflections from within car (e.g., reflections from dashboard reflected in windshield mirrors) which may interfere with camera's image data capture abilities. With reference to wing-mirror mounting assemblies, in at least one embodiment, wing-mirror assemblies may be custom 3D printed so that camera mounting plate matches shape of wing-mirror. In at least one embodiment, camera(s) may be integrated into wing-mirror. For side-view cameras, camera(s) may also be integrated within four pillars at each corner of cab In at least one embodiment.

In at least one embodiment, cameras with a field of view that include portions of environment in front of vehicle 1700 (e.g., front-facing cameras) may be used for surround view, to help identify forward facing paths and obstacles, as well as aid in, with help of one or more of controllers 1736 and/or control SoCs, providing information critical to generating an occupancy grid and/or determining preferred vehicle paths. In at least one embodiment, front-facing cameras may be used to perform many of same ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, wide-view camera 1670 may be used to perceive objects coming into view from periphery (e.g., pedestrians, crossing traffic or bicycles). Although only one wide-view camera 1770 is illustrated in FIG. 17B, in other embodiments, there may be any number (including zero) of wide-view camera(s) 1770 on vehicle 1700. In at least one embodiment, any number of long-range camera(s) 1798 (e.g., a long-view stereo camera pair) may be used for depth-based object detection, especially for objects for which a neural network has not yet been trained. In at least one embodiment, long-range camera(s) 1798 may also be used for object detection and classification, as well as basic object tracking.

In at least one embodiment, any number of stereo camera(s) 1768 may also be included in a front-facing configuration. In at least one embodiment, one or more of stereo camera(s) 1768 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of environment of vehicle 1700, including a distance estimate for all points in image. In at least one embodiment, one or more of stereo camera(s) 1768 may include, without limitation, compact stereo vision sensor(s) that may include, without limitation, two camera lenses (one each on left and right) and an image processing chip that may measure distance from vehicle 1700 to target object and use generated information (e.g., metadata) to activate autonomous emergency braking and lane departure warning functions. In at least one embodiment, other types of stereo camera(s) 1768 may be used in addition to, or alternatively from, those described herein.

In at least one embodiment, cameras with a field of view that include portions of environment to side of vehicle 1700 (e.g., side-view cameras) may be used for surround view, providing information used to create and update occupancy grid, as well as to generate side impact collision warnings. For example, in at least one embodiment, surround camera(s) 1774 (e.g., four surround cameras 1774 as illustrated in FIG. 17B) could be positioned on vehicle 1700. In at least one embodiment, surround camera(s) 1774 may include, without limitation, any number and combination of wide-view camera(s) 1770, fisheye camera(s), 360 degree camera(s), and/or like. For instance, in at least one embodiment, four fisheye cameras may be positioned on front, rear, and sides of vehicle 1700. In at least one embodiment, vehicle 1700 may use three surround camera(s) 1774 (e.g., left, right, and rear), and may leverage one or more other camera(s) (e.g., a forward-facing camera) as a fourth surround-view camera.

In at least one embodiment, cameras with a field of view that include portions of environment to rear of vehicle 1700 (e.g., rear-view cameras) may be used for park assistance, surround view, rear collision warnings, and creating and updating occupancy grid. In at least one embodiment, a wide variety of cameras may be used including, but not limited to, cameras that are also suitable as a front-facing camera(s) (e.g., long-range cameras 1798 and/or mid-range camera(s) 1776, stereo camera(s) 1768), infrared camera(s) 1772, etc.), as described herein.

Inference and/or training logic are used to perform inferencing and/or training operations associated with one or more embodiments. Details regarding inference and/or training logic are provided herein. In at least one embodiment, inference and/or training logic may be used in system FIG. 17B for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

FIG. 17C is a block diagram illustrating an example system architecture for autonomous vehicle 1700 of FIG. 17A, according to at least one embodiment. In at least one embodiment, each of components, features, and systems of vehicle 1700 in FIG. 17C are illustrated as being connected via a bus 1702. In at least one embodiment, bus 1702 may include, without limitation, a CAN data interface (alternatively referred to herein as a “CAN bus”). In at least one embodiment, a CAN bus may be a network inside vehicle 1700 used to aid in control of various features and functionality of vehicle 1700, such as actuation of brakes, acceleration, braking, steering, windshield wipers, etc. In at least one embodiment, bus 1702 may be configured to have dozens or even hundreds of nodes, each with its own unique identifier (e.g., a CAN ID). In at least one embodiment, bus 1702 may be read to find steering wheel angle, ground speed, engine revolutions per minute (“RPMs”), button positions, and/or other vehicle status indicators. In at least one embodiment, bus 1702 may be a CAN bus that is ASIL B compliant.

In at least one embodiment, in addition to, or alternatively from CAN, FlexRay and/or Ethernet may be used. In at least one embodiment, there may be any number of busses 1702, which may include, without limitation, zero or more CAN busses, zero or more FlexRay busses, zero or more Ethernet busses, and/or zero or more other types of busses using a different protocol. In at least one embodiment, two or more busses 1702 may be used to perform different functions, and/or may be used for redundancy. For example, a first bus 1702 may be used for collision avoidance functionality and a second bus 1702 may be used for actuation control. In at least one embodiment, each bus 1702 may communicate with any of components of vehicle 1700, and two or more busses 1702 may communicate with same components. In at least one embodiment, each of any number of system(s) on chip(s) (“SoC(s)”) 1704, each of controller(s) 1736, and/or each computer within vehicle may have access to same input data (e.g., inputs from sensors of vehicle 1700), and may be connected to a common bus, such CAN bus.

In at least one embodiment, vehicle 1700 may include one or more controller(s) 1736, such as those described herein with respect to FIG. 17A. Controller(s) 1736 may be used for a variety of functions. In at least one embodiment, controller(s) 1736 may be coupled to any of various other components and systems of vehicle 1700, and may be used for control of vehicle 1700, artificial intelligence of vehicle 1700, infotainment for vehicle 1700, and/or like.

In at least one embodiment, vehicle 1700 may include any number of SoCs 1704. Each of SoCs 1704 may include, without limitation, central processing units (“CPU(s)”) 1706, graphics processing units (“GPU(s)”) 1708, processor(s) 1710, cache(s) 1712, accelerator(s) 1714, data store(s) 1716, and/or other components and features not illustrated. In at least one embodiment, SoC(s) 1704 may be used to control vehicle 1700 in a variety of platforms and systems. For example, in at least one embodiment, SoC(s) 1704 may be combined in a system (e.g., system of vehicle 1700) with a High Definition (“HD”) map 1722 which may obtain map refreshes and/or updates via network interface 1724 from one or more servers (not shown in FIG. 17C).

In at least one embodiment, CPU(s) 1706 may include a CPU cluster or CPU complex (alternatively referred to herein as a “CCPLEX”). In at least one embodiment, CPU(s) 1706 may include multiple cores and/or level two (“L2”) caches. For instance, in at least one embodiment, CPU(s) 1706 may include eight cores in a coherent multi-processor configuration. In at least one embodiment, CPU(s) 1706 may include four dual-core clusters where each cluster has a dedicated L2 cache (e.g., a 2 MB L2 cache). In at least one embodiment, CPU(s) 1706 (e.g., CCPLEX) may be configured to support simultaneous cluster operation enabling any combination of clusters of CPU(s) 1706 to be active at any given time.

In at least one embodiment, one or more of CPU(s) 1706 may implement power management capabilities that include, without limitation, one or more of following features: individual hardware blocks may be clock-gated automatically when idle to save dynamic power; each core clock may be gated when core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1706 may further implement an enhanced algorithm for managing power states, where allowed power states and expected wakeup times are specified, and hardware/microcode determines best power state to enter for core, cluster, and CCPLEX. In at least one embodiment, processing cores may support simplified power state entry sequences in software with work offloaded to microcode.

In at least one embodiment, GPU(s) 1708 may include an integrated GPU (alternatively referred to herein as an “iGPU”). In at least one embodiment, GPU(s) 1708 may be programmable and may be efficient for parallel workloads. In at least one embodiment, GPU(s) 1708, in at least one embodiment, may use an enhanced tensor instruction set. In at least one embodiment, GPU(s) 1708 may include one or more streaming microprocessors, where each streaming microprocessor may include a level one (“L1”) cache (e.g., an L1 cache with at least 96 KB storage capacity), and two or more of streaming microprocessors may share an L2 cache (e.g., an L2 cache with a 512 KB storage capacity). In at least one embodiment, GPU(s) 1708 may include at least eight streaming microprocessors. In at least one embodiment, GPU(s) 1708 may use compute application programming interface(s) (API(s)). In at least one embodiment, GPU(s) 1708 may use one or more parallel computing platforms and/or programming models (e.g., NVIDIA's CUDA).

In at least one embodiment, one or more of GPU(s) 1708 may be power-optimized for best performance in automotive and embedded use cases. For example, in on embodiment, GPU(s) 1708 could be fabricated on a Fin field-effect transistor (“FinFET”). In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 17 FP32 cores, 8 FP64 cores, 17 INT32 cores, two mixed-precision NVIDIA TENSOR COREs for deep learning matrix arithmetic, a level zero (“L0”) instruction cache, a warp scheduler, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 1708 may include a high bandwidth memory (“HBM) and/or a 17 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1708 may include unified memory technology. In at least one embodiment, address translation services (“ATS”) support may be used to allow GPU(s) 1708 to access CPU(s) 1706 page tables directly. In at least one embodiment, embodiment, when GPU(s) 1608 memory management unit (“MMU”) experiences a miss, an address translation request may be transmitted to CPU(s) 1706. In response, CPU(s) 1706 may look in its page tables for virtual-to-physical mapping for address and transmits translation back to GPU(s) 1708, in at least one embodiment. In at least one embodiment, unified memory technology may allow a single unified virtual address space for memory of both CPU(s) 1706 and GPU(s) 1708, thereby simplifying GPU(s) 1708 programming and porting of applications to GPU(s) 1708.

In at least one embodiment, GPU(s) 1708 may include any number of access counters that may keep track of frequency of access of GPU(s) 1708 to memory of other processors. In at least one embodiment, access counter(s) may help ensure that memory pages are moved to physical memory of processor that is accessing pages most frequently, thereby improving efficiency for memory ranges shared between processors.

In at least one embodiment, one or more of SoC(s) 1704 may include any number of cache(s) 1712, including those described herein. For example, in at least one embodiment, cache(s) 1712 could include a level three (“L3”) cache that is available to both CPU(s) 1706 and GPU(s) 1708 (e.g., that is connected both CPU(s) 1706 and GPU(s) 1708). In at least one embodiment, cache(s) 1712 may include a write-back cache that may keep track of states of lines, such as by using a cache coherence protocol (e.g., MEI, MESI, MSI, etc.). In at least one embodiment, L3 cache may include 4 MB or more, depending on embodiment, although smaller cache sizes may be used.

In at least one embodiment, one or more of SoC(s) 1704 may include one or more accelerator(s) 1714 (e.g., hardware accelerators, software accelerators, or a combination thereof). In at least one embodiment, SoC(s) 1704 may include a hardware acceleration cluster that may include optimized hardware accelerators and/or large on-chip memory. In at least one embodiment, large on-chip memory (e.g., 4 MB of SRAM), may enable hardware acceleration cluster to accelerate neural networks and other calculations. In at least one embodiment, hardware acceleration cluster may be used to complement GPU(s) 1708 and to off-load some of tasks of GPU(s) 1708 (e.g., to free up more cycles of GPU(s) 1708 for performing other tasks). In at least one embodiment, accelerator(s) 1714 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1714 (e.g., hardware acceleration cluster) may include a deep learning accelerator(s) (“DLA(s)”). DLA(s) may include, without limitation, one or more Tensor processing units (“TPU(s)”) that may be configured to provide an additional ten trillion operations per second for deep learning applications and inferencing. In at least one embodiment, TPU(s) may be accelerators configured to, and optimized for, performing image processing functions (e.g., for CNNs, RCNNs, etc.). DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones 1796; a CNN for facial recognition and vehicle owner identification using data from camera sensors; and/or a CNN for security and/or safety related events.

In at least one embodiment, DLA(s) may perform any function of GPU(s) 1708, and by using an inference accelerator, for example, a designer may target either DLA(s) or GPU(s) 1708 for any function. For example, in at least one embodiment, designer may focus processing of CNNs and floating point operations on DLA(s) and leave other functions to GPU(s) 1708 and/or other accelerator(s) 1714.

In at least one embodiment, accelerator(s) 1714 (e.g., hardware acceleration cluster) may include a programmable vision accelerator(s) (“PVA”), which may alternatively be referred to herein as a computer vision accelerator. In at least one embodiment, PVA(s) may be designed and configured to accelerate computer vision algorithms for advanced driver assistance system (“ADAS”) 1738, autonomous driving, augmented reality (“AR”) applications, and/or virtual reality (“VR”) applications. PVA(s) may provide a balance between performance and flexibility. For example, in at least one embodiment, each PVA(s) may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any of cameras described herein), image signal processor(s), and/or like. In at least one embodiment, each of RISC cores may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA(s) to access system memory independently of CPU(s) 1706. In at least one embodiment, DMA may support any number of features used to provide optimization to PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, PVA may include a PVA core and two vector processing subsystem partitions. In at least one embodiment, PVA core may include a processor subsystem, DMA engine(s) (e.g., two DMA engines), and/or other peripherals. In at least one embodiment, vector processing subsystem may operate as primary processing engine of PVA, and may include a vector processing unit (“VPU”), an instruction cache, and/or vector memory (e.g., “VMEM”). In at least one embodiment, VPU may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute same computer vision algorithm, but on different regions of an image. In at least one embodiment, vector processors included in a particular PVA may simultaneously execute different computer vision algorithms, on same image, or even execute different algorithms on sequential images or portions of an image. In at least one embodiment, among other things, any number of PVAs may be included in hardware acceleration cluster and any number of vector processors may be included in each of PVAs. In at least one embodiment, PVA(s) may include additional error correcting code (“ECC”) memory, to enhance overall system safety.

In at least one embodiment, accelerator(s) 1714 (e.g., hardware acceleration cluster) may include a computer vision network on-chip and static random-access memory (“SRAM”), for providing a high-bandwidth, low latency SRAM for accelerator(s) 1714. In at least one embodiment, on-chip memory may include at least 4 MB SRAM, consisting of, for example and without limitation, eight field-configurable memory blocks, that may be accessible by both PVA and DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, PVA and DLA may access memory via a backbone that provides PVA and DLA with high-speed access to memory. In at least one embodiment, backbone may include a computer vision network on-chip that interconnects PVA and DLA to memory (e.g., using APB).

In at least one embodiment, computer vision network on-chip may include an interface that determines, before transmission of any control signal/address/data, that both PVA and DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1704 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1714 (e.g., hardware accelerator cluster) have a wide array of uses for autonomous driving. In at least one embodiment, PVA may be a programmable vision accelerator that may be used for key processing stages in ADAS and autonomous vehicles. In at least one embodiment, PVA's capabilities are a good match for algorithmic domains needing predictable processing, at low power and low latency. In other words, PVA performs well on semi-dense or dense regular computation, even on small data sets, which need predictable run-times with low latency and low power. In at least one embodiment, autonomous vehicles, such as vehicle 1700, PVAs are designed to run classic computer vision algorithms, as they are efficient at object detection and operating on integer math.

For example, according to at least one embodiment of technology, PVA is used to perform computer stereo vision. In at least one embodiment, semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, PVA may perform computer stereo vision function on inputs from two monocular cameras.

In at least one embodiment, PVA may be used to perform dense optical flow. For example, in at least one embodiment, PVA could process raw RADAR data (e.g., using a 4D Fast Fourier Transform) to provide processed RADAR data. In at least one embodiment, PVA is used for time of flight depth processing, by processing raw time of flight data to provide processed time of flight data, for example.

In at least one embodiment, DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, confidence enables a system to make further decisions regarding which detections should be considered as true positive detections rather than false positive detections. For example, in at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, DLA may run a neural network for regressing confidence value. In at least one embodiment, neural network may take as its input at least some subset of parameters, such as bounding box dimensions, ground plane estimate obtained (e.g. from another subsystem), output from IMU sensor(s) 1766 that correlates with vehicle 1700 orientation, distance, 3D location estimates of object obtained from neural network and/or other sensors (e.g., LIDAR sensor(s) 1764 or RADAR sensor(s) 1760), among others.

In at least one embodiment, one or more of SoC(s) 1704 may include data store(s) 1716 (e.g., memory). In at least one embodiment, data store(s) 1716 may be on-chip memory of SoC(s) 1704, which may store neural networks to be executed on GPU(s) 1708 and/or DLA. In at least one embodiment, data store(s) 1716 may be large enough in capacity to store multiple instances of neural networks for redundancy and safety. In at least one embodiment, data store(s) 1716 may comprise L2 or L3 cache(s).

In at least one embodiment, one or more of SoC(s) 1704 may include any number of processor(s) 1710 (e.g., embedded processors). In at least one embodiment, processor(s) 1710 may include a boot and power management processor that may be a dedicated processor and subsystem to handle boot power and management functions and related security enforcement. In at least one embodiment, boot and power management processor may be a part of SoC(s) 1704 boot sequence and may provide runtime power management services. In at least one embodiment, boot power and management processor may provide clock and voltage programming, assistance in system low power state transitions, management of SoC(s) 1704 thermals and temperature sensors, and/or management of SoC(s) 1704 power states. In at least one embodiment, each temperature sensor may be implemented as a ring-oscillator whose output frequency is proportional to temperature, and SoC(s) 1704 may use ring-oscillators to detect temperatures of CPU(s) 1706, GPU(s) 1708, and/or accelerator(s) 1714. In at least one embodiment, if temperatures are determined to exceed a threshold, then boot and power management processor may enter a temperature fault routine and put SoC(s) 1704 into a lower power state and/or put vehicle 1700 into a chauffeur to safe stop mode (e.g., bring vehicle 1700 to a safe stop).

In at least one embodiment, processor(s) 1710 may further include a set of embedded processors that may serve as an audio processing engine. In at least one embodiment, audio processing engine may be an audio subsystem that enables full hardware support for multi-channel audio over multiple interfaces, and a broad and flexible range of audio I/O interfaces. In at least one embodiment, audio processing engine is a dedicated processor core with a digital signal processor with dedicated RAM.

In at least one embodiment, processor(s) 1710 may further include an always on processor engine that may provide necessary hardware features to support low power sensor management and wake use cases. In at least one embodiment, always on processor engine may include, without limitation, a processor core, a tightly coupled RAM, supporting peripherals (e.g., timers and interrupt controllers), various I/O controller peripherals, and routing logic.

In at least one embodiment, processor(s) 1710 may further include a safety cluster engine that includes, without limitation, a dedicated processor subsystem to handle safety management for automotive applications. In at least one embodiment, safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1710 may further include a real-time camera engine that may include, without limitation, a dedicated processor subsystem for handling real-time camera management. In at least one embodiment, processor(s) 1710 may further include a high-dynamic range signal processor that may include, without limitation, an image signal processor that is a hardware engine that is part of camera processing pipeline.

In at least one embodiment, processor(s) 1710 may include a video image compositor that may be a processing block (e.g., implemented on a microprocessor) that implements video post-processing functions needed by a video playback application to produce final image for player window. In at least one embodiment, video image compositor may perform lens distortion correction on wide-view camera(s) 1770, surround camera(s) 1774, and/or on in-cabin monitoring camera sensor(s). In at least one embodiment, in-cabin monitoring camera sensor(s) are preferably monitored by a neural network running on another instance of SoC(s) 1704, configured to identify in cabin events and respond accordingly. In at least one embodiment, an in-cabin system may perform, without limitation, lip reading to activate cellular service and place a phone call, dictate emails, change vehicle's destination, activate or change vehicle's infotainment system and settings, or provide voice-activated web surfing. In at least one embodiment, certain functions are available to driver when vehicle is operating in an autonomous mode and are disabled otherwise.

In at least one embodiment, video image compositor may include enhanced temporal noise reduction for both spatial and temporal noise reduction. For example, in at least one embodiment, where motion occurs in a video, noise reduction weights spatial information appropriately, decreasing weight of information provided by adjacent frames. In at least one embodiment, where an image or portion of an image does not include motion, temporal noise reduction performed by video image compositor may use information from previous image to reduce noise in current image.

In at least one embodiment, video image compositor may also be configured to perform stereo rectification on input stereo lens frames. In at least one embodiment, video image compositor may further be used for user interface composition when operating system desktop is in use, and GPU(s) 1708 are not required to continuously render new surfaces. In at least one embodiment, when GPU(s) 1708 are powered on and active doing 3D rendering, video image compositor may be used to offload GPU(s) 1708 to improve performance and responsiveness.

In at least one embodiment, one or more of SoC(s) 1704 may further include a mobile industry processor interface (“MIPI”) camera serial interface for receiving video and input from cameras, a high-speed interface, and/or a video input block that may be used for camera and related pixel input functions. In at least one embodiment, one or more of SoC(s) 1704 may further include an input/output controller(s) that may be controlled by software and may be used for receiving I/O signals that are uncommitted to a specific role.

In at least one embodiment, one or more of SoC(s) 1604 may further include a broad range of peripheral interfaces to enable communication with peripherals, audio encoders/decoders (“codecs”), power management, and/or other devices. SoC(s) 1704 may be used to process data from cameras (e.g., connected over Gigabit Multimedia Serial Link and Ethernet), sensors (e.g., LIDAR sensor(s) 1764, RADAR sensor(s) 1760, etc. that may be connected over Ethernet), data from bus 1702 (e.g., speed of vehicle 1700, steering wheel position, etc.), data from GNSS sensor(s) 1758 (e.g., connected over Ethernet or CAN bus), etc. In at least one embodiment, one or more of SoC(s) 1704 may further include dedicated high-performance mass storage controllers that may include their own DMA engines, and that may be used to free CPU(s) 1706 from routine data management tasks.

In at least one embodiment, SoC(s) 1704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. In at least one embodiment, SoC(s) 1704 may be faster, more reliable, and even more energy-efficient and space-efficient than conventional systems. For example, in at least one embodiment, accelerator(s) 1714, when combined with CPU(s) 1706, GPU(s) 1708, and data store(s) 1716, may provide for a fast, efficient platform for level 3-5 autonomous vehicles.

In at least one embodiment, computer vision algorithms may be executed on CPUs, which may be configured using high-level programming language, such as C programming language, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on DLA or discrete GPU (e.g., GPU(s) 1720) may include text and word recognition, allowing supercomputer to read and understand traffic signs, including signs for which neural network has not been specifically trained. In at least one embodiment, DLA may further include a neural network that is able to identify, interpret, and provide semantic understanding of sign, and to pass that semantic understanding to path planning modules running on CPU Complex.

In at least one embodiment, multiple neural networks may be run simultaneously, as for Level 3, 4, or 5 driving. For example, in at least one embodiment, a warning sign consisting of “Caution: flashing lights indicate icy conditions,” along with an electric light, may be independently or collectively interpreted by several neural networks. In at least one embodiment, a sign itself may be identified as a traffic sign by a first deployed neural network (e.g., a neural network that has been trained) and a text “flashing lights indicate icy conditions” may be interpreted by a second deployed neural network, which informs vehicle's path planning software (preferably executing on CPU Complex) that when flashing lights are detected, icy conditions exist. In at least one embodiment, a flashing light may be identified by operating a third deployed neural network over multiple frames, informing vehicle's path-planning software of presence (or absence) of flashing lights. In at least one embodiment, all three neural networks may run simultaneously, such as within DLA and/or on GPU(s) 1708.

In at least one embodiment, a CNN for facial recognition and vehicle owner identification may use data from camera sensors to identify presence of an authorized driver and/or owner of vehicle 1700. In at least one embodiment, an always on sensor processing engine may be used to unlock vehicle when owner approaches driver door and turn on lights, and, in security mode, to disable vehicle when owner leaves vehicle. In this way, SoC(s) 1704 provide for security against theft and/or carjacking.

In at least one embodiment, a CNN for emergency vehicle detection and identification may use data from microphones 1796 to detect and identify emergency vehicle sirens. In at least one embodiment, SoC(s) 1704 use CNN for classifying environmental and urban sounds, as well as classifying visual data. In at least one embodiment, CNN running on DLA is trained to identify relative closing speed of emergency vehicle (e.g., by using Doppler effect). In at least one embodiment, CNN may also be trained to identify emergency vehicles specific to local area in which vehicle is operating, as identified by GNSS sensor(s) 1758. In at least one embodiment, when operating in Europe, CNN will seek to detect European sirens, and when in United States CNN will seek to identify only North American sirens. In at least one embodiment, once an emergency vehicle is detected, a control program may be used to execute an emergency vehicle safety routine, slowing vehicle, pulling over to side of road, parking vehicle, and/or idling vehicle, with assistance of ultrasonic sensor(s) 1762, until emergency vehicle(s) passes.

In at least one embodiment, vehicle 1700 may include CPU(s) 1718 (e.g., discrete CPU(s), or dCPU(s)), that may be coupled to SoC(s) 1704 via a high-speed interconnect (e.g., PCIe). In at least one embodiment, CPU(s) 1718 may include an X86 processor, for example. CPU(s) 1618 may be used to perform any of a variety of functions, including arbitrating potentially inconsistent results between ADAS sensors and SoC(s) 1704, and/or monitoring status and health of controller(s) 1736 and/or an infotainment system on a chip (“infotainment SoC”) 1730, for example.

In at least one embodiment, vehicle 1700 may include GPU(s) 1720 (e.g., discrete GPU(s), or dGPU(s)), that may be coupled to SoC(s) 1704 via a high-speed interconnect (e.g., NVIDIA's NVLINK). In at least one embodiment, GPU(s) 1720 may provide additional artificial intelligence functionality, such as by executing redundant and/or different neural networks, and may be used to train and/or update neural networks based at least in part on input (e.g., sensor data) from sensors of vehicle 1700.

In at least one embodiment, vehicle 1700 may further include network interface 1724 which may include, without limitation, wireless antenna(s) 1726 (e.g., one or more wireless antennas 1726 for different communication protocols, such as a cellular antenna, a Bluetooth antenna, etc.). In at least one embodiment, network interface 1724 may be used to enable wireless connectivity over Internet with cloud (e.g., with server(s) and/or other network devices), with other vehicles, and/or with computing devices (e.g., client devices of passengers). In at least one embodiment, to communicate with other vehicles, a direct link may be established between vehicle 1700 and other vehicle and/or an indirect link may be established (e.g., across networks and over Internet). In at least one embodiment, direct links may be provided using a vehicle-to-vehicle communication link. vehicle-to-vehicle communication link may provide vehicle 1700 information about vehicles in proximity to vehicle 1700 (e.g., vehicles in front of, on side of, and/or behind vehicle 1700). In at least one embodiment, aforementioned functionality may be part of a cooperative adaptive cruise control functionality of vehicle 1700.

In at least one embodiment, network interface 1724 may include a SoC that provides modulation and demodulation functionality and enables controller(s) 1736 to communicate over wireless networks. In at least one embodiment, network interface 1724 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

In at least one embodiment, vehicle 1700 may further include data store(s) 1728 which may include, without limitation, off-chip (e.g., off SoC(s) 1704) storage. In at least one embodiment, data store(s) 1728 may include, without limitation, one or more storage elements including RAM, SRAM, dynamic random-access memory (“DRAM”), video random-access memory (“VRAM”), Flash, hard disks, and/or other components and/or devices that may store at least one bit of data.

In at least one embodiment, vehicle 1700 may further include GNSS sensor(s) 1758 (e.g., GPS and/or assisted GPS sensors), to assist in mapping, perception, occupancy grid generation, and/or path planning functions. In at least one embodiment, any number of GNSS sensor(s) 1758 may be used, including, for example and without limitation, a GPS using a USB connector with an Ethernet to Serial (e.g., RS-232) bridge.

In at least one embodiment, vehicle 1700 may further include RADAR sensor(s) 1760. RADAR sensor(s) 1760 may be used by vehicle 1700 for long-range vehicle detection, even in darkness and/or severe weather conditions. In at least one embodiment, RADAR functional safety levels may be ASIL B. RADAR sensor(s) 1760 may use CAN and/or bus 1702 (e.g., to transmit data generated by RADAR sensor(s) 1760) for control and to access object tracking data, with access to Ethernet to access raw data in some examples. In at least one embodiment, wide variety of RADAR sensor types may be used. For example, and without limitation, RADAR sensor(s) 1760 may be suitable for front, rear, and side RADAR use. In at least one embodiment, one or more of RADAR sensors(s) 1760 are Pulse Doppler RADAR sensor(s).

In at least one embodiment, RADAR sensor(s) 1760 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m range. In at least one embodiment, RADAR sensor(s) 1760 may help in distinguishing between static and moving objects, and may be used by ADAS system 1738 for emergency brake assist and forward collision warning. Sensors 1760 (s) included in a long-range RADAR system may include, without limitation, monostatic multimodal RADAR with multiple (e.g., six or more) fixed RADAR antennae and a high-speed CAN and FlexRay interface. In at least one embodiment, with six antennae, central four antennae may create a focused beam pattern, designed to record vehicle 1700's surroundings at higher speeds with minimal interference from traffic in adjacent lanes. In at least one embodiment, other two antennae may expand field of view, making it possible to quickly detect vehicles entering or leaving vehicle 1700's lane.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1760 designed to be installed at both ends of rear bumper. When installed at both ends of rear bumper, in at least one embodiment, a RADAR sensor system may create two beams that constantly monitor blind spot in rear and next to vehicle. In at least one embodiment, short-range RADAR systems may be used in ADAS system 1738 for blind spot detection and/or lane change assist.

In at least one embodiment, vehicle 1700 may further include ultrasonic sensor(s) 1762. Ultrasonic sensor(s) 1762, which may be positioned at front, back, and/or sides of vehicle 1700, may be used for park assist and/or to create and update an occupancy grid. In at least one embodiment, a wide variety of ultrasonic sensor(s) 1762 may be used, and different ultrasonic sensor(s) 1762 may be used for different ranges of detection (e.g., 2.5 m, 4 m). In at least one embodiment, ultrasonic sensor(s) 1762 may operate at functional safety levels of ASIL B.

In at least one embodiment, vehicle 1700 may include LIDAR sensor(s) 1764. LIDAR sensor(s) 1764 may be used for object and pedestrian detection, emergency braking, collision avoidance, and/or other functions. In at least one embodiment, LIDAR sensor(s) 1764 may be functional safety level ASIL B. In at least one embodiment, vehicle 1700 may include multiple LIDAR sensors 1764 (e.g., two, four, six, etc.) that may use Ethernet (e.g., to provide data to a Gigabit Ethernet switch).

In at least one embodiment, LIDAR sensor(s) 1764 may be capable of providing a list of objects and their distances for a 360-degree field of view. In at least one embodiment, commercially available LIDAR sensor(s) 1764 may have an advertised range of approximately 100 m, with an accuracy of 2 cm-3 cm, and with support for a 100 Mbps Ethernet connection, for example. In at least one embodiment, one or more non-protruding LIDAR sensors 1764 may be used. In such an embodiment, LIDAR sensor(s) 1764 may be implemented as a small device that may be embedded into front, rear, sides, and/or corners of vehicle 1700. In at least one embodiment, LIDAR sensor(s) 1764, in such an embodiment, may provide up to a 120-degree horizontal and 35-degree vertical field-of-view, with a 200 m range even for low-reflectivity objects. In at least one embodiment, front-mounted LIDAR sensor(s) 1764 may be configured for a horizontal field of view between 45 degrees and 135 degrees.

In at least one embodiment, LIDAR technologies, such as 3D flash LIDAR, may also be used. 3D Flash LIDAR uses a flash of a laser as a transmission source, to illuminate surroundings of vehicle 1700 up to approximately 200 m. In at least one embodiment, a flash LIDAR unit includes, without limitation, a receptor, which records laser pulse transit time and reflected light on each pixel, which in turn corresponds to range from vehicle 1700 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1700. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device(s) may use a 5 nanosecond class I (eye-safe) laser pulse per frame and may capture reflected laser light in form of 3D range point clouds and co-registered intensity data.

In at least one embodiment, vehicle may further include IMU sensor(s) 1766. In at least one embodiment, IMU sensor(s) 1766 may be located at a center of rear axle of vehicle 1700, in at least one embodiment. In at least one embodiment, IMU sensor(s) 1766 may include, for example and without limitation, accelerometer(s), magnetometer(s), gyroscope(s), magnetic compass(es), and/or other sensor types. In at least one embodiment, such as in six-axis applications, IMU sensor(s) 1766 may include, without limitation, accelerometers and gyroscopes. In at least one embodiment, such as in nine-axis applications, IMU sensor(s) 1766 may include, without limitation, accelerometers, gyroscopes, and magnetometers.

In at least one embodiment, IMU sensor(s) 1766 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1766 may enable vehicle 1700 to estimate heading without requiring input from a magnetic sensor by directly observing and correlating changes in velocity from GPS to IMU sensor(s) 1766. In at least one embodiment, IMU sensor(s) 1766 and GNSS sensor(s) 1758 may be combined in a single integrated unit.

In at least one embodiment, vehicle 1700 may include microphone(s) 1796 placed in and/or around vehicle 1700. In at least one embodiment, microphone(s) 1796 may be used for emergency vehicle detection and identification, among other things.

In at least one embodiment, vehicle 1700 may further include any number of camera types, including stereo camera(s) 1768, wide-view camera(s) 1770, infrared camera(s) 1772, surround camera(s) 1774, long-range camera(s) 1798, mid-range camera(s) 1776, and/or other camera types. In at least one embodiment, cameras may be used to capture image data around an entire periphery of vehicle 1700. In at least one embodiment, types of cameras used depends on vehicle 1700. In at least one embodiment, any combination of camera types may be used to provide necessary coverage around vehicle 1700. In at least one embodiment, number of cameras may differ depending on embodiment. For example, in at least one embodiment, vehicle 1700 could include six cameras, seven cameras, ten cameras, twelve cameras, or another number of cameras. Cameras may support, as an example and without limitation, Gigabit Multimedia Serial Link (“GMSL”) and/or Gigabit Ethernet. In at least one embodiment, each of camera(s) is described with more detail previously herein with respect to FIG. 17A and FIG. 17B.

In at least one embodiment, vehicle 1700 may further include vibration sensor(s) 1742. In at least one embodiment, vibration sensor(s) 1742 may measure vibrations of components of vehicle 1700, such as axle(s). For example, in at least one embodiment, changes in vibrations may indicate a change in road surfaces. In at least one embodiment, when two or more vibration sensors 1742 are used, differences between vibrations may be used to determine friction or slippage of road surface (e.g., when difference in vibration is between a power-driven axle and a freely rotating axle).

In at least one embodiment, vehicle 1700 may include ADAS system 1738. ADAS system 1738 may include, without limitation, a SoC, in some examples. In at least one embodiment, ADAS system 1738 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1760, LIDAR sensor(s) 1764, and/or any number of camera(s). In at least one embodiment, ACC system may include a longitudinal ACC system and/or a lateral ACC system. In at least one embodiment, longitudinal ACC system monitors and controls distance to vehicle immediately ahead of vehicle 1700 and automatically adjust speed of vehicle 1700 to maintain a safe distance from vehicles ahead. In at least one embodiment, lateral ACC system performs distance keeping, and advises vehicle 1700 to change lanes when necessary. In at least one embodiment, lateral ACC is related to other ADAS applications such as LC and CW.

In at least one embodiment, CACC system uses information from other vehicles that may be received via network interface 1724 and/or wireless antenna(s) 1726 from other vehicles via a wireless link, or indirectly, over a network connection (e.g., over Internet). In at least one embodiment, direct links may be provided by a vehicle-to-vehicle (“V2V”) communication link, while indirect links may be provided by an infrastructure-to-vehicle (“I2V”) communication link. In general, V2V communication concept provides information about immediately preceding vehicles (e.g., vehicles immediately ahead of and in same lane as vehicle 1700), while I2V communication concept provides information about traffic further ahead. In at least one embodiment, CACC system may include either or both I2V and V2V information sources. In at least one embodiment, given information of vehicles ahead of vehicle 1700, CACC system may be more reliable and it has potential to improve traffic flow smoothness and reduce congestion on road.

In at least one embodiment, FCW system is designed to alert driver to a hazard, so that driver may take corrective action. In at least one embodiment, FCW system uses a front-facing camera and/or RADAR sensor(s) 1760, coupled to a dedicated processor, DSP, FPGA, and/or ASIC, that is electrically coupled to driver feedback, such as a display, speaker, and/or vibrating component. In at least one embodiment, FCW system may provide a warning, such as in form of a sound, visual warning, vibration and/or a quick brake pulse.

In at least one embodiment, AEB system detects an impending forward collision with another vehicle or other object, and may automatically apply brakes if driver does not take corrective action within a specified time or distance parameter. In at least one embodiment, AEB system may use front-facing camera(s) and/or RADAR sensor(s) 1760, coupled to a dedicated processor, DSP, FPGA, and/or ASIC. In at least one embodiment, when AEB system detects a hazard, AEB system typically first alerts driver to take corrective action to avoid collision and, if driver does not take corrective action, AEB system may automatically apply brakes in an effort to prevent, or at least mitigate, impact of predicted collision. In at least one embodiment, AEB system, may include techniques such as dynamic brake support and/or crash imminent braking.

In at least one embodiment, LDW system provides visual, audible, and/or tactile warnings, such as steering wheel or seat vibrations, to alert driver when vehicle 1700 crosses lane markings. In at least one embodiment, LDW system does not activate when driver indicates an intentional lane departure, by activating a turn signal. In at least one embodiment, LDW system may use front-side facing cameras, coupled to a dedicated processor, DSP, FPGA, and/or ASIC, that is electrically coupled to driver feedback, such as a display, speaker, and/or vibrating component. In at least one embodiment, LKA system is a variation of LDW system. LKA system provides steering input or braking to correct vehicle 1700 if vehicle 1700 starts to exit lane.

In at least one embodiment, BSW system detects and warns driver of vehicles in an automobile's blind spot. In at least one embodiment, BSW system may provide a visual, audible, and/or tactile alert to indicate that merging or changing lanes is unsafe. In at least one embodiment, BSW system may provide an additional warning when driver uses a turn signal. In at least one embodiment, BSW system may use rear-side facing camera(s) and/or RADAR sensor(s) 1760, coupled to a dedicated processor, DSP, FPGA, and/or ASIC, that is electrically coupled to driver feedback, such as a display, speaker, and/or vibrating component.

In at least one embodiment, RCTW system may provide visual, audible, and/or tactile notification when an object is detected outside rear-camera range when vehicle 1700 is backing up. In at least one embodiment, RCTW system includes AEB system to ensure that vehicle brakes are applied to avoid a crash. In at least one embodiment, RCTW system may use one or more rear-facing RADAR sensor(s) 1760, coupled to a dedicated processor, DSP, FPGA, and/or ASIC, that is electrically coupled to driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert driver and allow driver to decide whether a safety condition truly exists and act accordingly. In at least one embodiment, vehicle 1700 itself decides, in case of conflicting results, whether to heed result from a primary computer or a secondary computer (e.g., first controller 1736 or second controller 1736). For example, in at least one embodiment, ADAS system 1738 may be a backup and/or secondary computer for providing perception information to a backup computer rationality module. In at least one embodiment, backup computer rationality monitor may run a redundant diverse software on hardware components to detect faults in perception and dynamic driving tasks. In at least one embodiment, outputs from ADAS system 1738 may be provided to a supervisory MCU. In at least one embodiment, if outputs from primary computer and secondary computer conflict, supervisory MCU determines how to reconcile conflict to ensure safe operation.

In at least one embodiment, primary computer may be configured to provide supervisory MCU with a confidence score, indicating primary computer's confidence in chosen result. In at least one embodiment, if confidence score exceeds a threshold, supervisory MCU may follow primary computer's direction, regardless of whether secondary computer provides a conflicting or inconsistent result. In at least one embodiment, where confidence score does not meet threshold, and where primary and secondary computer indicate different results (e.g., a conflict), supervisory MCU may arbitrate between computers to determine appropriate outcome.

In at least one embodiment, supervisory MCU may be configured to run a neural network(s) that is trained and configured to determine, based at least in part on outputs from primary computer and secondary computer, conditions under which secondary computer provides false alarms. In at least one embodiment, neural network(s) in supervisory MCU may learn when secondary computer's output may be trusted, and when it cannot. For example, in at least one embodiment, when secondary computer is a RADAR-based FCW system, a neural network(s) in supervisory MCU may learn when FCW system is identifying metallic objects that are not, in fact, hazards, such as a drainage grate or manhole cover that triggers an alarm. In at least one embodiment, when secondary computer is a camera-based LDW system, a neural network in supervisory MCU may learn to override LDW when bicyclists or pedestrians are present and a lane departure is, in fact, safest maneuver. In at least one embodiment, supervisory MCU may include at least one of a DLA or GPU suitable for running neural network(s) with associated memory. In at least one embodiment, supervisory MCU may comprise and/or be included as a component of SoC(s) 1704.

In at least one embodiment, ADAS system 1738 may include a secondary computer that performs ADAS functionality using traditional rules of computer vision. In at least one embodiment, secondary computer may use classic computer vision rules (if-then), and presence of a neural network(s) in supervisory MCU may improve reliability, safety and performance. For example, in at least one embodiment, diverse implementation and intentional non-identity makes overall system more fault-tolerant, especially to faults caused by software (or software-hardware interface) functionality. For example, in at least one embodiment, if there is a software bug or error in software running on primary computer, and non-identical software code running on secondary computer provides same overall result, then supervisory MCU may have greater confidence that overall result is correct, and bug in software or hardware on primary computer is not causing material error.

In at least one embodiment, output of ADAS system 1738 may be fed into primary computer's perception block and/or primary computer's dynamic driving task block. For example, in at least one embodiment, if ADAS system 1738 indicates a forward crash warning due to an object immediately ahead, perception block may use this information when identifying objects. In at least one embodiment, secondary computer may have its own neural network which is trained and thus reduces risk of false positives, as described herein.

In at least one embodiment, vehicle 1700 may further include infotainment SoC 1730 (e.g., an in-vehicle infotainment system (IVI)). Although illustrated and described as a SoC, infotainment system 1730, in at least one embodiment, may not be a SoC, and may include, without limitation, two or more discrete components. In at least one embodiment, infotainment SoC 1730 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1700. For example, infotainment SoC 1730 could include radios, disk players, navigation systems, video players, USB and Bluetooth connectivity, carputers, in-car entertainment, WiFi, steering wheel audio controls, hands free voice control, a heads-up display (“HUD”), HMI display 1734, a telematics device, a control panel (e.g., for controlling and/or interacting with various components, features, and/or systems), and/or other components. In at least one embodiment, infotainment SoC 1730 may further be used to provide information (e.g., visual and/or audible) to user(s) of vehicle, such as information from ADAS system 1738, autonomous driving information such as planned vehicle maneuvers, trajectories, surrounding environment information (e.g., intersection information, vehicle information, road information, etc.), and/or other information.

In at least one embodiment, infotainment SoC 1730 may include any amount and type of GPU functionality. In at least one embodiment, infotainment SoC 1730 may communicate over bus 1702 (e.g., CAN bus, Ethernet, etc.) with other devices, systems, and/or components of vehicle 1700. In at least one embodiment, infotainment SoC 1730 may be coupled to a supervisory MCU such that GPU of infotainment system may perform some self-driving functions in event that primary controller(s) 1736 (e.g., primary and/or backup computers of vehicle 1700) fail. In at least one embodiment, infotainment SoC 1730 may put vehicle 1700 into a chauffeur to safe stop mode, as described herein.

In at least one embodiment, vehicle 1700 may further include instrument cluster 1732 (e.g., a digital dash, an electronic instrument cluster, a digital instrument panel, etc.). In at least one embodiment, instrument cluster 1732 may include, without limitation, a controller and/or supercomputer (e.g., a discrete controller or supercomputer). In at least one embodiment, instrument cluster 1732 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1730 and instrument cluster 1732. In at least one embodiment, instrument cluster 1732 may be included as part of infotainment SoC 1730, or vice versa.

Inference and/or training logic are used to perform inferencing and/or training operations associated with one or more embodiments. Details regarding inference and/or training logic are provided herein. In at least one embodiment, inference and/or training logic may be used in system FIG. 17C for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

FIG. 17D is a diagram of a system 1776 for communication between cloud-based server(s) and autonomous vehicle 1700 of FIG. 17A, according to at least one embodiment. In at least one embodiment, system 1776 may include, without limitation, server(s) 1778, network(s) 1790, and any number and type of vehicles, including vehicle 1700. In at least one embodiment, server(s) 1778 may include, without limitation, a plurality of GPUs 1784(A)-1784(H) (collectively referred to herein as GPUs 1784), PCIe switches 1782(A)-1782(D) (collectively referred to herein as PCIe switches 1782), and/or CPUs 1780(A)-1780(B) (collectively referred to herein as CPUs 1780). GPUs 1784, CPUs 1780, and PCIe switches 1782 may be interconnected with high-speed interconnects such as, for example and without limitation, NVLink interfaces 1788 developed by NVIDIA and/or PCIe connections 1786. In at least one embodiment, GPUs 1784 are connected via an NVLink and/or NVSwitch SoC and GPUs 1784 and PCIe switches 1782 are connected via PCIe interconnects. In at least one embodiment, although eight GPUs 1784, two CPUs 1780, and four PCIe switches 1782 are illustrated, this is not intended to be limiting. In at least one embodiment, each of server(s) 1778 may include, without limitation, any number of GPUs 1784, CPUs 1780, and/or PCIe switches 1782, in any combination. For example, in at least one embodiment, server(s) 1778 could each include eight, sixteen, thirty-two, and/or more GPUs 1784.

In at least one embodiment, server(s) 1778 may receive, over network(s) 1790 and from vehicles, image data representative of images showing unexpected or changed road conditions, such as recently commenced road-work. In at least one embodiment, server(s) 1778 may transmit, over network(s) 1790 and to vehicles, neural networks 1792, updated neural networks 1792, and/or map information 1794, including, without limitation, information regarding traffic and road conditions. In at least one embodiment, updates to map information 1794 may include, without limitation, updates for HD map 1722, such as information regarding construction sites, potholes, detours, flooding, and/or other obstructions. In at least one embodiment, neural networks 1792, updated neural networks 1792, and/or map information 1794 may have resulted from new training and/or experiences represented in data received from any number of vehicles in environment, and/or based at least in part on training performed at a data center (e.g., using server(s) 1778 and/or other servers).

In at least one embodiment, server(s) 1778 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1790, and/or machine learning models may be used by server(s) 1778 to remotely monitor vehicles.

In at least one embodiment, server(s) 1778 may receive data from vehicles and apply data to up-to-date real-time neural networks for real-time intelligent inferencing. In at least one embodiment, server(s) 1778 may include deep-learning supercomputers and/or dedicated AI computers powered by GPU(s) 1784, such as a DGX and DGX Station machines developed by NVIDIA. However, in at least one embodiment, server(s) 1778 may include deep learning infrastructure that use CPU-powered data centers.

In at least one embodiment, deep-learning infrastructure of server(s) 1778 may be capable of fast, real-time inferencing, and may use that capability to evaluate and verify health of processors, software, and/or associated hardware in vehicle 1700. For example, in at least one embodiment, deep-learning infrastructure may receive periodic updates from vehicle 1700, such as a sequence of images and/or objects that vehicle 1700 has located in that sequence of images (e.g., via computer vision and/or other machine learning object classification techniques). In at least one embodiment, deep-learning infrastructure may run its own neural network to identify objects and compare them with objects identified by vehicle 1700 and, if results do not match and deep-learning infrastructure concludes that AI in vehicle 1700 is malfunctioning, then server(s) 1778 may transmit a signal to vehicle 1700 instructing a fail-safe computer of vehicle 1700 to assume control, notify passengers, and complete a safe parking maneuver.

In at least one embodiment, server(s) 1778 may include GPU(s) 1784 and one or more programmable inference accelerators (e.g., NVIDIA's TensorRT 3). In at least one embodiment, combination of GPU-powered servers and inference acceleration may make real-time responsiveness possible. In at least one embodiment, such as where performance is less critical, servers powered by CPUs, FPGAs, and other processors may be used for inferencing. In at least one embodiment, inference and/or training logic are used to perform one or more embodiments. Details regarding inference and/or training logic are provided elsewhere herein.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
identifying a reference point of a first object in an environment based on one or more characteristics pertaining to the first object, wherein a portion of the first object is occluded by a second object in the environment relative to a perspective of a camera component associated with a set of image frames depicting the first object and the second object;
updating a set of coordinates of a multi-dimensional model for the first object based on the identified reference point, wherein the updated set of coordinates indicate a region in at least one image frame of the set of image frames that includes the occluded portion of the first object relative to the identified reference point; and
causing a location of the first object to be tracked in the environment based on the updated set of coordinates of the multi-dimensional model.

2. The method of claim 1, wherein updating the set of coordinates of the multi-dimensional model for the first object comprises:
determining a first coordinate of the multi-dimensional model that corresponds to the identified reference point of the first object;
determining, based on the determined first coordinate, a second coordinate of the multi-dimensional model that corresponds to a portion of the first object that is depicted by the set of image frames;
generating a mapping between the second coordinate of the multi-dimensional model and an additional region of the set of image frames including the depicted portion of the first object; and
updating the first coordinate based on the generated mapping, wherein the updated value of the first coordinate represents a corrected location of the reference point of the first object in view of the generated mapping between the second coordinate of the multi-dimensional model and the additional region of the set of image frames including the depicted portion of the first object,
wherein the updated set of coordinates comprises at least the updated first coordinate and the second coordinate.

3. The method of claim 2, further comprising:
determining an angle of the perspective of the camera component associated with the set of image frames,
wherein the second coordinate of the multi-dimensional model is further determined based on the determined angle of the perspective of the camera component.

4. The method of claim 2, further comprising:
determining, based on the determined first coordinate, a third coordinate of the multi-dimensional model that corresponds to the occluded portion of the first object,
wherein the updated set of coordinates further comprises the determined third coordinate.

5. The method of claim 4, wherein the first object comprises at least a top portion, a center portion, and a bottom portion, and wherein the first coordinate corresponds to the center portion of the first object, the second coordinate corresponds to the top portion of the first object, and the third coordinate corresponds to the bottom portion of the first object.

6. The method of claim 1, wherein identifying the reference point of the first object based on the one or more characteristics pertaining to the first object comprises:
determining a type of the first object; and
identifying a set of pre-defined characteristics for the first object in view of the determined type, wherein the one or more characteristics comprise at least one of the identified set of pre-defined characteristics.

7. The method of claim 6, wherein the set of pre-defined characteristics comprises a pre-defined size of objects corresponding to the determined type and a location of the reference point for the objects relative to the pre-defined size of the objects.

8. The method of claim 1, further comprising:
determining a value of a visibility metric indicating a degree of visibility of the first object in the set of image frames based on bounding box data for the first object in the environment and the updated set of coordinates of the multi-dimensional model for the first object; and
determining whether the value of the visibility metric satisfies one or more visibility criteria,
wherein causing the location of the first object to be tracked in the environment is performed responsive to a determination that the value of the visibility metric satisfies the one or more visibility criteria.

9. The method of claim 1, wherein causing the location of the first object to be tracked in the environment comprises providing the updated set of coordinates to at least one of:
an object tracking engine to track a location of objects detected within the environment across a sequence of subsequent image frames generated by the camera component,
an object location engine to track a location of the object relative to real-world geographic coordinates associated with the environment, or
a tracking correction engine to associate newly detected objects in the environment with previously detected objects in the environment.

10. The method of claim 1, wherein the camera component is associated with a computing system comprised by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system implemented using an edge device;
a system implemented using a robot;
a system for performing conversational AI operations;
a system for performing operations using a large language model (LLM);
a system for performing operations using a vision language model (VLM);
a system for performing operations using a multi-modal language model;
a system for performing synthetic data generation;
a system for generating synthetic data;
a system for presenting at least one of virtual reality content, augmented reality content, or mixed reality content;
a system implemented at least partially in a data center; or
a system implemented at least partially using cloud computing resources.

11. A system comprising:
a set of one or more processing devices to perform operations comprising:
identifying a reference point of a first object in an environment based on one or more characteristics pertaining to the first object, wherein a portion of the first object is occluded by a second object in the environment relative to a perspective of a camera component associated with a set of image frames depicting the first object and the second object;
updating a set of coordinates of a multi-dimensional model for the first object based on the identified reference point, wherein the updated set of coordinates indicate a region in at least one image frame of the set of image frames that includes the occluded portion of the first object relative to the identified reference point; and
causing a location of the first object to be tracked in the environment based on the updated set of coordinates of the multi-dimensional model.

12. The system of claim 11, wherein updating the set of coordinates of the multi-dimensional model for the first object comprises:
determining a first coordinate of the multi-dimensional model that corresponds to the identified reference point of the first object;
determining, based on the determined first coordinate, a second coordinate of the multi-dimensional model that corresponds to a portion of the first object that is depicted by the set of image frames;
generating a mapping between the second coordinate of the multi-dimensional model and an additional region of the set of image frames including the depicted portion of the first object; and
updating the first coordinate based on the generated mapping, wherein the updated value of the first coordinate represents a corrected location of the reference point of the first object in view of the generated mapping between the second coordinate of the multi-dimensional model and the additional region of the set of image frames including the depicted portion of the first object,
wherein the updated set of coordinates comprises at least the updated first coordinate and the second coordinate.

13. The system of claim 12, wherein the operations further comprise:
determining an angle of the perspective of the camera component associated with the set of image frames,
wherein the second coordinate of the multi-dimensional model is further determined based on the determined angle of the perspective of the camera component.

14. The system of claim 12, wherein the operations further comprise:
determining, based on the determined first coordinate, a third coordinate of the multi-dimensional model that corresponds to the occluded portion of the first object,
wherein the updated set of coordinates further comprises the determined third coordinate.

15. The system of claim 14, wherein the first object comprises at least a top portion, a center portion, and a bottom portion, and wherein the first coordinate corresponds to the center portion of the first object, the second coordinate corresponds to the top portion of the first object, and the third coordinate corresponds to the bottom portion of the first object.

16. The system of claim 11, wherein identifying the reference point of the first object based on the one or more characteristics pertaining to the first object comprises:
determining a type of the first object;
identifying a set of pre-defined characteristics for the first object in view of the determined type, wherein the one or more characteristics comprise at least one of the identified set of pre-defined characteristics.

17. The system of claim 16, wherein the set of pre-defined characteristics comprises a pre-defined size of objects corresponding to the determined type and a location of the reference point for the objects relative to the pre-defined size of the objects.

18. A processor comprising a set of one or more processing units to:
identify a reference point of a first object in an environment based on one or more characteristics pertaining to the first object, wherein a portion of the first object is occluded by a second object in the environment relative to a perspective of a camera component associated with a set of image frames depicting the first object and the second object;
update a set of coordinates of a multi-dimensional model for the first object based on the identified reference point, wherein the updated set of coordinates indicate a region in at least one image frame of the set of image frames that includes the occluded portion of the first object relative to the identified reference point; and
cause a location of the first object to be tracked in the environment based on the updated set of coordinates of the multi-dimensional model.

19. The processor of claim 18, wherein to update the set of coordinates of the multi-dimensional model for the first object, the set of one or more processing units is to:
determine a first coordinate of the multi-dimensional model that corresponds to the identified reference point of the first object;
determine, based on the determined first coordinate, a second coordinate of the multi-dimensional model that corresponds to a portion of the first object that is depicted by the set of image frames;
generate a mapping between the second coordinate of the multi-dimensional model and an additional region of the set of image frames including the depicted portion of the first object; and
update the first coordinate based on the generated mapping, wherein the updated value of the first coordinate represents a corrected location of the reference point of the first object in view of the generated mapping between the second coordinate of the multi-dimensional model and the additional region of the set of image frames including the depicted portion of the first object,
wherein the updated set of coordinates comprises at least the updated first coordinate and the second coordinate.

20. The processor of claim 18, wherein the set of one or more processing units is further to:
determine an angle of the perspective of the camera component associated with the set of image frames,
wherein the second coordinate of the multi-dimensional model is further determined based on the determined angle of the perspective of the camera component.
